(19) United States
(12) Patent Application Publication
(10) Pub. No.: US 2022/0270183 A1
(43) Pub. Date: Aug. 25, 2022

(54) Revenue Assurance Systems And Related Methods

(71) Applicant: Ravin Kumar Checker, Cupertino, CA (US)

(72) Inventors: Anil Menon, Pflugerville, TX (US); Sahasrangshu Choudhury, Bangalore (IN); Chandrasekar Ramaswamy, Bangalore (IN); Ravin Kumar Checker, Cupertino, CA (US)

(21) Appl. No.: 17/681,123

(22) Filed: Feb. 25, 2022

Related U.S. Application Data
(60) Provisional application No. 63/153,603, filed on Feb. 25, 2021.

(51) Int. Cl. G06Q 40/00; G06Q 10/06

(52) U.S. Cl. CPC G06Q 40/12; G06Q 10/06393

(57) ABSTRACT

A revenue assurance system includes one or more servers coupled with one or more databases and providing a number of displayed fields/selectors on computer interfaces. A business area selection field allows selection of a business area. A first data source field receives selection of a first data source. A first input field receives selection of one or more first data associated with the first data source. An operator field receives selection of a mathematical symbol. A second input field receives a constant or selection of one or more second data. A database query is generated and executed to retrieve data from the database(s), the query defined at least in part by the first data source field, the first input field, the operator field, and the second input field. A graph representatively illustrates the data retrieved by the database query and displays business revenue-related information relevant to the selected business area.

### CROSS REFERENCE TO RELATED APPLICATIONS

This document claims the benefit of the filing date of U.S. Provisional Patent Application No. 63/153,603, entitled “Revenue Assurance Systems and Methods,” naming as first inventor Ravin Kumar Checker, which was filed on Feb. 25, 2021, the disclosure of which is hereby incorporated entirely herein by reference.

### BACKGROUND

### 1. Technical Field

Aspects of this document relate generally to systems and methods for revenue assurance. Specific implementations relate to using key performance indicators for revenue assurance.

### 2. Background Art

The subscription model for products and services is growing at a rapid pace. Subscription industry revenue is expected to reach $7.6 trillion by 2025. Subscription industry information technology (IT) processes of order to cash are no longer linear from customer relationship management (CRM) to enterprise resource planning (ERP). Instead there is a chaotic and dynamic relationship from CRM to quote, order, fulfill, use, bill, invoice, collect, recognize, and ERP, allowing customers to subscribe, unsubscribe, upgrade, or even leave at will. Revenue recognition is recurring in nature and depends on performance obligation. Revenue leakages in the subscription industry range from 6-12% of revenue. Based on this its assumed that a low estimate of the potential containable leakage will be $456 billion per year. Systems and methods are needed to prevent/capture this revenue leakage.

### SUMMARY

Implementations of revenue assurance methods may include: using one or more user interfaces displayed on one or more displays of one or more computing devices communicatively coupled with one or more databases: receiving a user selection of a business area stored in the one or more databases (e.g., Business Area selector of FIG. 22); receiving, at a first data source field, a user selection of a first data source (e.g., LHS Source of FIG. 22), the first data source used to populate the one or more databases with business revenue-related source data relevant to the selected business area; receiving, at a first input field, a user selection of one or more first data associated with the first data source through the one or more databases (e.g., LHS Field of FIG. 22); receiving, at an operator field, a user selection of an equal-to operator, a not-equal-to operator, a greater-than operator, a greater-than-or-equal-to operator, a less-than operator, or a less-than-or-equal-to operator (e.g., Operator field of FIG. 22); receiving, at a second input field (e.g., RHS Field of FIG. 22), either a user input of a constant or a user selection of one or more second data, the one or more second data associated through the one or more databases with either the first data source or a second data source (e.g., RHS Source of FIG. 22) used to populate the one or more databases with business revenue-related source data relevant to the selected business area; executing a first database query to retrieve data from the one or more databases, wherein the first database query is defined at least in part by the first data source field, the first input field, the operator field, and the second input field; displaying, on the one or more user interfaces, a graph representatively illustrating the data retrieved by the first database query, wherein the graph displays business revenue-related information relevant to the selected business area (e.g., graph of FIG. 25).

Implementations of revenue assurance methods may include one or more or all of the following:

The method may include displaying, on the one or more user interfaces, one or more key performance indicator (KPI) input fields (e.g., FIG. 26 fields) and, in response to receiving input using the KPI input fields, executing a second database query to retrieve data from the one or more databases and displaying, on the one or more user interfaces, an output of the second database query or a calculation based on the output, wherein the output includes business revenue-related information relevant to the selected business area (e.g., FIG. 27 output/display).

The second database query may be defined at least in part by the data retrieved by the first database query (e.g., selecting a first database query “rule” as the Name/Field Name of FIG. 26).

The method may include displaying a KPI threshold input field on the on the one or more user interfaces (e.g., Threshold field of FIG. 26), receiving a user-input threshold at the KPI threshold input field, and displaying, on the one or more user interfaces, the user-input threshold, the data retrieved by the second database query or a value calculated using the data retrieved by the second database query, and an indication of whether the data retrieved by the second database query is outside the user-input threshold (e.g., FIG. 27 and related color coding described hereafter).

Implementations of revenue assurance systems may include: one or more servers communicatively coupled with one or more databases, the one or more servers providing information to display, on one or more user interfaces displayed on one or more displays of one or more computing devices: a business area selection field configured to receive a user selection of one of a plurality of previously-determined business areas stored in the one or more databases; a first data source field configured to receive a user selection of a first data source, the first data source used to populate the one or more databases with business revenue-related source data relevant to the selected business area; a first input field configured to receive a user selection of one or more first data associated with the first data source through the one or more databases; an operator field configured to receive a user selection of an equal-to operator, a not-equal-to operator, a greater-than operator, a greater-than-or-equal-to operator, a less-than operator, or a less-than-or-equal-to operator; and a second input field configured to receive either a user input of a constant or a user selection of one or more second data, the one or more second data associated through the one or more databases with either the first data source or a second data source used to populate the one or more databases with business revenue-related source data relevant to the selected business area; one or more input fields configured to, in response to receiving one or more user inputs, automatically initiate generation of a database query and automatically initiate execution of the database query (e.g., input fields of FIGS. 24A-24E) to retrieve data from the one or more databases, wherein the database query is defined at least in part by the first data source field, the first input field, the operator field, and the second input field; and a graph representatively illustrating the data retrieved from the one or more databases by the database query, wherein the graph displays business revenue-related information relevant to the selected business area.

Implementations of revenue assurance systems may include one or more or all of the following:

The one or more servers may further provide information to display, on the one or more user interfaces, a table displaying the data retrieved by the database query or one or more calculations based on the data retrieved by the database query (e.g., table at bottom half of FIG. 25).

The one or more servers may further provide information to display, on the one or more user interfaces, one or more frequency input fields configured to, in response to receiving one or more user inputs, automatically initiate execution of the database query on a repeating schedule (e.g., frequency input fields of FIGS. 24A-24E).

The one or more servers may further provide information to display, on the one or more user interfaces, a threshold field configured to receive an input threshold value.

The one or more servers may further provide information to display, on the one or more user interfaces, a notification input field (e.g., Notification Email field of FIG. 26) configured to allow selection of one or more users for automatic notifications when the threshold value is exceeded by either a value retrieved from the one or more databases (e.g., when there is no Denominator input on interface 2600 and the output is a number, not a ratio or percentage) or a calculation based on one or more values retrieved from the one or more databases (e.g., when there is a Denominator input on interface 2600 and the output is a ratio or percentage).

The one or more servers may further provide information to display, on the one or more user interfaces, a summary showing the threshold value and either a value retrieved from the one or more databases or a calculation based on one or more values retrieved from the one or more databases.

Implementations of revenue assurance systems may include: one or more servers communicatively coupled with one or more data stores, the one or more servers providing information to display, on one or more displays of one or more computing devices: one or more first rule interfaces (e.g., interface 2200 of FIG. 22), the one or more first rule interfaces including: a first data source field configured to receive a user selection of a first data source, the first data source used to populate the one or more data stores with business revenue-related source data; a first input field configured to receive a user selection of one or more first data associated with the first data source through the one or more data stores; an operator field configured to receive a user selection of a mathematical symbol (e.g., the Operator field of FIG. 22); a second input field configured to receive either a user input of a constant or a user selection of one or more second data, the one or more second data associated through the one or more data stores with either the first data source or a second data source used to populate the one or more data stores with business revenue-related source data; one or more input fields configured to, in response to receiving one or more user inputs, automatically initiate generation of one or more data store queries and automatically initiate execution of the one or more data store queries to retrieve data from the one or more data stores, wherein the one or more data store queries are defined at least in part by the first data source field, the first input field, the operator field, and the second input field, and wherein the one or more data store queries include one or more first rules (e.g., the query itself is called a first rule); and one or more first rule outcome interfaces (e.g., FIG. 25), the one or more first rule outcome interfaces including: one or more first rule outcome graphs (e.g., graph of FIG. 25) representatively illustrating the data retrieved by the one or more data store queries, wherein the one or more first rule outcome graphs display business revenue-related information.

Implementations of revenue assurance systems may include one or more or all of the following:

The one or more first rule interfaces may further include a business area selection field configured to receive a user selection of one of a plurality of previously-determined business areas stored in the one or more data stores, wherein the business revenue-related source data from the first data source is relevant to the selected business area, and wherein the one or more first rule outcome graphs display business revenue-related information relevant to the selected business area.

The one or more servers may further provide information to display, on the one or more displays of the one or more computing devices, a group dashboard interface (e.g., FIG. 29) configured to allow, for each previously-determined business area, user selection of a subset of the first rule outcome graphs (e.g., listed and selected contexts and insights of FIG. 29), the subset defining a graph group.

The one or more servers may further provide information to display, on the one or more displays of the one or more computing devices, one or more summary interfaces (e.g., FIG. 15) displaying two or more of the previously-determined business areas and further displaying, for each displayed business area, the user-defined graph group for that business area.

The mathematical symbol may include an equal-to operator, a not-equal-to operator, a greater-than operator, a greater-than-or-equal-to operator, a less-than operator, or a less-than-or-equal-to operator.

The one or more servers may further provide information to display, on the one or more displays of the one or more computing devices, one or more second rule interfaces (e.g., FIG. 26), the one or more second rule interfaces configured to allow user creation of a second rule (e.g., creation of a KPI rule) in part by allowing a user to select an output of one of the one or more first rules to be a component of the second rule. For example, on interface 2600 the user may select for the “Name” field a previously identified rule name (InsightName) set up on interface 2200 and may select for the “Field Name” input a field related to the rule (such as a previously identified Detail Outcome listed in the Detail Outcome List of interface 2200).

The one or more second rule interfaces may include one or more input fields configured to allow user selection of a numerator and user selection of a denominator (e.g., fields of Numerator and Denominator rows of FIG. 26), the numerator and the denominator at least partly defining the second rule (e.g., a KPI rule).

The one or more second rule interfaces may include one or more selectors configured to allow user identification of an outcome of the second rule as either a number, a ratio, or a percentage (e.g., Conditions Unit field of FIG. 26).

The one or more servers may further provide information to display, on the one or more displays of the one or more computing devices, one or more second rule outcome interfaces (e.g., FIG. 28), the one or more second rule outcome interfaces displaying a graph of an output of the second rule plotted against time (e.g., graph of FIG. 28).

The one or more servers may further provide information to display, on the one or more displays of the one or more computing devices, one or more user access interfaces configured to receive user input to adjust a user's ability to edit the one or more first rules (e.g., role interface of FIG. 30 and interface 3300 of FIG. 33 allowing a change of a user's role).

General details of the above-described implementations, and other implementations, are given below in the DESCRIPTION, the DRAWINGS, and the CLAIMS.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a diagram of an example implementation of a revenue assurance system;

FIG. 2 is a diagram of an example architecture of elements of the system of FIG. 1;

FIG. 3 is a diagram of an example method implemented using the FIG. 1 system;

FIG. 4 is a diagram of an example method implemented using the FIG. 1 system;

FIG. 5 is a diagram of an example method implemented using the FIG. 1 system;

FIG. 6 is a diagram of an example method implemented using the FIG. 1 system;

FIG. 7 is a diagram of an example method implemented using the FIG. 1 system;

FIG. 8 is a diagram of an example method implemented using the FIG. 1 system;

FIG. 9 is a diagram of an example method implemented using the FIG. 1 system;

FIG. 10 is a diagram of an example method implemented using the FIG. 1 system;

FIG. 11 is a diagram of an example method implemented using the FIG. 1 system;

FIG. 12 is a diagram of an example method implemented using the FIG. 1 system;

FIG. 13 is an example user interface implemented using the system of FIG. 1;

FIG. 14 is an example user interface implemented using the system of FIG. 1;

FIG. 15 is an example user interface implemented using the system of FIG. 1;

FIG. 16 is an example user interface implemented using the system of FIG. 1;

FIG. 16B is an example user interface implemented using the system of FIG. 1;

FIG. 17 is an example user interface implemented using the system of FIG. 1;

FIG. 18 is an example user interface implemented using the system of FIG. 1;

FIG. 19 is an example user interface implemented using the system of FIG. 1;

FIG. 20 is an example user interface implemented using the system of FIG. 1;

FIG. 21 is a diagram of method elements implemented using the system of FIG. 1;

FIG. 22 is an example user interface implemented using the system of FIG. 1;

FIG. 23 is an example user interface implemented using the system of FIG. 1;

FIG. 24A is an example user interface implemented using the system of FIG. 1;

FIG. 24B is an example user interface implemented using the system of FIG. 1;

FIG. 24C is an example user interface implemented using the system of FIG. 1;

FIG. 24D is an example user interface implemented using the system of FIG. 1;

FIG. 24E is an example user interface implemented using the system of FIG. 1;

FIG. 25 is an example user interface implemented using the system of FIG. 1;

FIG. 26 is an example user interface implemented using the system of FIG. 1;

FIG. 27 is an example user interface implemented using the system of FIG. 1;

FIG. 28 is an example user interface implemented using the system of FIG. 1;

FIG. 29 is an example user interface implemented using the system of FIG. 1;

FIG. 30 is an example user interface implemented using the system of FIG. 1;

FIG. 31 is an example user interface implemented using the system of FIG. 1;

FIG. 32 is an example user interface implemented using the system of FIG. 1;

FIG. 33 is an example user interface implemented using the system of FIG. 1;

FIG. 34 is an example user interface implemented using the system of FIG. 1;

FIG. 35 is a diagram representatively illustrating elements of systems and methods for revenue assurance;

FIG. 36 is an example user interface implemented using the system of FIG. 1;

FIG. 37 is an example user interface implemented using the system of FIG. 1;

FIG. 38 is an example user interface implemented using the system of FIG. 1;

FIG. 39 is an example user interface implemented using the system of FIG. 1;

FIG. 40 is an example user interface implemented using the system of FIG. 1;

FIG. 41 is an example user interface implemented using the system of FIG. 1;

FIG. 42 is an example user interface implemented using the system of FIG. 1;

FIG. 43 is an example user interface implemented using the system of FIG. 1;

FIG. 44 is an example user interface implemented using the system of FIG. 1;

FIG. 45 is an example user interface implemented using the system of FIG. 1;

FIG. 46 is an example user interface implemented using the system of FIG. 1;

FIG. 47 is an example user interface implemented using the system of FIG. 1;

FIG. 48 is an example user interface implemented using the system of FIG. 1;

FIG. 49 is an example user interface implemented using the system of FIG. 1;

FIG. 50 is an example user interface implemented using the system of FIG. 1;

FIG. 51 is an example user interface implemented using the system of FIG. 1;

FIG. 52 is an example user interface implemented using the system of FIG. 1;

FIG. 53 is an example user interface implemented using the system of FIG. 1;

FIG. 54 is an example user interface implemented using the system of FIG. 1;

FIG. 55 is an example user interface implemented using the system of FIG. 1;

FIG. 56 is an example user interface implemented using the system of FIG. 1;

FIG. 57 is an example user interface implemented using the system of FIG. 1;

FIG. 58 is an example user interface implemented using the system of FIG. 1;

FIG. 59 is an example user interface implemented using the system of FIG. 1;

FIG. 60 is an example user interface implemented using the system of FIG. 1;

FIG. 61 is an example user interface implemented using the system of FIG. 1;

FIG. 62 is an example user interface implemented using the system of FIG. 1;

FIG. 63 is an example user interface implemented using the system of FIG. 1;

FIG. 64 is an example user interface implemented using the system of FIG. 1;

FIG. 65 is an example user interface implemented using the system of FIG. 1;

FIG. 66 is an example user interface implemented using the system of FIG. 1;

FIG. 67 is an example user interface implemented using the system of FIG. 1;

FIG. 68 is an example user interface implemented using the system of FIG. 1;

FIG. 69 is an example user interface implemented using the system of FIG. 1;

FIG. 70 is an example user interface implemented using the system of FIG. 1;

FIG. 71 is an example user interface implemented using the system of FIG. 1;

FIG. 72 is an example user interface implemented using the system of FIG. 1;

FIG. 73 is an example user interface implemented using the system of FIG. 1;

FIG. 74 is an example user interface implemented using the system of FIG. 1;

FIG. 75 is an example user interface implemented using the system of FIG. 1;

FIG. 76 is an example user interface implemented using the system of FIG. 1;

FIG. 77 is an example user interface implemented using the system of FIG. 1;

FIG. 78 is an example user interface implemented using the system of FIG. 1;

FIG. 79 is an example user interface implemented using the system of FIG. 1;

FIG. 80 is an example user interface implemented using the system of FIG. 1;

FIG. 81 is an example user interface implemented using the system of FIG. 1;

FIG. 82 is an example user interface implemented using the system of FIG. 1;

FIG. 83 is an example user interface implemented using the system of FIG. 1;

FIG. 84 is an example user interface implemented using the system of FIG. 1;

FIG. 85 is an example user interface implemented using the system of FIG. 1;

FIG. 86 is an example user interface implemented using the system of FIG. 1;

FIG. 87 is an example user interface implemented using the system of FIG. 1;

FIG. 88 is an example user interface implemented using the system of FIG. 1;

FIG. 89 is an example user interface implemented using the system of FIG. 1;

FIG. 90 is an example user interface implemented using the system of FIG. 1;

FIG. 91 is an example user interface implemented using the system of FIG. 1;

FIG. 92 is an example user interface implemented using the system of FIG. 1;

FIG. 93 is an example user interface implemented using the system of FIG. 1;

FIG. 94 is an example user interface implemented using the system of FIG. 1;

FIG. 95 is an example user interface implemented using the system of FIG. 1;

FIG. 96 is an example user interface implemented using the system of FIG. 1;

FIG. 97 is an example user interface implemented using the system of FIG. 1;

FIG. 98 is an example user interface implemented using the system of FIG. 1;

FIG. 99 is an example user interface implemented using the system of FIG. 1;

FIG. 100 is an example user interface implemented using the system of FIG. 1;

FIG. 101 is an example user interface implemented using the system of FIG. 1;

FIG. 102 is an example user interface implemented using the system of FIG. 1;

FIG. 103 is an example user interface implemented using the system of FIG. 1;

FIG. 104 is an example user interface implemented using the system of FIG. 1; and

FIG. 105 is an example user interface implemented using the system of FIG. 1.

### DESCRIPTION

Implementations/embodiments disclosed herein (including those not expressly discussed in detail) are not limited to the particular components or procedures described herein. Additional or alternative components, assembly procedures, and/or methods of use consistent with the intended revenue assurance systems and related methods may be utilized in any implementation. This may include any components, sub-components, methods, sub-methods, steps, and so forth.

Systems and methods disclosed herein are configured to show a user insights into business transactions. In implementations the systems and methods may mitigate risk of revenue leakage in a risk-based, comprehensive, and automated manner (revenue assurance), though in implementations the systems and methods may do much more than revenue assurance, as described herein. The systems/methods in implementations are built with global practice in mind, following global standards and frameworks, and provide lightweight, secure, fast integration with new data sources, full configurable rules to find leakages and visually-enticing intelligent leakage dashboards. The systems/methods in implementations also generate detailed leakage reports with impact analytics which can be further drilled down to pinpoint root causes. In implementations leakage alerts are delivered to end users through emails and workflow systems. Intelligent analytics may be used to prevent future leakages before they can occur.

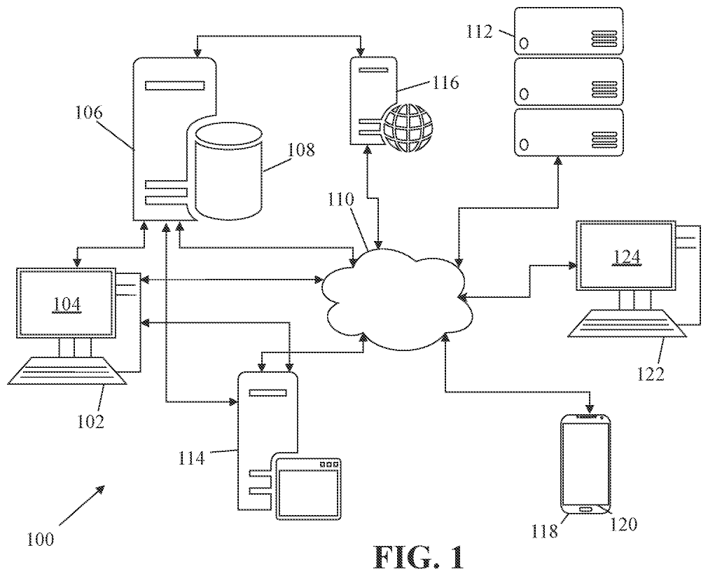

Referring now to FIG. 1, an implementation of a revenue assurance system (system) 100 is diagrammed. The system may include one or more admin computing devices (devices) 102 having a display 104 which may be used for an administrator to log into the system and edit settings, set up users, edit/modify software/system settings, and the like. The system may include one or more database servers 106 and one or more databases 108 which may be communicatively coupled with the device 102 either directly or through a telecommunications network 110 such as the Internet. One or more remote/cloud servers 112 could also be included in the system and could be used for storage, processing of information, and so forth. One or more application servers 114 could be included and could be coupled directly and/or through the telecommunications network with the database server and/or with remote servers 112 and/or with the admin computing device(s) and could be used to implement one or more software applications such as, by non-limiting example, a mobile software application, which could allow users (administrators and end users) interactive access to elements and user interfaces of the system through computing devices 118 having displays 120. One or more web servers 116 could be included and could be used to implement one or more websites which could allow users (administrators and end users) interactive access to elements and user interfaces of the system through computing devices 118 and through computing devices 122 having displays 124.

FIG. 1 is just one example system setup that may be used to implement a revenue assurance system, and is a simplified representation. Other implementations could exclude one or more of the elements shown in FIG. 1 or could include additional elements, and any of the elements could be multiplied to scale the system up to handle any number of users. Some of the elements of FIG. 1 could be implemented not on different devices (as shown in FIG. 1) but on a common device through virtualization. Data stores other than databases could be used to store data and other information. External elements may be communicatively coupled with one or more of the elements of system 100 to provide source data.

User interfaces implemented using system 100 may be facilitated by (and may provide a front end interface to) data stored in one or more relational databases of the system. User interfaces may provide a front end for associating objects through the relational database(s), updating database objects, deleting database objects, and so forth. Any of the administrator and/or end user computing devices 102/118/122 could be any type of computing device including a desktop computer, laptop, tablet, mobile phone, smart phone, smart speaker, smart glasses, smart watch, and any other device providing a display and/or audio/microphone for interacting with other elements of the system 100.

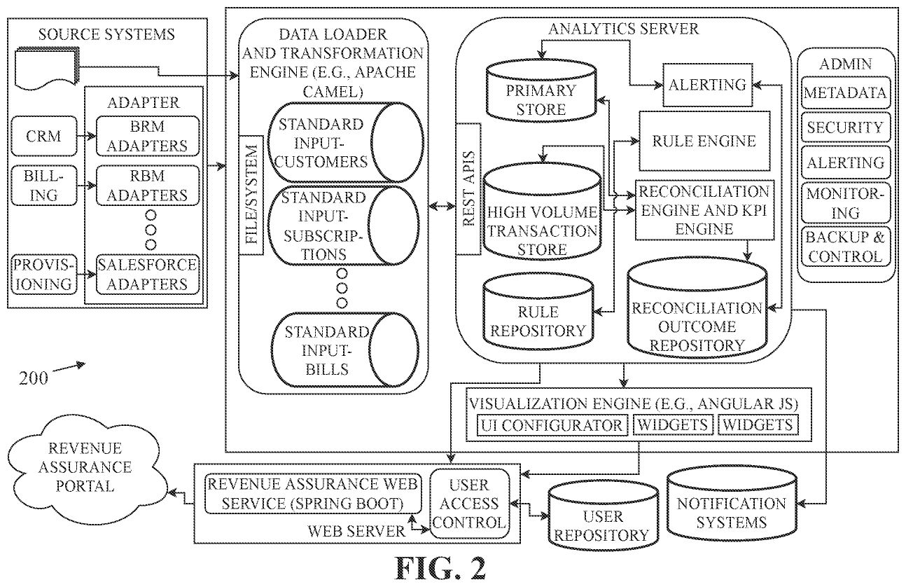

Referring now to FIG. 2, a representative example architecture 200 implemented using elements of system 100 is given. The architecture may be implemented using software and/or hardware components of system 100. In implementations the architecture 200 unifies data from multiple source systems and applies configurable rules on that data to identify potential revenue leakage areas within a quote-to-cash subscription business process—the result of the analysis stored back into one or more databases. These outcomes are then communicated to a revenue assurance (RA) analyst to escalate the next step of root cause analysis of the revenue leakage and mitigate the future risk of loss. In implementations system 100 uses a distributed storage mechanism (HADOOP) to store large volumes of data collected from different source systems. MAPREDUCE algorithms may be used for analyzing large volumes of data and to compute the required outcomes.

In implementations the architecture 200 follows a multi-tier application architecture. Each layer may be designed with scalability and high availability in mind. The application tier may be based on a stateless, microservices-based architecture. This allows the application to be scaled horizontally based on the load. The data storage may be implemented on a distributed file system (HADOOP) which provides a high availability feature out of the box. Various elements of architecture 200 are described below in further detail.

In implementations the source systems are where the original data of a subscription business resides. These may include different online transaction processing (OLTP) systems like customer relationship management (CRM), billing, provisioning, usage, etc., where the data is stored. Data from these systems will be collected, transformed and persisted into system 100 elements for further analysis.

The adapters of FIG. 2 are the components that pull data from specific source systems and push them to one or more system databases. Some adapters have been designed which are specific to a source system and source data type. These adapters have the logic specific to the source system and know the source data type and how to extract and collect data from that very specific source. Examples of these adapters would be a billing and revenue management (BRM) adapter (for example an adapter for an ORACLE BRM), an RBM (NETCRACKER billing system) adapter, a SALESFORCE adapter, etc. Some adapters are not specific to a source system/data type but are generic. Generic adapters are designed to be independent of source and to assist in faster data source integration. These generic adapters don't depend on any specific source system or source data type, but are text data source based adapters which can read data in a specific delimited format and push it to one or more system databases.

When an adapter pulls data from a source system, it then sends it to the data loader layer. The data loader layer has been designed for performing the following tasks on the collected data sent by the adapters: validations and cleaning up of data based on configurable parameters; transformation of data into canonical formats based on transformation configuration; and persisting data into one or more system databases. The data loader uses a multi-threading concept to optimize loading of huge volumes of data into the one or more system databases.

The analytics server component is responsible for analyzing the data collected from various sources. The REST of REST APIs stands for representational state transfer. The analytics component uses programming models like MAPREDUCE and parallel processing to perform data analysis on a huge volume of data to predict or to report potential areas of control risks causing (or which may cause) revenue leakages. Once the data are analyzed, the leakage report outcome of the analysis is persisted back to the one or more databases. The analyzed data is then used by the presentation layer to display intuitive analytics to the RA analyst.

In implementations the analytics server will be multi-tenancy enabled and capable of processing and analyzing data based on tenant Identifiers, and a single instance of the server will be capable of multiple tenant processing. This enables the analytics server to host and manage multiple customers in a cloud-based environment and supports scalability in a public cloud environment.

The rule engine is designed to allow the revenue assurance users to create new control reconciliation rules, deploy them, and view the results of the execution. All these can be done on the fly without system downtime.

The revenue assurance portal is the presentation layer that uses the analyzed data to display multiple analytics to the revenue assurance (RA) analyst. The portal allows the RA analyst to perform the following tasks which may make data analysis easier and simpler: configure revenue assurance rules through an easy to use user interface; interactive data analysis using configurable dashboards (the users can pick and choose the set of outcomes that they want to visualize and create their own dashboard); manage role-based and user-based key performance indicators (KPI's); manage users and roles; and perform other administrative tasks.

Referring still to FIG. 2, the system data storage components are responsible for, among other things, storing the unified data which is pulled from the various source systems. The data storage layer is further divided into the following layers: primary storage (primary store); high volume storage (high volume transaction store); config data storage (rule repository); and outcome repository (reconciliation outcome repository). In implementations these could all be in a common database or on a common machine using virtually separated storage.

The primary storage stores the master set of data pulled from the source systems. Examples of this type data includes users/customers, subscriptions, bill details, accounts, products, etc. The primary storage stores data which is not generated by time-based events but is instead a master set of data.

High volume storage stores data which are high volume in nature and which are produced by time-based events. Examples of this type data include call events produced by usage, usage rated billing data produced every second or every minute, usage statistics of high volume data, data regarding each call across the customer base, and so forth. Contextual information may be needed for all of this data. The data storage is split into the multiple layers to enable faster data querying using tools and technologies tailored for the volume/size of the individual layers/stores.

Config storage (rule repository) stores master data that is specific to the system 100 and not pulled from external systems. This includes authentication and authorization data of the system, rules created by the users, and other configuration data required to bootstrap the system. The results of various rule execution results are stored in the reconciliation outcome repository. The visualization layer of the system fetches data from this storage for various types of visualization and graphical outputs.

Referring still to FIG. 2, the alert engine component (alerting) is responsible for sending alerts to users when certain specific events are triggered in the system. For example, when the key performance indicator (KPI) for a specific rule is violated the system will alert the user via an email. The company-generated invoices may, for instance, be expected to be in the range of $100-$500. If an invoice gets created for $1,000,000, the system can send an alert to one of the users.

The business rule configurator (rule engine) allows the revenue assurance (RA) analyst to create and manage rules through a user interface. The business rule configurator has the following sections to configure a rule: rule metadata section—this section contains the basic information about a rule like the rule name and rule description; rule details section—this section contains the actual rule conditions, the set of fields that should be compared to analyze the data; rule summary section—the summary configuration for a rule (the summary will run on top of the outcome data and the results of the summary are used for producing various graphical outputs on the dashboards-a summary is usually an aggregation function on top of the detailed outcome data); rule scheduling section—this allows the user to schedule the rule to run at a specific frequency and/or time/day, etc.; rule output configuration section—this allows the user to select the type of graph that will be used to display the summarized information on the dashboards.

With regards to the reconciliation engine, the analytics component uses programming models like MAPREDUCE and parallel processing to perform data analysis on a huge volume of data to predict or to report potential areas of control risks causing (or which may cause) revenue leakages. Once the data are analyzed, the leakage report outcome of the analysis is persisted back to the one or more databases. The analyzed data is then used by the presentation layer to display intuitive analytics to the RA analyst. In implementations the reconciliation engine performs the regular running of the rules according to schedules. For example, the reconciliation engine may, according to a schedule, regularly check for customers who have not paid bills. The reconciliation engine can interface with the notification systems API to provide notifications to users.

Referring still to FIG. 2, the key performance indicator (KPI) engine allows the users to set performance indicators on top of the revenue reconciliation data. The KPI engine allows the user to set metrics through which the success/failure ratio of the reconciliation data can be analyzed.

As used in this document, a key performance indicator (KPI) is a measurable value that demonstrates how effectively a company is achieving key business objectives. Often success is simply the repeated, periodic achievement of some level of operational goal (e.g., zero defects, 10/10 customer satisfaction, etc.). Other times, success is defined in terms of making progress towards a strategic goal. Accordingly, choosing the right KPIs relies upon a good understanding of what is important to the organization. What is deemed important often depends on how a department or component of the business measures performance, e.g., the KPIs useful to finance may differ from the KPIs assigned to sales.

The KPI engine allows the user to define different mathematical relationships between the reconciliation data to create the required metrics indicator(s). The KPI engine allows configuring of KPI's between the following different data sets: master to master data; transaction to transaction data; between two rule outcome data; and between rule outcome data and master data. The KPI engine provides one or more web-based user interfaces through which the user can configure the required KPIs. The KPIs help the users to qualify and quantify the leakage. Following are some sample KPIs that can be configured through the KPI engine: percentage of reconciled customers; percentage of unbilled and/or underbilled revenue over total revenue; ratio of billing call records to network call records; and quantitative description of the average time for recovery of revenue.

The KPIs can be classified into the following broader types: absolute KPI—this type of KPI compares the reconciliation data against a fixed threshold value; relative KPI—this type of KPI allows comparing of different reconciliation data against each other. In implementations the KPI engine allows the following type of relationships to be defined when comparing the data set: all logical operators; mathematical operators (plus, minus, division, multiplication); and aggregation functions (sum, count, average, max, and min). Using these operators and expressions, the KPI engine allows the user to create different relationships within the data to set the KPI metrics.

In implementations the architecture of the KPI engine may be the same as that of the rule engine. It may use HADOOP, MAPREDUCE and parallel processing capabilities to analyze the data and produce the KPI outcome. The KPI engine in implementations performs the KPI check on the data and produces the outcome. The KPI outcome may be stored regardless of whether the particular outcome has succeeded or failed at that particular point in time. The KPI dashboard may show the outcome of the KPI check with an indicator of whether the KPI succeeded or failed. The dashboard may be completely configurable and the user may in implementations choose and create custom dashboards.

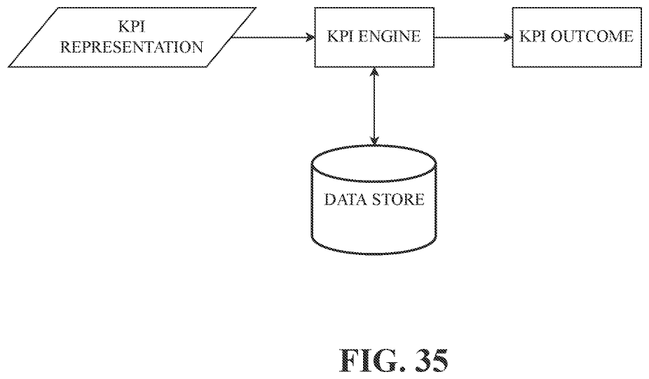

Reference will now be made to FIG. 35 in conjunction with further description regarding key performance indicator (KPI) functionality. The KPI engine executes a given KPI on top of stored data and produces a KPI output. FIG. 35 gives a high-level view of KPI engine functionality. In implementations the running time KPI engine will get an input that contains a KPI representation in JSON. Based on this the KPI engine will process data stored in the data store and produce a KPI outcome. In implementations the KPI outcome may be a number, a ratio, or a percentage.

In implementations in which the KPI outcome is a number, it may be a number that is output, by example, from one or more sum, count, and/or avg operations of one or more values. These values can come from different data sources such as “entities” and “outcome” tables and may be produced by different rules previously executed. For example, an “entities” table may be a data table that stores information/data previously polled. During a configuration step the user may specify which table column to use in the calculation. There are a variety of mathematical operations/representations that may be used when the KPI outcome is a number. For example, assuming A, B, C, and D are numbers, a first expression could be A+B+C, a second expression could be A+B−C, a third expression could be A+B−C+D, a fourth expression could be A+B*C, and a fifth expression could be A+B−C*D. These are just examples of the mathematical representations/expressions that may be used when the outcome is a number. The KPI outcome, when a number, may be the outcome of a single numerical function or a total sum count of a plurality of numerical functions, for example.

In implementations in which the KPI outcome is a ratio it may be a ratio of values found, by example, from one or more sum, count, and/or avg operations of one or multiple table columns. These values can come from different data sources such as the previously mentioned entities table and outcome table and may be produced by different rules previously executed. The entities and other tables may, again, be data tables that store information/data previously polled. During a configuration step the user may specify which table column(s) to use in the calculation, and because this KPI outcome is a ratio it must have two portions-a numerator and a denominator. There are a variety of mathematical operations/representations that may be used when the KPI outcome is a ratio. For example, assuming A, B, C, D, Q, and z are numbers, a first expression could be A (numerator)/B (denominator), a second expression could be (A+B) (numerator)/(C+D) (denominator), a third expression could be (A+B−C)/(C+D−Q*z), and so forth. The ratio accordingly may divide one sum or total (the numerator) by another sum or total (the denominator).

In implementations in which the KPI outcome is a percentage it may be a percentage of values found, by example, from one or more sum, count, and/or avg operations of one or multiple table columns. These values can come from different data sources such as the previously mentioned entities table and outcome table and may be produced by different rules previously executed. The entities and other tables may be data tables that store information/data previously polled. During a configuration step the user may specify which table column(s) to use in the calculation, and because this KPI outcome is a percentage it must have two portions-a numerator and a denominator, and the KPI engine may first calculate (or locate a stored) ratio and then convert it into a percentage (such as by multiplying it by 100). There are a variety of mathematical operations/representations that may be used when the KPI outcome is a percentage. For example, assuming A, B, C, D, Q, and z are numbers, a first expression could be A*100 (numerator)/B (denominator), a second expression could be (A+B)*100 (numerator)/(C+D) (denominator), a third expression could be (A+B−C)*100/(C+D−Q*z), and so forth. The method accordingly may divide one sum or total (the numerator) by another sum or total (the denominator) and multiply the result by 100 (or multiply the numerator by 100 before dividing by the denominator) so that the output is a percentage instead of a ratio.

Example application programming interface (API) details that may be useful in performing KPI operations are given below:

```
{
  “adhocEmails”:[“String” ],
  “description”: “string”,
  “kpiFraction”: {
    “denominators”: [
        {
        “appendNextConditionwith”: “string”,
        “parentAggregationType”: “string”,
        “ruleId”: “string”,
        “ruleOutcome”: {
            “aggregationType”: “string”,
            “entity”: “string”,
            “field”: “string”,
            “source”: “string”
            }
        }
      ],
    “numerators”: [
        {
        “appendNextConditionwith”: “string”,
        “parentAggregationType”: “string”,
          “ruleId”: “string”,
          “ruleOutcome”: {
              “aggregationType”: “string”,
              “entity”: “string”,
              “field”: “string”,
              “source”: “string”
              }
          }
      ]
  },
  “kpiOperator”: “string”,
  “kpiOwners”: [ ],
  “kpiThreshold”: 0,
  “name”: “string”,
  “priority”: “string”,
  “type”: “string”,
  “units”: “PERCENTAGE”
}
```

Example JSON field details useful for KPI operations are given below in TABLE 1.

TABLE 1
JSON Field Details

| SINo | Field Name | Function | Data type |
|---|---|---|---|
| 1 | name | A unique KPI name | string |
| 2 | priority | KPI priority | string |
| 3 | type | A KPI type (such astactical, | string |
| | | operational, etc.) | |
| 4 | units | KPI unit (percentage, ratio, number) | string |
| 5 | kpiThreshold | A threshold value for KPI | double |
| 6 | kpiOwners | Owners who can see this KPI | array |
| 7 | kpiOperator | An operator used to relate a KPI | string |
| | | value and a threshold | |
| 8 | kpiFraction | A KPI fraction object which contains | object |
| | | information for KPI calculation | |
| 9 | denominators | An object array which represents | array |
| | | denominator fields | |
| 10 | numerators | An object array which represents | array |
| | | numerator fields | |
| 11 | description | A field used to describe the KPI | string |
| 12 | adhocEmails | An array which contains all emails | array |
| | | used for KPI violation notifications | |
| 13 | appendNextConditionwith | A field used to appendbetween two | string |
| | | entity fields (+, −, *, etc.) | |
| 14 | parentAggregationType | Indicates the need to do an | string |
| | | aggregation type on a field (count, | |
| | | sum, avg, etc.) | |
| 15 | ruleId | Indicates whether a field isa column | string |
| | | from an outcometable. If ruleId is | |
| | | null thecolumn is from the entity (or | |
| | | entities) table | |
| 16 | ruleOutcome | An object which containsdetail | object |
| | | about a field | |
| 17 | aggregationType | Used when field is taken from rule | string |
| | | outcome. If aggregation type is | |
| | | present the outcome field is storing a | |
| | | value of an aggregation function. | |
| 18 | entity | The table name | string |
| 19 | field | Exact field name in the entity table | string |
| 20 | source | Data source for field (like BRM, CRM, | string |
| | | etc.) | |

Implementation of KPI mathematical operations will now briefly be described. Possible combinations were previously discussed. Consider, for example, a KPI equation for a ratio (A+B)/(C+D). This ratio has two portions, a numerator and a denominator, so that the ratio can be expressed as numerator/denominator. Each of the numerator and denominator can be the result of one or more values. In JSON, combination of the numerator and denominator may use a kpiFraction field. This may have two array fields: Numerator, Denominator. This array contains objects that represent each field and aggregation type. In cases in which there is more than one field in the numerator it must be specified how these fields are attached using the “appendNextConditionwith” field. In instances where the KPI output is a number but not a ratio or percentage, a denominator is not mandatory.

Referring again to FIG. 2, the administration (admin) components deal with managing the day to day operational tasks of the system. This layer may have common settings that are common among all components of the layer. The metadata component stores and manages the entire configuration information required for bootstrapping and running the system. The security component provides various levels of security. This includes security at various levels like the infrastructure level security and the application level security which manages the authentication and authorization of users in the system. The alerting component is used for sending alerts to administrator users when certain events are triggered in the system. The monitoring component is responsible for monitoring the system health on a regular basis and alerting the administrator(s) in case of any issues. The backup & control component is used for continued operational purposes, taking regular backups of the system state so that the system can be restored in case of a failure.

As discussed above, the systems and methods disclosed herein are configured to reduce revenue leakage for the subscription industry in an automated manner. In implementations the assurance and control areas as defined within the systems and methods are categorized into logical groups aligned to the subscription economy business and revenue life cycle. By non-limiting example, in implementations these may be Quote Configuration Assurance, Order Assurance, Subscription Assurance, Consumption/Usage, Billing, Invoicing, Renewal, and Payment.

The life cycle of leakage detection may start by the analysis of as-is business process and control gaps. Post-risk analysis of the systems and methods may be configured to collect data from various systems which support the subscription business life cycle, store the data, and configure rules to perform various control reconciliations on the data to help identify and plug the leakages. To perform these operations the systems and methods may use a configurable rule based approach to compare and analyze the data. The systems and methods may also report insights and provide predictive leakage possibilities by applying optimum machine learning algorithms to scenario-specific training data. This may include the use of a predictive engine component of the system (not shown in the drawings). Identified leakages may be reported using detailed and visually enticing interactive dashboards to enable mitigation of leakage root causes and to help users focus on areas to improve the control gaps.

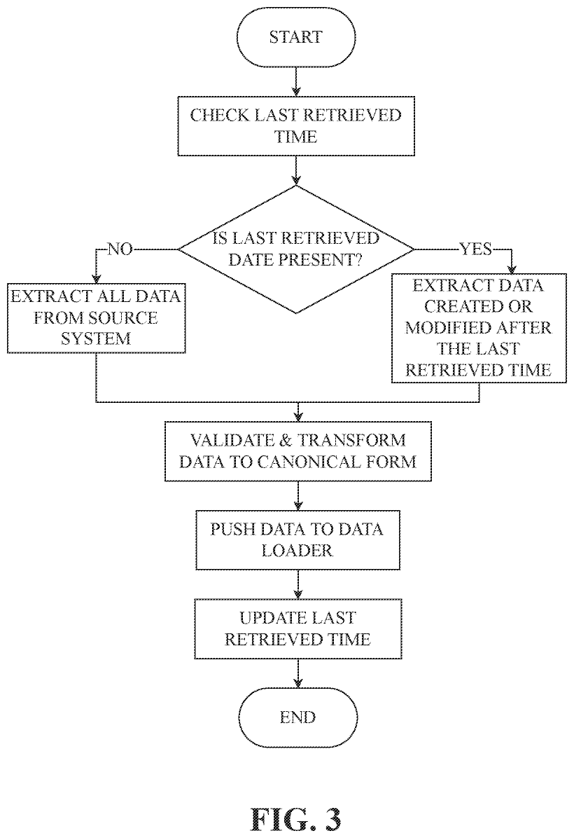

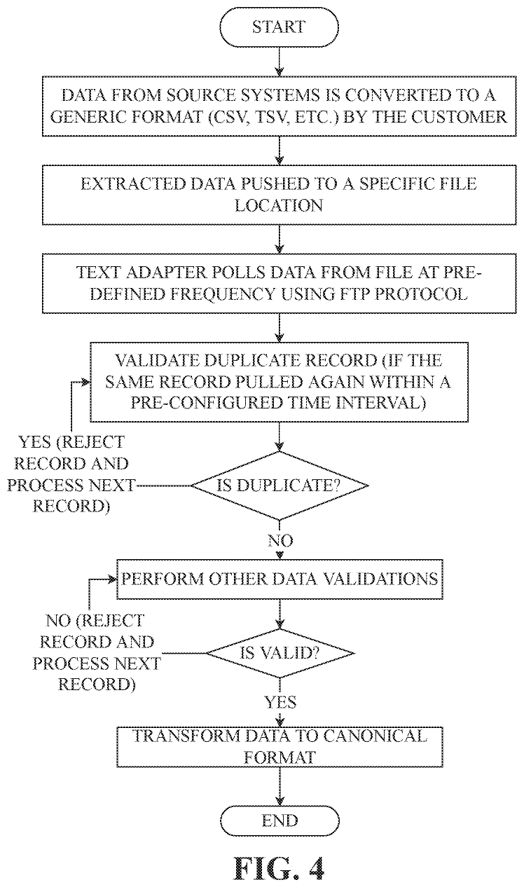

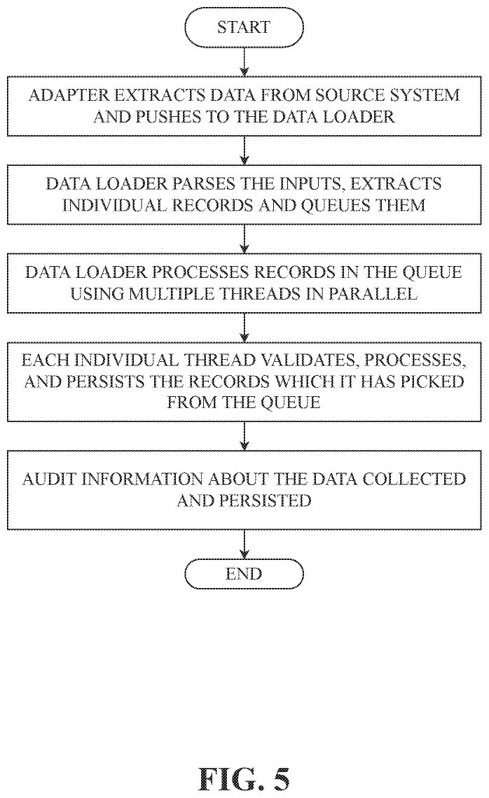

A number of flow diagrams provided in the drawings detail elements or steps that may be used by the systems and methods. The systems and methods extract data from source systems or data sources using source specific adapters and/or by using a generic adapter, as discussed above. FIG. 3 gives example steps that may be used in data extraction with a source-specific adapter. FIG. 4 gives example steps that may be used in data extraction with a generic adapter. FIG. 5 gives example steps that may be used by the data loader.

In implementations the rule engine comprises or consists of the following different components: a rule configurator; rule parser/persistence; a rule deployment engine; and a rule execution engine. The rule configurator is a user interface component that allows the RA analyst to configure and create a rule. Rule persistence relates to the rule being validated and persisted in the one or more databases. The rule deployment engine parses the rule, generates executables, and deploys the rule. The rule execution engine executes the rule, produces an outcome, and persists the outcome.

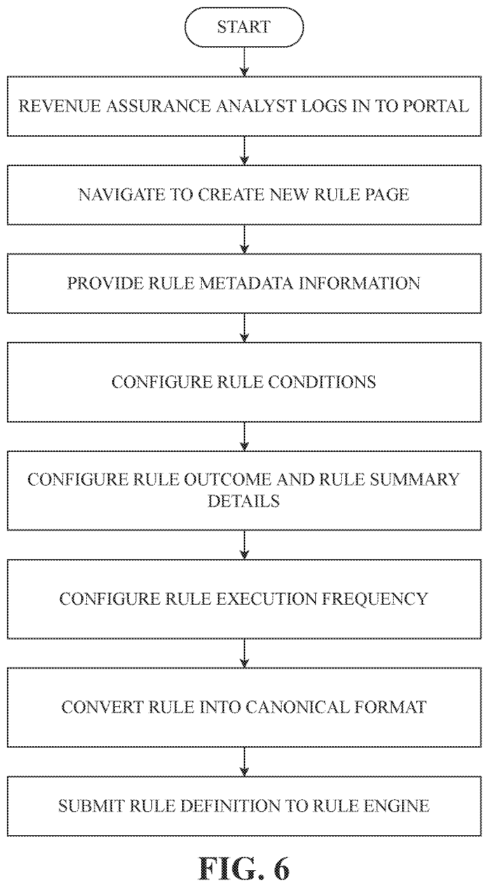

A number of flow diagrams provided in the drawings detail elements or steps that may be used related to the rule engine. FIG. 6 gives example steps that may be used by the rule configurator. The rule configurator allows a revenue assurance (RA) analyst to configure rules against the available dataset and also schedule the rule execution as per the business needs. The rule configurator converts the rule definition into canonical (for example JSON) format and submits it to the rule parser/persister. The conversion of the rule into canonical format may be done internally (not manually by a user).

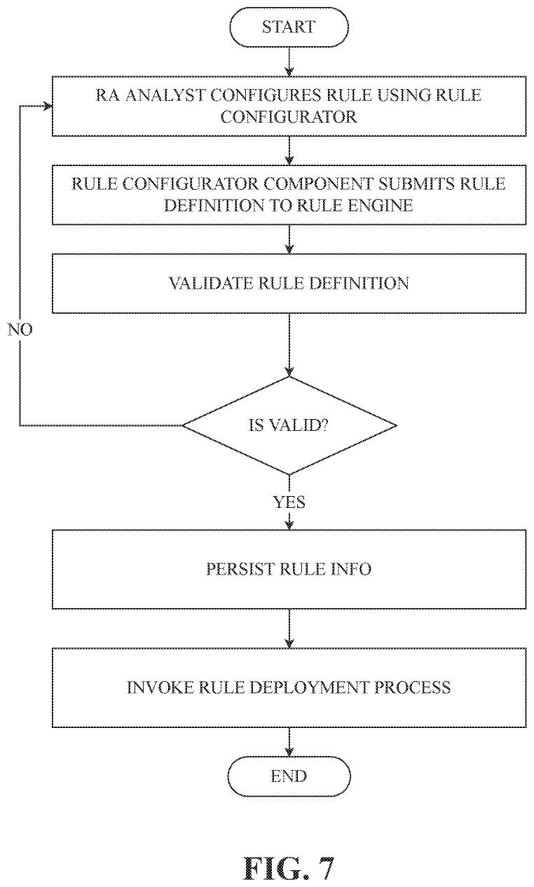

FIG. 7 gives example steps related to the rule parser/persister. The rule parser/persister parses the rule definition, validates it, and persists it to the database. In implementations the entire rule configuration is stored as canonical JSON format.

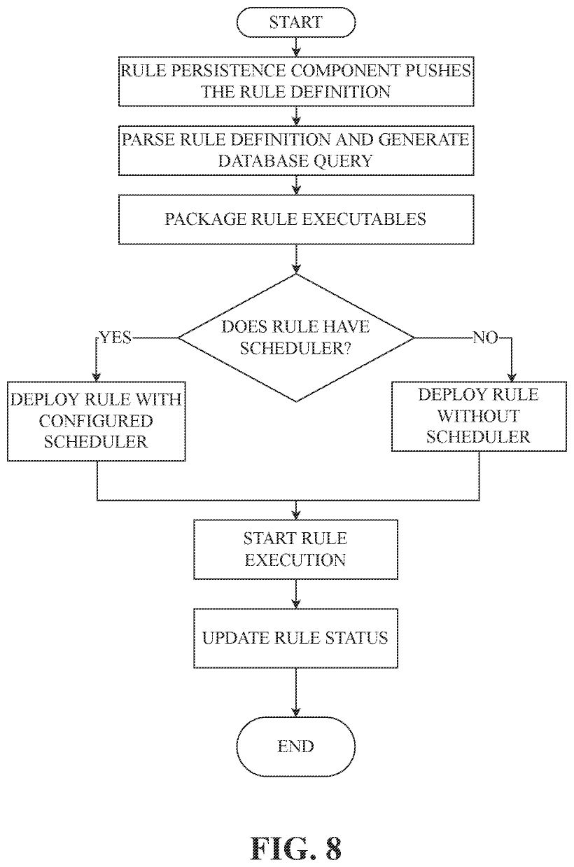

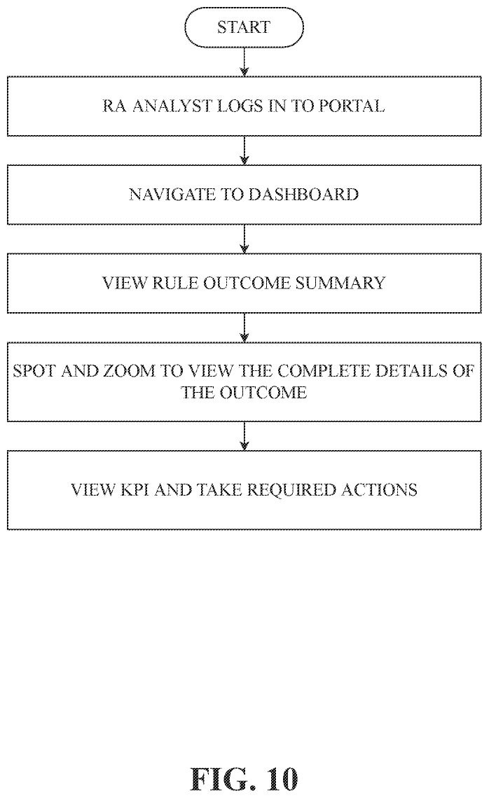

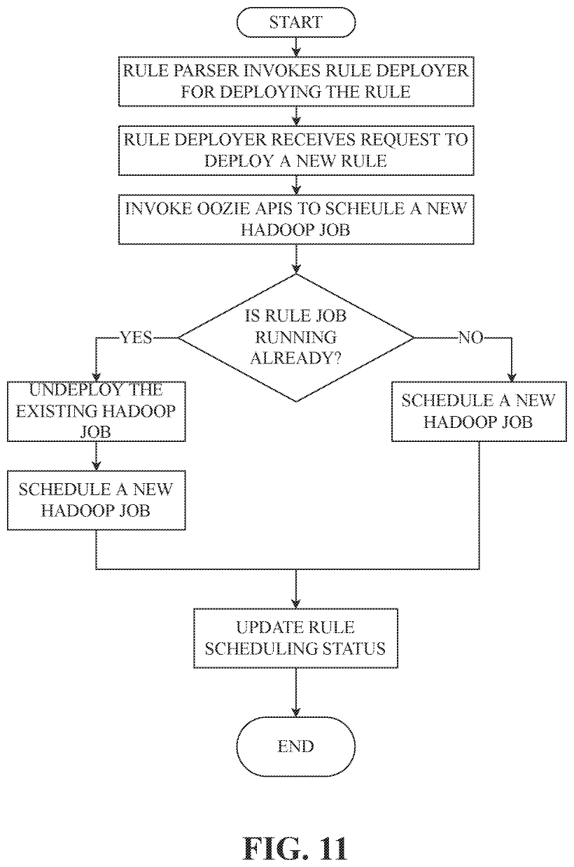

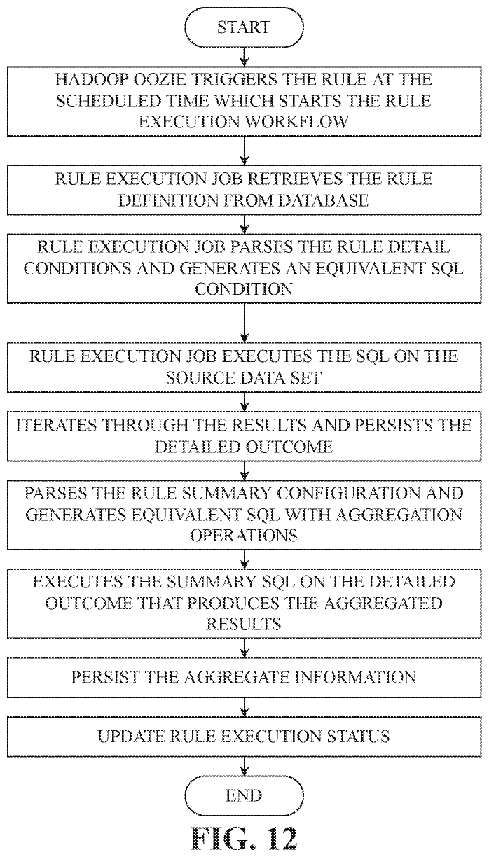

FIG. 8 gives example steps that may be used by the rule deployment engine (rule deployer). The rule deployer component is responsible for generating the runtime executables for executing a rule, deploying the rule, and starting the rule execution. In implementations the step of “Parse Rule Definition and Generate Database Query” may be excluded or not performed by the rule deployment engine and instead may be performed by the rule execution engine (see related steps/functionality in FIG. 12). The component supports both creation and updating of rules. In implementations, when a new rule is created the rule deployer component creates a new HADOOP job using OOZIE APIs and schedules it. When an existing rule is updated, the deployer component will remove the existing job and schedule a new one. FIG. 10 gives example steps that may be used by a presentation engine. FIG. 11 gives more or alternative example steps that may be used by the rule deployment component.

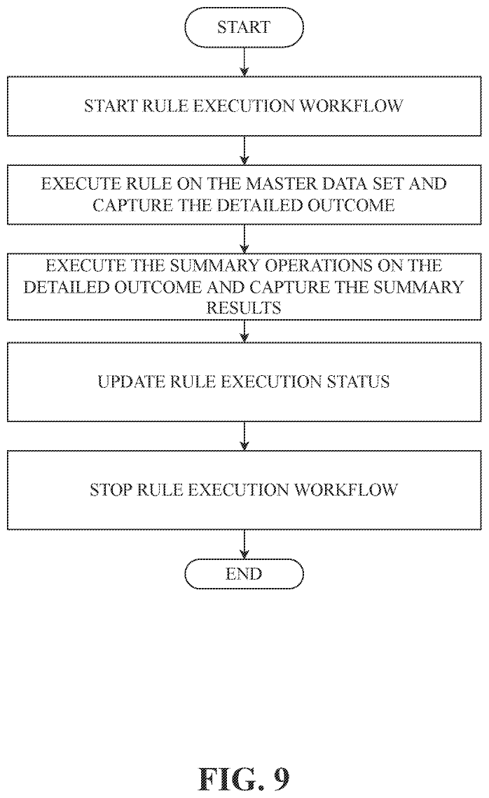

FIG. 9 gives example steps that may be used by the rule execution engine. In implementations each rule gets translated internally into an equivalent STRUCTURED QUERY LANGUAGE (SQL) command that is executed on the source data set. The result of executing this SQL command is nothing but the set of records that have a mismatch or have certain specific problems. These results are stored back into the one or more databases. The rule execution in implementations uses the parallel processing capability of the APACHE PHOENIX framework to process large volumes of data. In implementations the system internally uses a JAVA program for executing a rule. Each rule is a new instance of a JAVA program which executes the rule SQL on the data set and persists the results. Every time a rule executes, a new instance of the JAVA program is created. In implementations the JAVA program to execute a rule is a common generic code which is used across all rules—the system does not generate this code for each and every rule. In implementations the rule engine internally uses a HADOOP OOZIE framework to coordinate the rule execution workflow. FIG. 12 gives example steps that may be used by the rule execution engine.

Referring again to FIG. 2, the analytics server analyzes the data collected from various sources, applies different analytics, and produces the outcome. The analytics server in implementations includes a rule engine and a visualization engine. The rule engine allows the RA analyst to create different rules for analyzing the data. The RA analyst can create rules under different categories and schedule them to run automatically.

As indicated above, in implementations the rule engine includes the following components: a rule configurator; a rule parser/persister; a rule deployer; and a rule executor. There are many types of operations that are supported in a rule. The rule engine provides a powerful set of operators that the user can use to create a rule. In implementations the following operations and expressions are supported by the rule engine: all logical and Boolean operators; all mathematical operators (add, subtract, etc.); querying data within an entity; and querying data across different entities by joining them.

Rules allow the analyst to analyze the data. In implementations a rule comprises or consists of the following: rule metadata which includes a rule name, description, rule group etc.; a set of conditions on the attributes of the data collected from different sources; the rule outcome configuration that includes the list of attributes of the entities that should be available as an outcome; the rule dashboard configuration (users can configure the summary and aggregation functions on the outcome data—this summarized information may be available as a dashboard); and rule scheduling information (the rule can be scheduled to run at predetermined days/times and/or at predefined frequencies).

Referring still to FIG. 2, the visualization engine provides a visually enticing user interface which helps the RA analyst to analyze the revenue leakages. This engine could be implemented, for example, using ANGULAR JAVASCRIPT (JS) or REACT JAVASCRIPT. The visualization engine provides the ability to the RA analyst to fully configure and customize the dashboards. The UI Configurator of the visualization engine may be implemented using a configuration screen accessible by an admin. The widgets (related to groups, discussed in more detail hereafter) of the visualization engine may be components that are used for the development of user interfaces of the system. The visualization engine retrieves the data from the rule outcome (reconciliation outcome) repository and displays the information in varied formats like graphs and tabular data. In implementations the visualization engine will be multi-tenant enabled where the engine is capable of presenting visualization of a particular tenant based on tenant identification and a single instance of the visualization engine will process data for multiple tenants. This enables the visualization engine to host and manage multiple customers in a cloud-based environment and supports scalability in a public cloud environment.

In implementations the visualization engine comprises or consists of the following major components: simple dashboards; executive dashboards; dashboards with multiple insights; and an operational dashboard. The simple dashboards provide the RA analyst with various reconciliation reports across different business areas. The executive dashboards are targeted towards the executives of an organization. These dashboards provide insights on the end-to-end business processes of an organization and the major revenue leakage points within this process. The systems and methods provide for dashboards with multiple insights. This includes the capability to configure dashboards from multiple rule outcomes and display them together for better analysis of the data. The RA analyst can select more than one rule from a business area and create a dashboard. This allows data from different rules to be displayed together, which gives more meaningful insights into a particular business area. In implementations the operational dashboard is targeted for system administrators who will get end to end view of operations primarily focused on the following areas: system monitoring; rule creation monitoring; rule execution monitoring; KPI monitoring; and data loader monitoring.

Specific example user interfaces will now be described. Before getting into the user interfaces, a few definitions will be given or reiterated. The term “insight” as it is used with respect to the user interfaces means a reconciliation between various entities to drive an area of control gap that is a potential cause of revenue leakage. An example of this is accounts missed for billing. The term “context” as it is used with respect to the user interfaces is analogous to an insight in terms of configuration. However, the purpose of a context is to give overall information of a specific area. An example of this is total billing for the month. The term “group” as it is used with respect to the user interfaces refers to a simple configuration where multiple insights and/or contexts can be grouped to display related dashboards. This will provide analysts a comparison between the related insights and/or contexts in the same view. The term “KPI” or “key performance indicator” as it is used with respect to the user interfaces depends on a threshold violation in percentage, number or ratio and is formulated between insights or between entity and insights/context (entity to rule or rule to entity), entity to entity, or insights/context to insights (rule to rule). The term “business area” as it is used with respect to the user interfaces is a logical grouping of business processes of an organization where the systems and methods are used and the contexts and insights will be grouped under each relevant business area. An example is rating and billing.

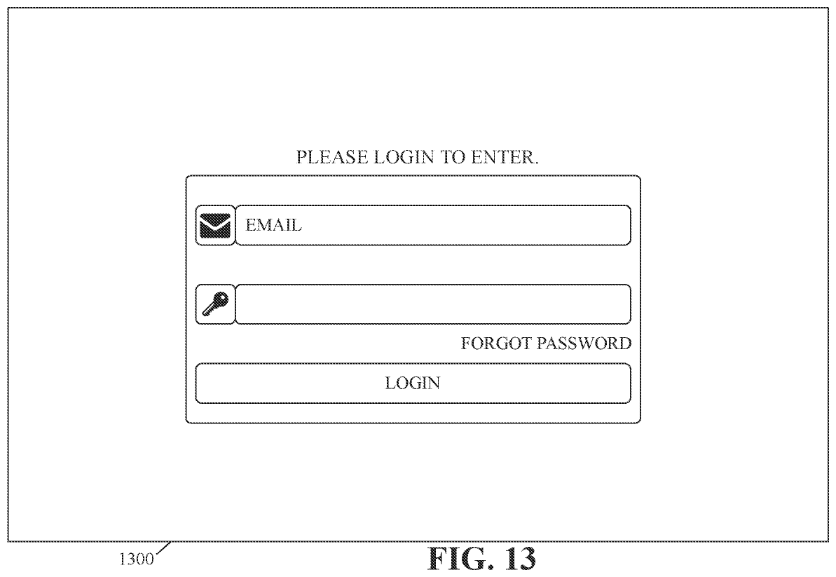

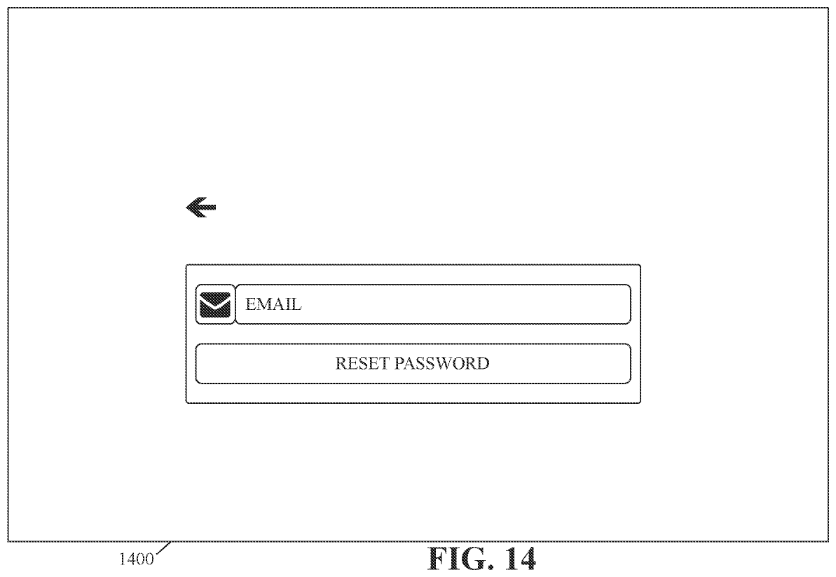

Referring now to FIG. 13, interface 1300 is a login screen. In implementations the login screen is the first screen the user sees upon opening the application uniform resource locator (URL). The login credentials may be created by an administrator (admin). Once a user is created, login details can be sent to the same email that constitutes the email identification (ID) as a link. Upon clicking on the link the user may log in and change the password as desired. From the login page, a user may select a “Forgot Password” selector to navigate to the interface 1400 of FIG. 14. Once the user is on this page the user may enter a valid email ID to have a link emailed to reset the password. The user can also select the back arrow to return to the login interface 1300.

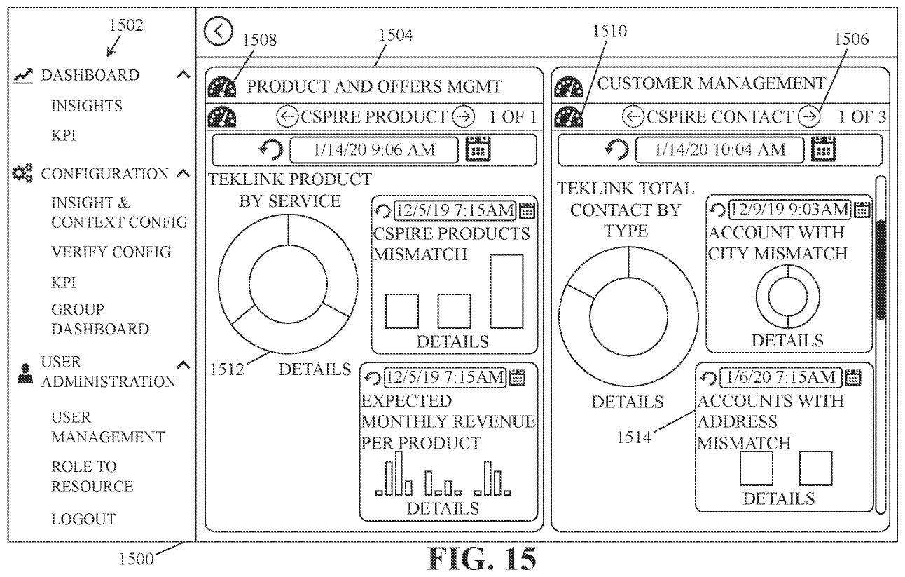

Once the login is successful, it will navigate the user to the insight interface (summary interface) 1500 of FIG. 15, which is the home page of the application. Based on access control the insights will be displayed on this page. The insight interface has been kept simple to allow the analyst to view and navigate the application with mostly click-to-operate. The left hand side includes an operation menu 1502. The operation menu is divided into different sections and subsections as follows: Dashboard (Including Insights and KPI); Configuration (including Insight and Context Configuration; Verify Configuration; KPI; and Group Dashboard); and User Administration (including User Management, Role to Resource; and Logout).

The interface 1500 also includes a number of business areas 1504 (the examples shown are: Product and Offers Management; and Customer Management). With regards to a business area, all product/service industries have life cycle from product/service to cash. Each process is logically grouped under one business area and these areas are fully configurable from the backend. For example: (1) product and offers management; (2) customer management; (3) order entry and provisioning; (4) network and usage management; (5) rating and billing; and (6) finance and accounting.

Below the business area names are shown group names (the examples shown are CSPIRE Product and CSPIRE Contact—CSPIRE is used herein only as a representative example). Previous and Next selectors 1506 allow the user to navigate between multiple groups (group names) of a given business area (for the CSPIRE Contact group on the right there are three groups and the interface is presently displaying group 1 of 3, whereas for the CSPIRE Product group on the left there is only one group so the interface is presently displaying 1 of 1). Each business area may have a default group, which may be configured to be different for individual users based on user role. This may be done using a group configuration interface which will be described later. If there is no group or default group configured for a particular business area, that business area may display “no group found” or the like. Under each business area/group name are displayed group dashboards which contain context(s) 1512 and insights 1514. Group dashboards can be created to group multiple related insights/context(s) under each business area. These groupings of insights and/or contexts are called “groups” and “graph groups” herein (inasmuch as each insight or context displays a graph), and are configurable using interface 2900, which will be discussed hereafter. For example, “CSPIRE Product” on interface 1500 may be called a “group” or a “graph group” inasmuch as it displays a group of graphs under the Product and Offers Mgmt business area. The same can be said for CSPIRE Contact, it may be called a “group” or a “graph group.”

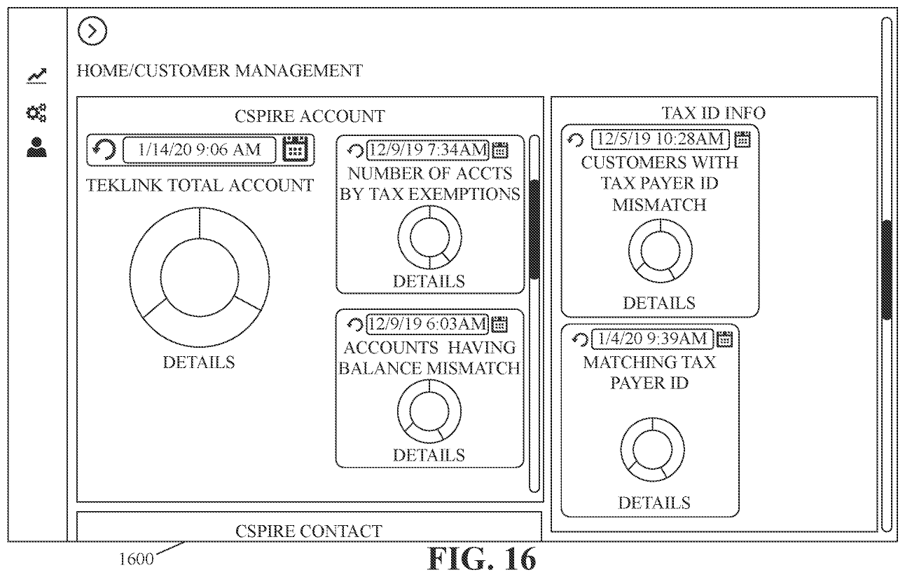

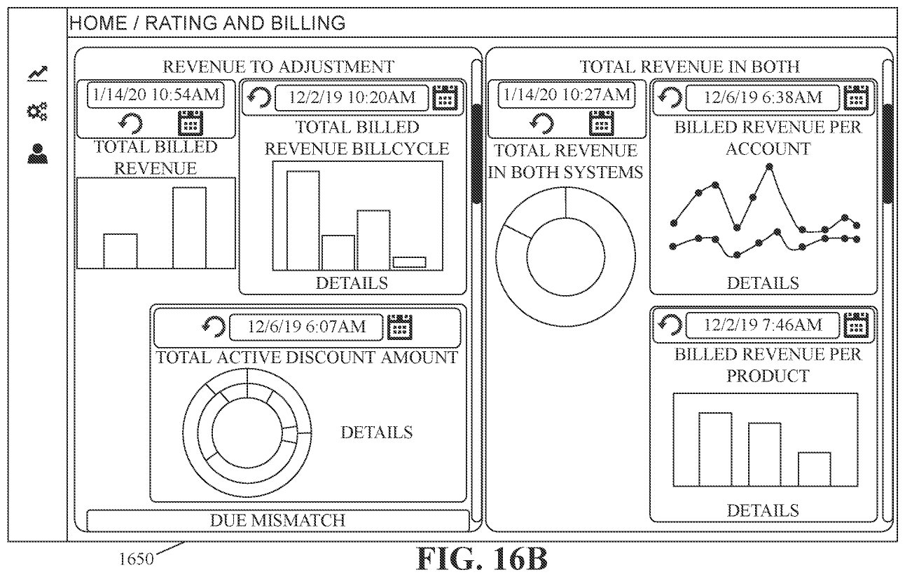

Selectable icons 1508 and 1510 allow a user to see all groups (i.e., all group dashboards) of a business area and all insights and context(s) (each of which may include graphs) of a group, respectively. Upon selection of an icon 1508 an all group dashboard interface such as interface 1600 of FIG. 16 is shown. In the example of FIG. 16 the user has selected the icon 1508 corresponding with the “Customer Management” business area on the right hand side of FIG. 15. FIG. 16 accordingly shows all group dashboards for the Customer Management business area (the groups shown include CSPIRE Account, Tax ID Info, and CSPIRE Contact). The screen (and sub-portions of the screen) may be scrolled to see all of the information. FIG. 16B is another example of a view of all dashboards of a business area, but interface 1650 of FIG. 16B shows group dashboards for a “Rating and Billing” business area. Interface 1500 may be configured to show custom groups under a business area, but the all group dashboard interfaces (such as interfaces 1600 and 1650) will show all groups for a given business area, not just those in a configured custom group.

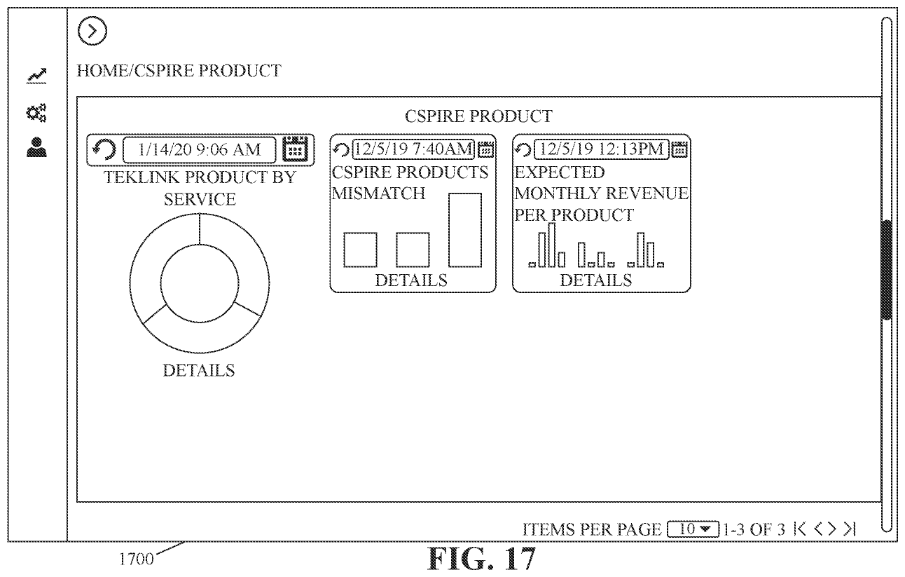

Referring back to FIG. 15, upon selection of an icon 1510 a detail group interface such as interface 1700 of FIG. 17 will be shown. This shows all insights and context(s) (each of which may include graphs) for the selected group. In the example of FIG. 17 the user has selected the CSPIRE Product group. Interface 1500 may be configured to show only a subset of insights and contexts (each of which may include graphs) for a particular group, but interface 1700 may show all of the insights and contexts (including all graphs) for the selected group.

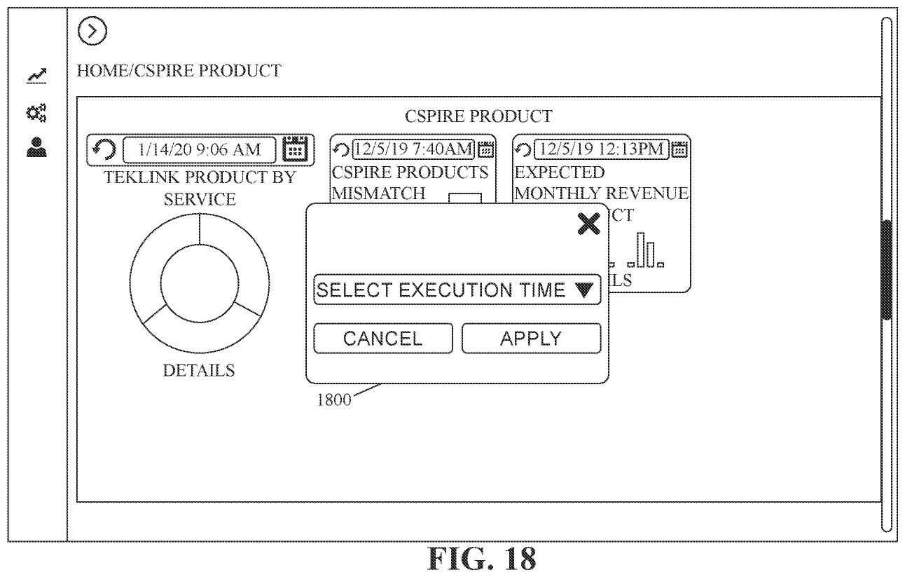

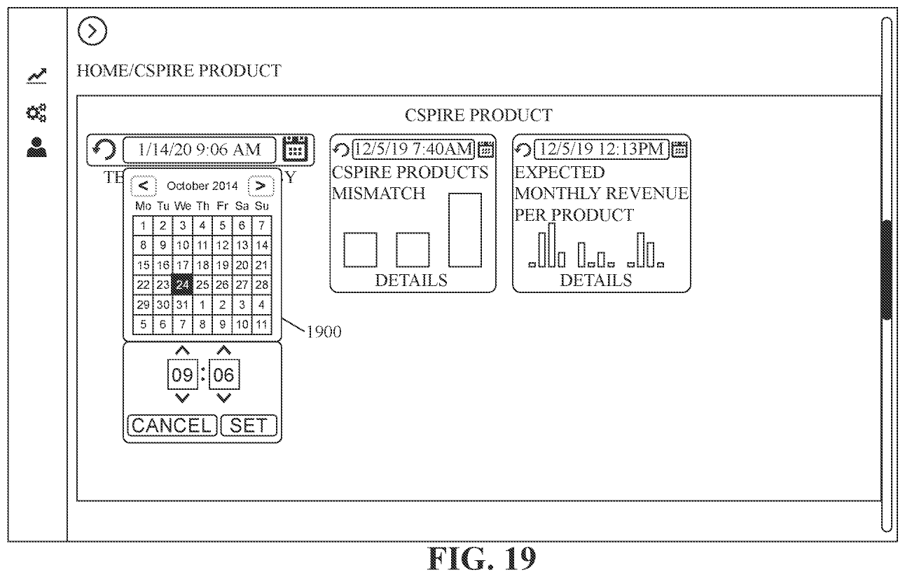

Referring to FIG. 18, historical dashboards and corresponding data for a context or insight may be displayed by clicking on the history icon (revolving arrow). A popup 1800 is shown in FIG. 18 which asks the user to select an execution time and then either to apply or to cancel. For example, the user may select an execution that was performed a week ago to see the corresponding data/graph for the context or insight from a week ago. Referring to FIG. 19, the user may also select the calendar icon for a context or insight and then select a date and time on a calendar interface 1900, and then select “set” to see results based on the selected date/time, or “cancel” to exit the calendar.

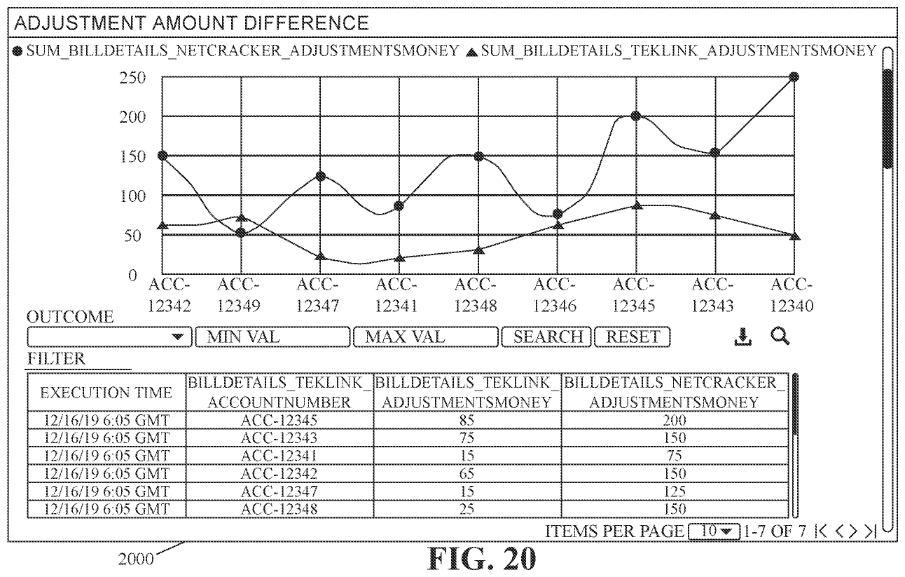

It is shown in FIGS. 15-19 that “DETAILS” selectors are shown at the bottom of the dashboard contexts and insights. When the “DETAILS” selector is selected for any given insight or context a details interface such as interface 2000 of FIG. 20 is displayed. The details interface may include the following features: (1) a detail graph (as seen in the top half of FIG. 20) with zoom options (such as using a mouse wheel); (2) an outcome table (as seen in the bottom third of FIG. 20); (3) a filter option; (4) a min/max value search for a particular column; (5) wildcard search; (6) an option to download an EXCEL spreadsheet or other file format with outcome details; and (7) pagination allowing the user to navigate between different pages (seen at the bottom of FIG. 20). The type of graph shown in interface 2000 may depend on the settings and/or the type of data—in FIG. 20 two graphed lines are shown on an X-Y coordinate system, but in other implementations a bar graph, pie chart, or other type of graph could be shown.

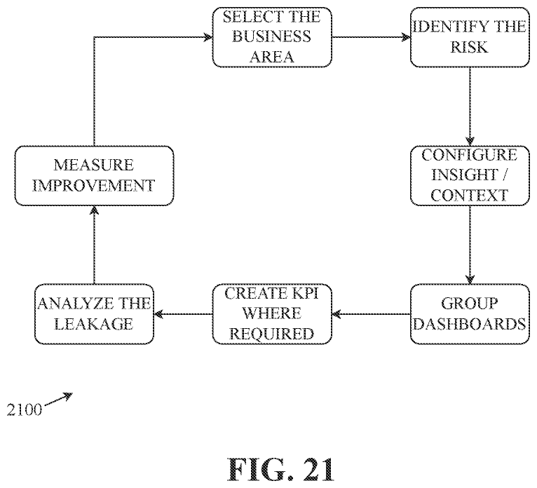

FIG. 21 shows an example workflow that a user may follow using system 100 and its user interfaces described herein, starting with selecting the business area. The user may continuously or repeatedly go through this workflow, in some cases skipping certain steps as appropriate. Some of the workflow steps will be discussed in more detail below by referring to specific user interfaces.

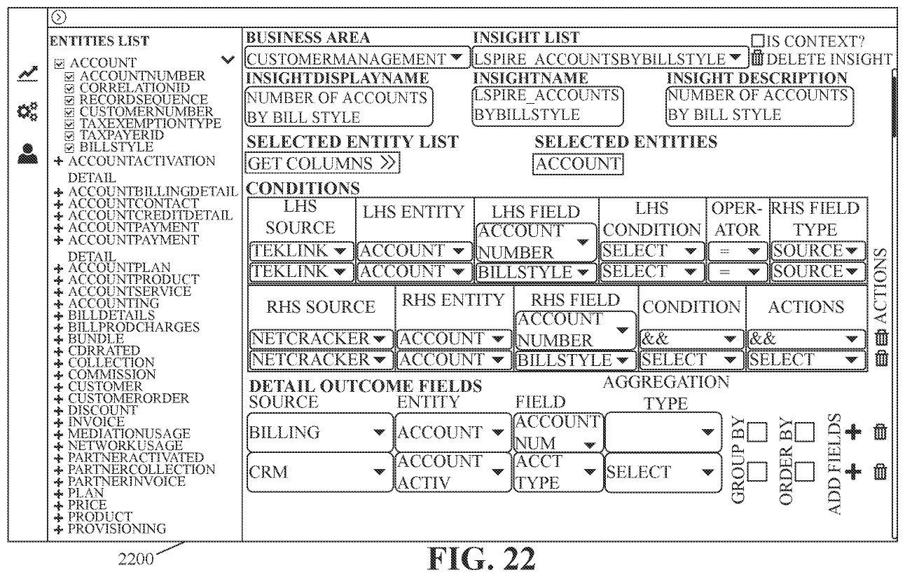

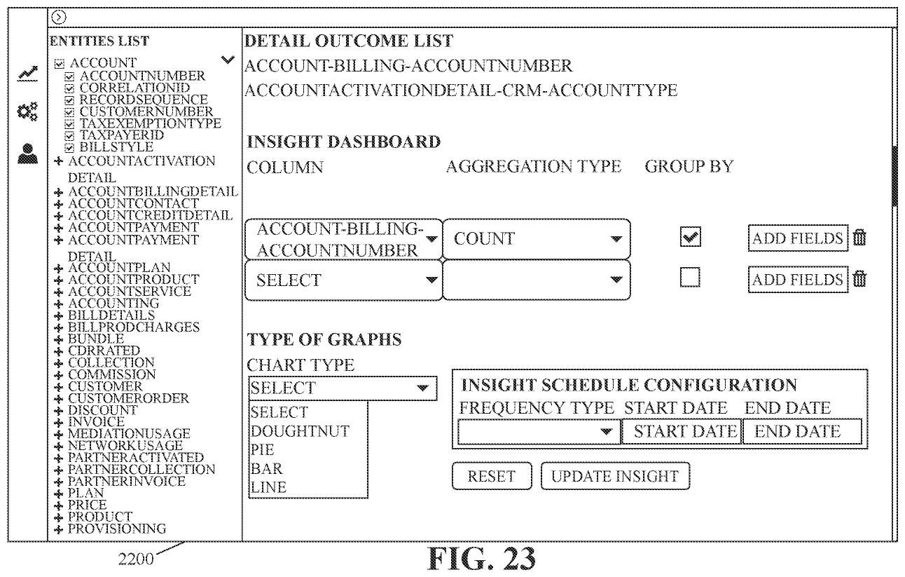

Referring back to FIG. 15, if the user selects on “Insight & Context Config” under the “Configuration” menu item the user is brought to an insight/context configuration interface such as first rule interface (rule interface) (interface) 2200 of FIGS. 22-23. FIG. 23 is a continuation of FIG. 22 but scrolled down further on the page. This interface includes several input fields and is used to create a “rule” or query, and accordingly is called herein a “rule interface” in some places. On the left hand side of FIG. 22 is shown an entities list that includes selectable entities and entity fields. For example, the listed entities are Account, AccountActivationDetail, AccountBillingDetail, AccountContact, etc. A user may select the plus icon next to any entity to expand it and show its individual fields. For example, the Account entity has been expanded and the selectable fields are AccountNumber, CorrelationID, RecordSequence, CustomerNumber, TaxExemptionType, TaxPayerID, and BillStyle. The user may select one or more fields of a given entity (selecting a field may automatically select an entity, but within an entity the user may determine which fields to select/deselect). Each entity of the entities list may have different fields. Entities are tables from different resources. Each entity may have multiple entity fields. To build a query a user will need to select one or more of the entity fields.

At the top of interface 2200 are several insight/context selectors, including: a business area selector; an insight list selector; an “is context” selector; an insight display name field; an insight name field; an insight description field; and a delete insight selector. These fields are used to set up basic details under a business area. The business area selector allows the user to select any of a number of business areas related to a subscription model. The user can select any business area to configure insights for that business area. Implicit in FIG. 22 is that system 100 includes one or more other interfaces for adding, editing, and deleting the business areas themselves, since in FIG. 22 the business areas are selectable from a dropdown list. The practitioner of ordinary skill in the art will understand how to set up one or more user interfaces for this purpose, so that it is not necessary to include them in the drawings. The data sources described with respect to FIG. 2 are used to populate the one or more databases of the system with business revenue-related source data, and the imported data may be associated through the one or more databases with business areas so that when the user selects business areas on any of the user interfaces (such as interface 2200) the data that will later be retrieved as a result of any query from that screen may be business revenue-related source data relevant to the selected business area.

The insight list of FIG. 22 will include a list of insights which the user has previously configured, and the user may select any of the previously configured insights to edit the insight and update it using interface 2200. The user can also select a “new” or “add” item from the dropdown list (or simply not select anything from the dropdown list) to create a new insight. For example if the user creates a new insight, many of the fields of interface 2200 will be blank or awaiting user input. If the user selects an insight already on the list many or all of the fields may already be filled/selected and the user may be able to update the insight. Although the Insight List selector is a dropdown list, and several of the other selectors of FIG. 22 are dropdown lists, other types of selectors or fields (such as radio selectors, free text fields with text prediction to show relevant options, checkboxes, and so forth) may be used for any of the selectors/fields.

The “is context” selector in the example of FIG. 22 is a checkbox field. By default it may be false. If the user checks the box, then the insight will be created/defined as context. The insight display name field is a text field, which the system/application will display as a title for the visualization aspects of the system/methods. The insight name field is a text field and must be unique. The user cannot create an insight with the same name as another insight. In the representative example the format allows no spaces, so underscores are used between words where desired. The insight description is a text field which the user may use to give a meaningful description for the insight in question. The delete insight selector, if selected, will bring up a popup to alert the user that the insight will be deleted. If the user selects to proceed, the insight will be deleted.

A selected entity list “get columns” selector is shown. In order to use this selector the user first clicks on an entity in the entities list on the left side, which upon selection will open the list of entity fields with checkboxes. The user selects all or which entity fields the user wants to query. Once the user has selected the entity and entity fields, the user clicks on the get columns selector/button and then the selected entities will be displayed under the “selected entities” area. For example, in the example shown in FIG. 22 the user has selected the “account” entity and all entity fields of the “account” entity, the user has already selected the “get columns” selector, and the “selected entities” area displays the “account” entity as being selected. The entity fields are used in other fields of interface 2200 to produce a query for a required output, as will be described below.

The “conditions” section of interface 2200 is used to make queries. The selectors/fields include LHS source, LHS entity, LHS field, LHS condition, operator, RHS field type, RHS source, RHS entity, RHS field, condition, actions, and delete selectors. The LHS and RHS acronyms stand for “left hand side” and “right hand side” of a mathematical calculation/equation. There are multiple sources which will be selectable from the LHS source field, for example Billing, CRM, TEKLINK, NETRACKER, etc. These potential sources, such as CRM, TEKLINK, NETRACKER, and others, are only used herein as representative examples, and other data sources could be used in other implementations. The selectable “source” relates to the “source systems” of FIG. 2. In other words, the user is here identifying a data source. System 100 may have already organized the source data into tables and columns and the like in one or more relational databases or data stores, for example, for each source of data, and the entities list may simply reflect the tables/columns etc. that are already stored and available for creating insight/context rules. The practitioner of ordinary skill in the art will understand how to organize the source data in such a way, so that a detailed description is not needed here. The entities list, however, may include entities that were input by an admin or the like (so that the source data is organized by the input entities and entity fields) or the entities list could be automatically populated using source data, in implementations.

The LHS entity field allows for the selection of one of the previously selected entities. For example, if the user had selected the “account” and “account activation detail” entities and then selected “get columns,” then the LHS entity field allows the user to select either “Account” or “AccountActivationDetail” for the LHS entity.

The “LHS field” selector displays the previously selected fields that are associated with the selected entity of the LHS entity field. For example, if the user has selected “Account” for the LHS entity field then the “LHS field” selector includes options of AccountNumber, CorrelationlD, RecordSequence, etc. In the top LHS Field of FIG. 22 the user has selected AccountNumber. By selecting one of the available entity fields the user is selecting one or more data associated through the one or more databases with the selected data source.

The LHS condition field, in implementations, would allow for the entry of a mathematical operator (+, −, *, /) and either a constant or a field value so that the left hand side comprises a sum, subtraction, multiplication, or division of two values. For example the user could multiply the left hand side by 100 using this field so that the rule outcome is a percentage instead of a ratio. As another example, the user could use the LHS Condition field so that the left hand side adds, subtracts, multiplies, or divides two fields. For example the left hand side could use the LHS condition field to add current credit card usage plus credit card payments due and the right side could be the credit limit, with the operator “more than” used, so that the outcome reflects credit card accounts for which the credit card payments due plus the credit card usage is above the credit card limit. In implementations when the user selects a mathematical operator (+, −, *, /) from the LHS Condition dropdown one or more additional fields will appear for the user to insert a constant or another field. In implementations, as in the example of FIG. 22, the LHS Condition field may not be used (and so may be left on the “Select” selection).

The Operator selector allows the user to select a condition/operator between two tables. This may include (or consist of) the selection of a mathematical symbol. For example, representative operators could be: =(equal to); !=(not equal to); >(greater than); >=(greater than or equal to); <(less than); <=(less than or equal to); etc. The RHS Field Type selector allows the user to select either “source” or “constant.” Based on the selected type the fields to the right of this (wrapped around to another row in FIG. 22) will vary. If the user selects “source” then the user will need to select the source, the entity, and the entity fields as was done for the left hand side (by selecting one of the available entity fields the user is selecting one or more data associated through the one or more databases with the selected RHS data source). If the user selects “constant” then the RHS Source and RHS entities will not have selectable fields and the RHS Field selector will switch to a text input field for the user to input a constant value.

There are multiple sources which will be selectable from the RHS source field, for example Billing, CRM, TEKLINK, NETRACKER, etc. The selectable “source” relates to the “source systems” of FIG. 2. In other words, the user is here again identifying a data source from which the query will be made.

The RHS entity field allows for the selection of one of the previously selected entities. For example, if the user had selected the “account” and “account activation detail” entities and then selected “get columns,” then the RHS entity field allows the user to select either “Account” or “AccountActivationDetail” for the RHS entity. Note, though, that the “Account Number” field may have a different value when the source is different—for example in this example the LHS Source is TEKLINK and the RHS source is NETCRACKER, so the account numbers of the respective tables may be different.

The “RHS field” selector is a dropdown of the previously selected fields that are associated with the selected account of the RHS entity field. For example, if the user has selected “Account” for the RHS entity field then the “RHS field” selector includes options of AccountNumber, CorrelationlD, RecordSequence, etc.

The “Condition” field allows the user to select either “&&” or “∥” (or no selection, for example for the last condition) to indicate “and” or “or.” When the user is making multiple queries, the user will use the && (and) or ∥ (or) condition. After selecting “and” or “or,” another row will be generated with the same fillable fields and selectors. For example, in the example of FIG. 22 there are two conditions, one using AccountNumber as the LHS field and another using BillStyle as the LHS field. In this case after the user had made selections for the first wrapped row (all the way from TEKLINK to the && Condition) the second wrapped row was generated, and in this row the user made selections (all the way from TEKLNIK to the BILLSTYLE RHS Field). In implementations with large enough user interfaces the Conditions rows may not need to be wrapped. Any condition/row may be deleted using the trash icons under “Actions.” Because of the way the rows wrap in FIG. 22, if the user selected the bottommost trash icon under “Actions” (next to the “SELECT” selector) then that row all the way wrapped back around to the LHS Source “TEKLINK” field would be deleted. It is also pointed out that a user may be able to generate a second row by selecting && or ∥ for the Condition before the first row selections are made.

In implementations user selection of the various fields allows a user to define rule conditions without any SQL knowledge. The user uses conditions/filters to compare between different entities and their corresponding fields and values, and the system generates the proper queries behind the scenes based on the user selections. This results in an improvement in the functioning of the computing system/computer itself because it ensures that all queries are properly formatted, which increases efficiency and reduces debugging needs, and reduces potential coding errors. Poor SQL query design is one of the top SQL SERVER performance killers. The use of the fields of the user interfaces discussed herein prevent improper SQL query formatting, thus removing the potential performance degradation due to poor or improper query formatting, and thus inherently improve the functioning of the computer(s) and system(s) involved in the data retrieval and the methods disclosed herein.

As a representative example of the Conditions fields, suppose the user wants to find all accounts that are present in SALESFORCE (CRM) and ZUORA (billing) and that have a due amount in ZUORA greater than $1,000. In a first Conditions row the user will select for the LHS (left hand side—what to compare) the LHS Source of SALESFORCE. The LHS entity will be selected as Account (i.e., CRM), then the LHS Field accountNumber (i.e., account ID) will be selected. The LHS condition field will not be used for this row, so it is skipped. The Operator is selected as “=” and then the RHS (right hand side—compare to) fields will be selected. The RHS Field Type can be selected as Source (to select another entity) or Constant (to compare to a direct value)—in this example Source is selected and the RHS Source field of ZUORA is selected. RHS Entity is selected as “Account” and the RHS Field is again the account ID (accountNumber). This completes the first clause/row (CRM.Account ID=Billing.Account ID). The second clause/row will be that the amount due in ZUORA is greater than $1,000. In the first row, the user selects the Condition as AND (&&), which automatically adds a row for the user to add the second clause. In the second row the user selects the LHS Source as ZUORA, the LHS Entity as AccountBillingDetails, the LHS field as Due, the LHS Condition is again skipped, the LHS Operator is selected as “>” (more than), the RHS Field Type is selected as “constant,” and the RHS Field is entered as 1,000. This completes the second clause (Billing.Due>1000). The two rows together define a rule that finds all accounts that are present in both SALESFORCE (CRM) and ZUORA (billing) and that have a due amount in ZUORA greater than $1,000. The rule is essentially a SQL database query which retrieves data from the one or more databases (associated with the selected one or more sources). Accordingly, the query is defined at least in part by the entries/selections that the user makes in the Conditions fields. When the data is later displayed in a graph or table as will be described below, the graph and/or table representatively illustrate and/or list the data retrieved from the one or more databases as a result of the database query.

Referring still to FIG. 22, the Detail Outcome Fields section will now be described. There are several fields/selectors in this section. The source field allows the user to select a source, similar to other fields described above. The entity field allows the user to select an entity and the “Field” field allows the user to select an entity field, similar with other selectors/fields described above. The Aggregation Type selector allows the user to select an aggregation type (such as count, sum, avg, min, and max) and the Group By and Order By selectors allow the user to select to have the detail outcome fields either grouped by, or ordered by, the selected row (discussed further below). The Add Fields selector will add another row, while the trash icon will delete the respective row. Once the user selects the relevant fields in the Detail Outcome Fields section, a Detail Outcome List will be shown, as shown at the top of FIG. 23, which will list the entity, source and entity field for each entry that was added using the Detail Outcome Fields.

Referring to FIG. 23, the Insight Dashboard is used to plot a graph. The Column selector allows the user to select one of the items listed in the Detail Outcome List that was previously generated. The user can then select an aggregation type (such as count, sum, avg, min, and max) and the Group By selector allows the user to select to have the query group the outcome by the selected row (discussed further below). The Add Fields selector allows the user to add one or more rows and the trash icon allows the user to delete a row.

With regards to the “Group By” and “Order By” functions, “Group By” is used to group a rule outcome by some category, e.g., showing customers grouped by states or showing product revenue grouped by product class. As previously described, the aggregation type for a row can be sum, count, min, max, avg, and so forth. Once an aggregation is applied to a row, another row can be added for the “Group By” function and/or another row for the “Order By” function. For example, assume the user wants to show total expected monthly recurring charge (MRC) grouped by “product from billing” and ordered by “start date.” In the first row of the Detail Outcome Fields the user can select ZUORA (the subscription entity from billing) as the source, AccountProduct as the entity, recurChargeMny as the field, and sum as the aggregation type. The user can then add a row and select ZUORA as the source, AccountProduct as the entity, productId as the field, leave the aggregation type blank, and select “Group By.” The user can add another row and select ZUORA as the source, AccountProduct as the entity, startDate as the field, leave the aggregation type blank, and select “Order By.” The rule will then output a sum of monthly recurring charges grouped by product identification (ID) and ordered by start date. The Detail Outcome List in this case will then show “AccountProduct-ZUORA-recurChargeMny (sum)” followed by “AccountProduct-ZUORA-productld” followed by “AccountProduct-ZUORA-startDate.”

The Type of Graphs section of FIG. 23 allows the user to select a graph type for the data that will be plotted. In the example shown the options are doughnut, pie, bar, and line graphs.

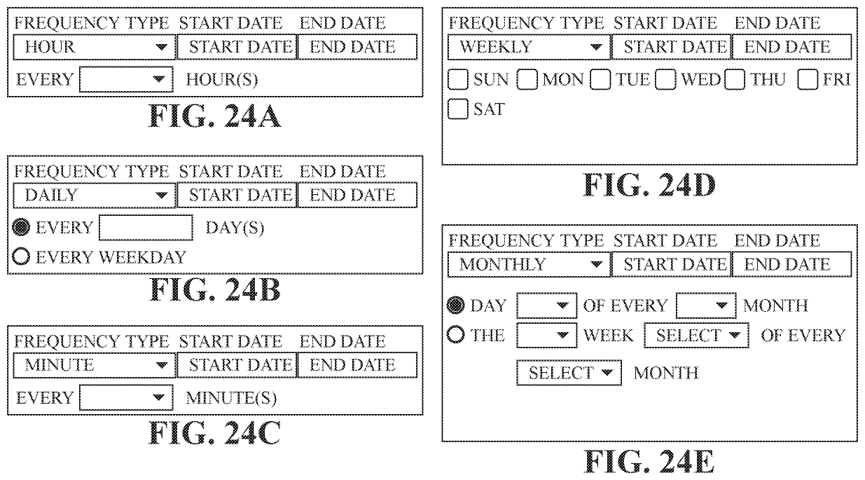

The Insight Schedule Configuration section of FIG. 23 will be used to make a schedule for a particular query. The execution will happen based on the selected time. The frequency type may include, for example, options of hour, daily, minute, weekly, and monthly. FIGS. 24A-24E show scheduling interfaces including frequency input fields that are used to, in response to receiving one or more user inputs, automatically initiate execution of the database query(ies) set up on interface 2200 on a repeating schedule. Referring now to FIG. 24A, if the user selects “hour” then the user can select a number of hours, a start date, and an end date, and the query will repeat every selected number of hours between the start and end date. Referring to FIG. 24B, if the user selects “daily” then the user can select a start date, an end date, and a number of days (or every weekday) and the query will repeat every selected number of days (or every weekday) between the start and end date. Referring to FIG. 24C, if the user selects “minute” then the user can select a number of minutes, a start date, and an end date and the query will repeat every selected number of minutes between the start date and end date. Referring to FIG. 24D, if the user selects “weekly” then the user can select a start date, an end date, and can select a day of the week whereon the query will repeat on a weekly basis between the start and end date. Referring to FIG. 24E, if the user selects “monthly,” then the user can select a start date and end date and can select to run the query every selected day of every selected number of months or a selected day of a selected week every selected number of months between the start date and end date.

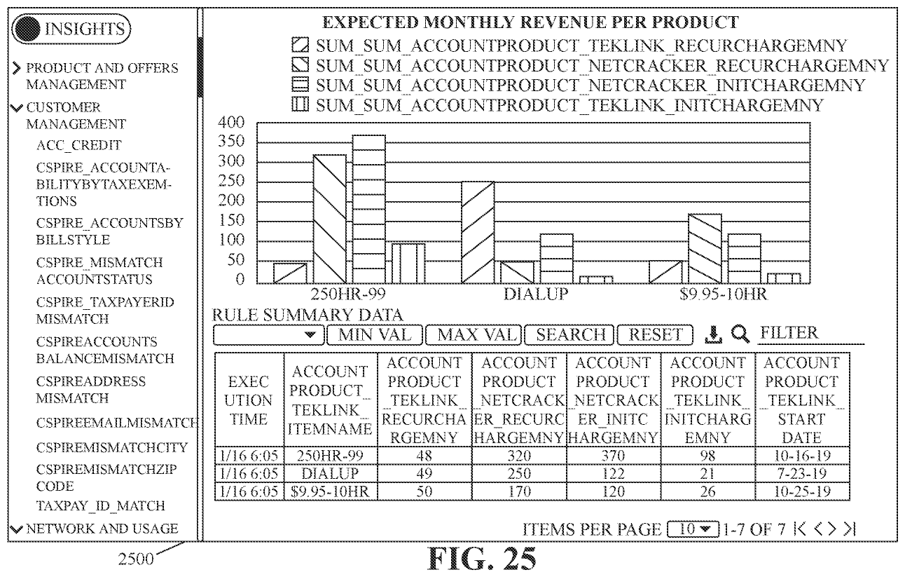

After setting up the insights using interface 2200 of FIGS. 22-23 and one of the scheduling interfaces of FIGS. 24A-24E (which may simply be a part of interface 2200 which appears upon selection of the frequency type), the user can navigate to a verify insight/context interface such as interface 2500 of FIG. 25. For example, the user could navigate here by selecting “Verify Config” under the “Configuration” section of interface 1500. Interface 2500 has a toggle at the top that allows the user to switch between viewing the insights or the context(s). This page is used to see the result of the query(ies) the user has set up for the specific insights. Interface 2500 may show one insight/context at a time. The left hand menu may show a list of the business areas with sub-lists that can be expanded to show all insights for each business area. The main business areas in this example are Product and Offers Management, Customer Management, Network and Usage Management, and Rating and Billing (not shown). A sub-list below the Customer Management business area shows a number of insights that are available, including for example an ACC_Credit insight, a CSPIRE_AccountabilityByTaxExamptions insight, and so forth. These are insights that the user has set up using interface 2200. The user may be able to scroll on the left hand side to see more of the list, and the user may be able to scroll on the right hand side if all of the graph and other information is not visible in the user's screen. The user may be able to navigate to different pages using the selectors at the bottom of the page. The user in this case has selected an Expected Monthly Revenue Per Product insight (not shown in the left hand list). On the top half of the right hand side is shown a graph outcome from this selected insight (which shows that the user selected “bar” as the graph type), and on the bottom half of the right hand side is shown a detail outcome of the selected insight. Interface 2500 may be called a “rule outcome interface” inasmuch as it displays results of the outcome(s) of the rule(s)/query(ies) set up on interface 2200.

In the example of FIG. 25, for example, the user has set up this insight to show initial charges and recurring charges for various services based on data from TEKLINK and NETCRACKER source data. The table in the bottom third of the right side of interface 2500 includes values retrieved from the database using the query(ies) set up by interface 2200 and/or calculations based on the data retrieved from the database using the query(ies). It can be seen for the DialUp service the NETCRACKER source data, when queried or calculated on January 16 at 6:05, shows an initial charge of $122 and a recurring charge of $250 (these could be represented as thousands of dollars, or more, for example, for a large organization). For the DialUp service the TEKLINK source data, when queried or calculated on January 16 at 6:05, shows an initial charge of $21 and a recurring charge of $49. Accordingly, the user in this case has set up an insight that shows initial charges and monthly charges, as queried from the TEKLINK and NETCRACKER source data, for a DialUp service (and also for a 250HR-99 service and a $9.85-10 HR service). This is just one example of an insight, and the user could set up various other insights based on the data sources.

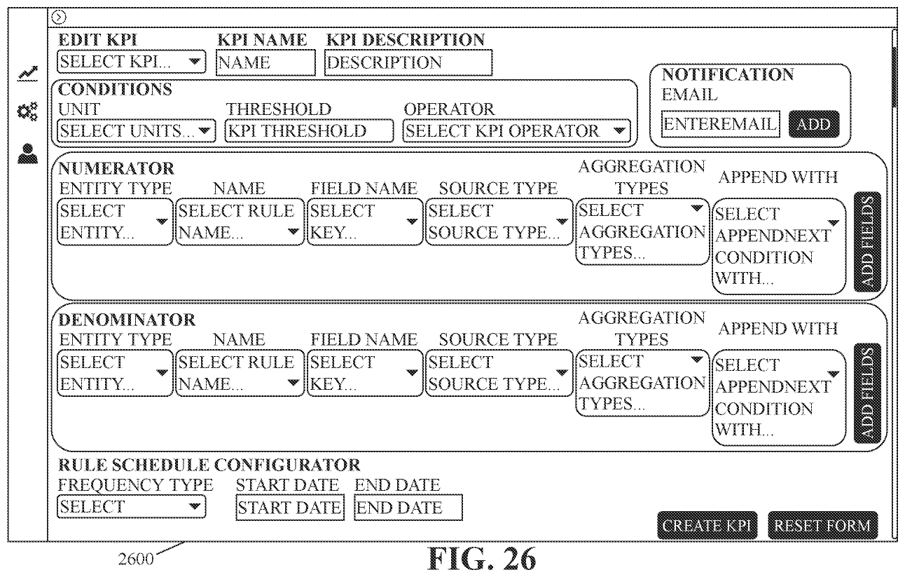

From interface 1500 of FIG. 15, the user may select “KPI” under the “Configuration” menu item to navigate to a KPI configuration interface such as second rule interface (rule interface) (interface) 2600 of FIG. 26. This interface includes several KPI input fields and is used to create a “rule” or query, and accordingly is called herein a “rule interface” in some places. As described previously, a key performance indicator (KPI) is a measurable value that demonstrates how effectively a company is achieving key business objectives. Organizations use KPIs to evaluate their success at reaching targets, for example. Interface 2600 includes some configuration fields at the very top, conditions fields, a notification field, numerator/denominator fields, and schedule configuration fields.

The Edit KPI field may be used to select an already-input KPI in order to edit one or more of the fields and save it (in which case the “Create KPI” selector at the bottom may switch to a “Save KPI” selector or the like. The KPI Name field is for a situation where the user is creating a new KPI (though, in implementations, the user may be able to use this field to change the name of an existing KPI). The KPI Description is for the user to input a description of the KPI.

The Conditions section includes fields/selectors for Unit, Threshold, and Operator. The Unit selector allows the user to select between Percentage, Ratio, and Number. This may be seen as user identification of an output of the KPI rule as either a number, a ratio, or a percentage, though the selection can also be used to affect the output or calculation (for example if “number” is chosen there may be no denominator field, if “ratio” is selected the output may simply be the numerator divided by the denominator, and if “percentage” is selected the output may be the numerator multiplied by 100 and divided by the denominator). The Threshold field (KPI threshold input field) is used to input a threshold the user is targeting for the output. The user can enter any number into this field. The Operator selector is for selecting an operator such as: =; !=; >; >=; <; or <=. Based on the threshold and output, the color may be changed on an insights/context summary (for example green for within the threshold, red for outside of the threshold to notify the user that something needs to be addressed to bring the KPI within the desired range).

The Notification section includes a notification email field which can be used to add any number of email addresses of users who will receive automatic notifications when the KPI value is outside of the threshold value as defined by the operator field.

The Numerator and Denominator fields will determine a generated output. The Entity Type selector allows the user to select either Entity or RuleOutcome. If the user selects Entity then the Name field will be used to select an entity and the Field Name field will be used to select an entity field for that entity. If the user selects RuleOutcome then in the Name field the user will select a rule name and in the Field Name field the user will select a field related to the rule. This allows the user to select outputs from an insight or context (set up using interface 2200) as an input for the KPI. The Source Type field allows the user to select a source such as Billing, CRM, etc. (i.e., sources of data discussed with respect to the Source Systems of FIG. 2). The Aggregation Type selector allows the user to select an aggregation type such as count, sum, average, min, max, and so forth. The Append With allows the user to define a relationship between the present row, using AppendNextConditionWith, and the next row, for example a condition such as +, −, /, or * (plus, minus, divided by, multiplied by). The user may select the Add Fields selector to add one or more additional rows. In other words, several rows could be added for the Numerator and the Append With section at the end of each row will define how that row relates to the next row. This could allow the addition of two rows minus a third row, the multiplication of two rows plus another row, and so forth. In this way, the Numerator can include various values aggregated together using mathematical operators. Once the Numerator fields are set up, the Denominator selections can be set up in a similar fashion, including all the rows and Append With conditions that are needed.

The Rule Schedule Configurator is used to set up a schedule for a particular query, and the query will be executed based on the selected time. A Frequency Type, Start Date and End Date are shown. The Frequency Type may allow the user to select between hour, daily, minute, weekly, and monthly. Based on this selection, new fields may be shown to further set up the schedule, similar to what has been shown and described with respect to FIGS. 24A-24E. The user may select the Create KPI selector to create the KPI, and the user may at any time select the Reset Form selector to reset/empty all of the fields.

The KPI fields of interface 2600 (and any scheduling fields) essentially set up (create) a database query, similar to what is described above for interface 2200. When the query is executed, it retrieves data from the one or more databases and uses the output to either provide/display the output on one or more interfaces or to provide/display a calculation based on the output. The database query configured on interface 2600 may be defined at least in part by the data retrieved from a prior database query (configured using interface 2200) inasmuch as the KPI fields allow the user to select an already created rule/insight (created at interface 2200) as an input or component of the KPI rule/query(ies).

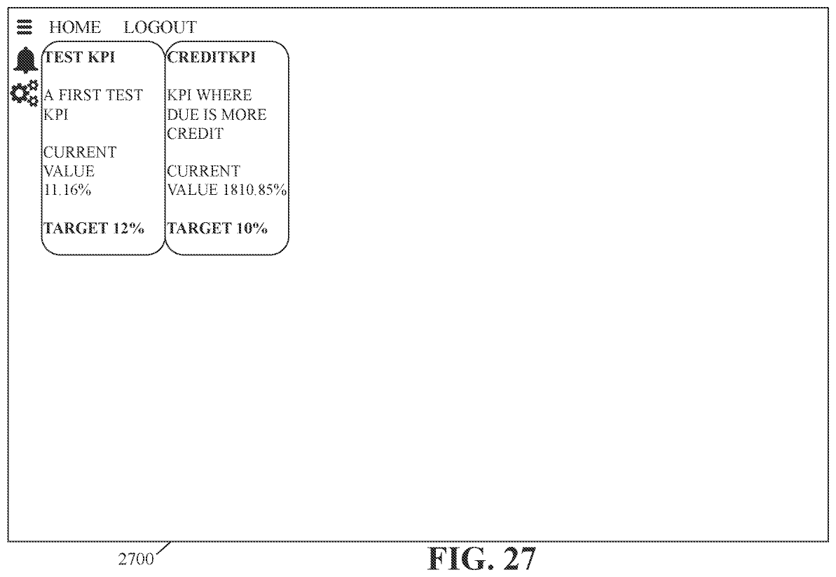

Once the KPI is executed, the user may view details of the KPI (i.e., details of the query) by navigating to a KPI interface such as interface 2700 of FIG. 27. The user may navigate here, for example, from interface 1500 by selecting KPI under the Dashboard menu item. Interface 2700 shows the result of the KPIs that have been set up. For each KPI that has been set up the result will include the previously selected KPI name (for example “Test KPI”), the previously selected KPI Description (for example “A First Test KPI”), the last output value (for example “Current Value 11.16%”) (this value will be updated based on the schedule), and the previously selected Threshold value (for example “Target 12%”). The last output value may be a value retrieved from the one or more databases using the query configured using interface 2600 (for example in some cases where there is no denominator), or it may be a calculation based on one or more values retrieved by the query configured using interface 2600. Although the singular term “query” is used here, it is to be understood that any of the interfaces that are used to set up queries (2200, 2600, etc.) may be setting up multiple queries, and when executed may execute multiple queries, to retrieve multiple data from the one or more databases.

On interface 2700 the current value and/or target/threshold value text may be color coded (and/or may have a color-coded background), for example the current value may be green if it is within the threshold/target as defined by the operator and red if it is without the threshold/target as defined by the operator. For example if a threshold value is set at “greater than 12%,” the current value may show up as red if it is 12% or lower and green if it is 12.01% or higher. If the threshold/target value is set at “less than or equal to 12%,” on the other hand, the current value may appear red if it is 12.01% or higher and green if it is 12% or lower. Interface 2700 may have selectors to allow for sorting of the KPIs such as by prioritizing by those that are outside of the threshold value (i.e., sorting by red vs. green if they are color coded) and by other sorting parameters.

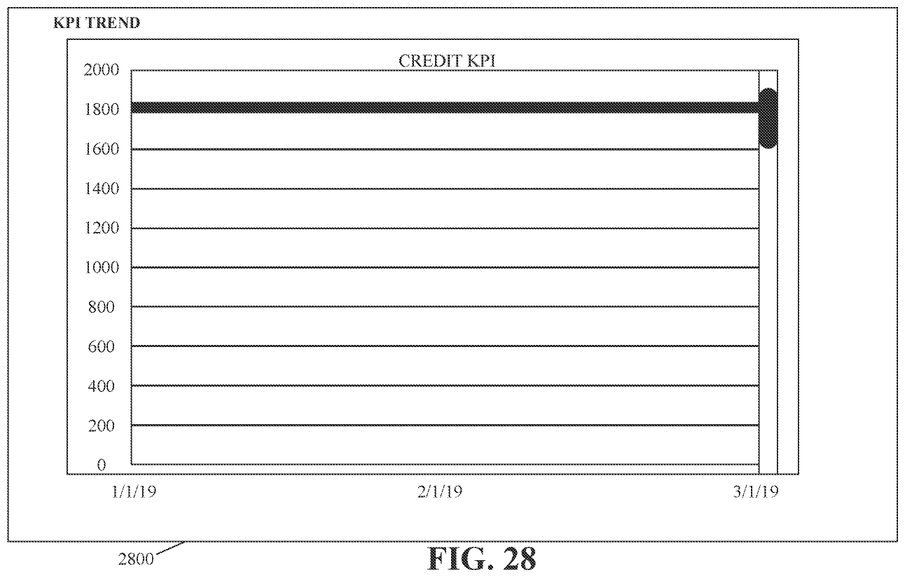

A user may select any of the KPIs from interface 2700 to show a trend interface such as interface 2800 of FIG. 28. In this instance the user has selected CreditKPI from interface 2700 and the trend graph shows that the value has remained constant at 1810.85%. If the value had changed over time then it would be reflected on this graph. In implementations interface 2800 may be shown as a popup on interface 2700. Interface 2800 accordingly shows a graph of an outcome of the KPI rule plotted against time. Interfaces 2700 and 2800 may be called rule outcome interfaces inasmuch as they display results of the outcome of the KPI rule.

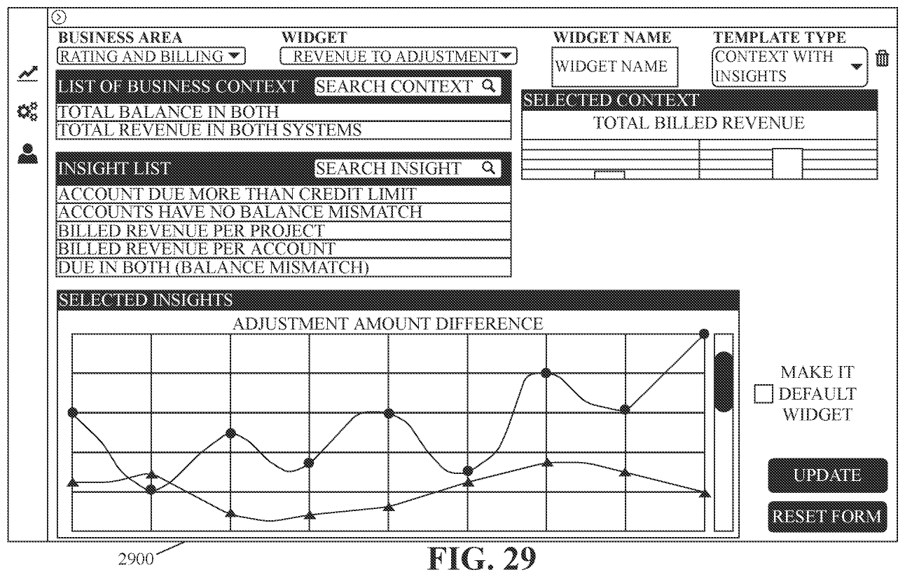

From interface 1500 the user may select Group Dashboard under the Configuration menu item to bring up a group dashboard interface such as interface 2900 of FIG. 29. The group dashboard interface is customizable using a selection mechanism for both contexts and insights. In some implementations this could be a drag and drop mechanism, though other mechanisms could be used such as single or double clicking to make selections of contexts and insights, or checking a box (not shown) to select them, etc. Interface 2900 shows a business area selector, an existing group list (widget) selector, a group name (widget name) field, a template type selector, a list of contexts, a list of insights, a selected contexts area (selected context), a selected insights area (selected insights), and a default group selector (make it default widget). From this interface the user can create three template types: context with insights; context only; and insight only.

The business area selector allows the user to select a business area under which the user is creating a group (widget) (for example in this case the business area selector may allow the user to select from Product and Offers Management, Customer Management, Network and Usage Management, and Rating and Billing) (these are just examples, as users may set up their own Business Areas depending on the business in question). If the user wants to edit a preexisting group, the user can select an existing group from the existing group list. After the user has selected the business area, the existing group (widget) selector will list all available groups which can be edited, if desired. If the user wants to create a new group, the user can leave the existing group (widget) selector blank and enter a name in the group name (widget name) field (which in this case is a text field). In other implementations an “add” or “new” selector may be selectable from the existing group (widget) selector. Using the Template Type selector the user can select “Context with Insights,” “Only Insights” or “Only Context.” In this case the user has selected “Context with Insights” so that the contexts list, selected contexts area, insights list, and selected insights area are visible.

In this example the list of contexts will be populated with selectable contexts associated with the business area and the list of insights will be populated with selectable insights associated with the business area. From the context list the user can select contexts which will then appear in the selected contexts area, and from the insight list the user can select insights which will then appear in the selected insights area. If the user selects the default group selector (make it default widget selector) the selected group will be the default group shown on the display of interface 1500 for this business area. Referring back to interface 1500, it can be shown that the user has only set up one group for the Product and Offers Management business area (the CSPIRE Product Group) and has set up three groups for the Customer Management business area (the CSPIRE Contact group is shown first, as it is selected as the default group, but there are three groups total that the user can navigate between). If not all of the insights and contexts are visible on interface 1500 the user will have a scroll bar (as shown on the right side of FIG. 15) to scroll to the remaining insights/contexts for the group being viewed.

Referring back to FIG. 29, if the user selects “Only Context” as the template type then the contexts list and selected contexts area will be visible, but the insights list and selected insights area will not be visible. The user will be able to select desired contexts for the group, and the may select to have the context-only group as the default group/widget for the business area. Similarly, if “Only Insights” is selected as the template type the insights list and selected insights area will be visible, but the contexts list and selected contexts area will not be visible. The user will be able to select desired insights for the group, and the user may select to have the insight-only group as the default group/widget for the selected business area. The insights/contexts that the user selects as part of the group may be termed a “graph group” inasmuch as each of the insights and contexts includes a graph.

Though only four business areas are discussed herein, the user may be able to set up more or fewer or different business areas, as desired, using one or more user interfaces not shown in the drawings, but similar to other user interfaces which are shown and which will be understood by the practitioner of ordinary skill in the art. As with other user interfaces, one or more user interfaces which allow the user to define business areas may simply have one or more input fields allowing the user to give names for the business areas, which may be stored in one or more data stores of the system 100, such as in a relational database or other type of data store (in some implementations they may be stored in a single APACHE HBASE database), and the user interface 2900 which allows the user to define and associate groups with the business areas may associate the groups with the business areas through the relational database. Other interfaces discussed herein may also simply be front-end user interfaces for one or more back-end relational databases stored in data stores of the system which are used to store and associate various data, insights, groups, contexts, rules, rule outputs, source data, and so forth with one another. Other setups are possible, however, and the use of one or more relational databases is only given as a representative example.

From interface 2200 it can be understood that contexts are set up in the system the same way as insights are, but by also selecting the “Is Context” selector. In a sense all contexts are also insights, but they are broad insights, while those insights which are not context may be simpler insights. Accordingly a user could, if desired, arbitrarily designate an insight as a context or arbitrarily switch a context to a non-context insight (by deselecting “Is Context”). As indicated above, however, the contexts are generally intended to be broader or more general items, for example total billed revenue, all products or services for one of the data sources, total contacts by type, and so forth. The insights, on the other hand, are intended to be used more for quickly seeing issues—for example a “product mismatch” insight, an “accounts with city mismatch” insight (for accounts that have addresses with cities that don't match), an “accounts with address mismatch” insight (for accounts that have addresses that don't match), an “expected monthly revenue by product” insight so that a user can, by looking at the expected monthly revenue and the actual monthly revenue, determine whether targets are being met, and so forth. Nevertheless, the difference between a context and an insight is up to the user, and this is simply a feature which allows greater flexibility for the end user. In some implementations a context insight could act like a “parent” insight, and non-context insights associated with the context could at as “child” insights for that group. For example one selected context for a group may show a big picture of some aspect of the business area and one or more selected insights might reveal sub-issues related to that aspect of the business area. In some implementations at least one context will be needed to create a dashboard pertinent to a business area, and insights can then be grouped with that context using interface 2900. In implementations a context selected on interface 2900 may be used to create a parent dashboard (for example a Total Billed Revenue context dashboard) and then it can have multiple child rules/insights associated with it (for example Revenue Not Billed, Customer Not Billed, etc.). In some implementations a group may only allow one context, but may allow multiple insights.

Because insights are set up (and include graph types) that are the same as those for insights, it is not necessary on FIG. 25 to show the interface when the switch is switched from “Insights” to “Context.” In FIG. 25 it is seen that the selected insight uses bar graphs, but for any given insight or context the user could instead use the other graph types such as a line graph, pie chart, doughnut graph, etc.

It can be seen on FIG. 29 that the user has selected one context (Total Billed Revenue) which shows in the selected contexts area and this actually displays the graph/plot (in this case a bar chart/graph) related to this context. Similarly, the user has selected one insight (Adjustment Amount Difference) which shows in the selected insights area and this actually displays the graph/plot (in this case a line graph/plot) related to this insight. This allows the user to immediately see what will be shown for this group (i.e., it shows the graph group that will be shown) on interfaces 1500/1600/1700. In implementations when a user selects a context from the context list or an insight from the insight list, that context/insight is no longer listed in the respective list. In implementations if the user desires to remove a context or insight from either the selected contexts or selected insights area the user may simply drag the graph/plot back to the relevant list area, or click or double click on it, or the like, and it will show up in the original list again as a list item. In this way, the user can quickly and visually build and edit the group as desired.

In FIG. 29 an Update selector is shown because the user has selected an existing group/widget (Revenue to Adjustment) to edit. If the user desires to save the edits the user can select the Update selector. The user may also simply navigate away from interface 2900 to cancel the edits, which may bring up a warning asking the user whether to update/save or not. Similar functionality may be provided on all other interfaces that are capable of being updated/edited. In implementations a cancel selector may also be provided to provide the function of exiting the interface without saving edits. If the user is creating a new group the Update selector may be replaced with a Save selector or Create Group selector or the like. The user at any point may select the Reset Form selector to erase the field entries and selections, and at any point the user may also select the trash icon to delete an already created group, which for example could have the effect of removing/deleting the associations between the group elements that were created in a relational database when the group was initially created.

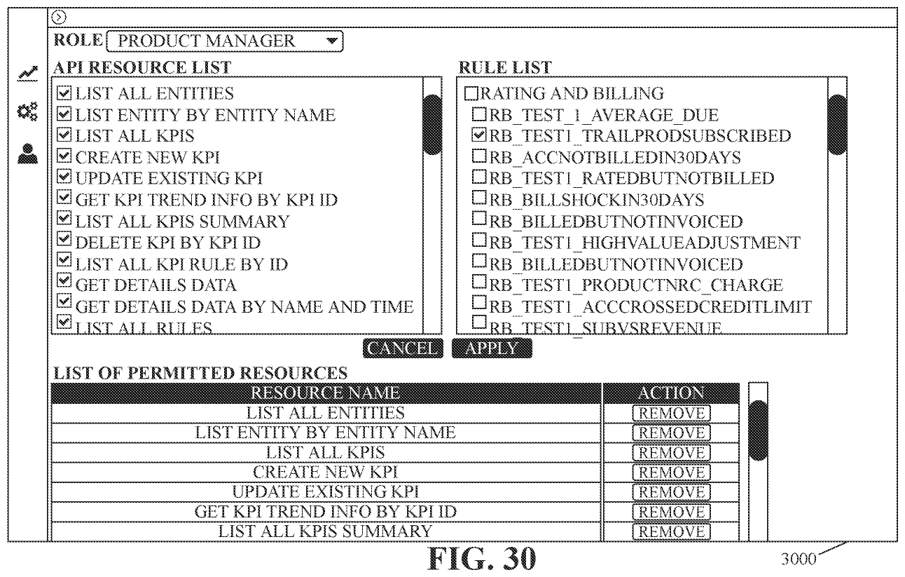

Referring back to interface 1500, the user may select on Role to Resource under the User Administration menu item to navigate to a role interface such as interface 3000 of FIG. 30. Interface 3000 may be used to assign which application programming interfaces (APIs) or functions are accessible by which roles and which insights/contexts (rules) are accessible by which roles. An individual user with rights to given APIs/functions and insights/contexts/rules may also give the same or lesser access to another user with another role. In FIG. 30 it is seen that the role of Product Manager is selected and that the API resource list includes APIs or functions of List All Entities, List Entity by Entity Name, List All KPIs, Create New KPI, Update Existing KPI, and so forth. The user may use the checkboxes to select items from this list and they will appear in the List of Permitted Resources. This may, for example, allow user with the selected role to access certain screens/interfaces, rules (insights/context), KPIs, etc. The user may select Remove next to any resource to remove it from the list, which will also uncheck it in the API Resource list. In implementations the user may alternatively drag the item to the list from the API or Rule list to add it to the List of Permitted Resources. The user may check specific insights/contexts (rules) in the Rule List to similarly add them to the List of Permitted Resources and may remove them using the Remove selector, or do either/both by drag and drop functionality or by some other selection mechanism.

At any point the user may select Apply to update the selections or Cancel to cancel the selections. A user may, for example, make some changes to the Product Manager role and select Apply, then select the CEO role and make changes to that role. In implementations, before a user deletes access of a role to a specific API/function or insight context (rule), a popup will appear asking for confirmation. If the user proceeds access will be removed from that role for that API or insight/context (rule).

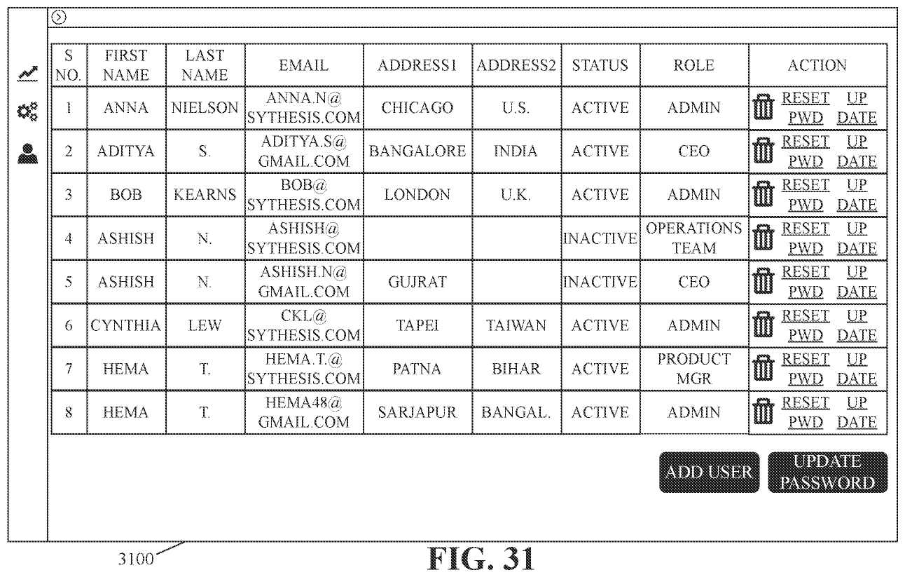

Referring back to FIG. 15, if the user selects User Management under the User Administration menu item the user may be brought to a user management interface such as interface 3100 of FIG. 31. Interface 3100 is used to create users, update users, delete users, reset passwords, and the like. It is seen that each user has a user number, a first and last name, an email address, a physical/mailing address, a status (active or inactive), and an assigned role (Admin, CEO, Operations Team, Product Manager, etc.). The trash icon may be selected to delete a user (which would remove all access privileges for that user). The Reset Pwd selector could be selected to send the respective user a reset password link (by email) and require the user to select a new password (this could be done on a regular basis for all users for security reasons, for example). The emailed user may in implementations choose to keep the prior password instead if the emailed user remembers the prior password. The user who is viewing interface 3100 may also select Update Password to change his/her own password.

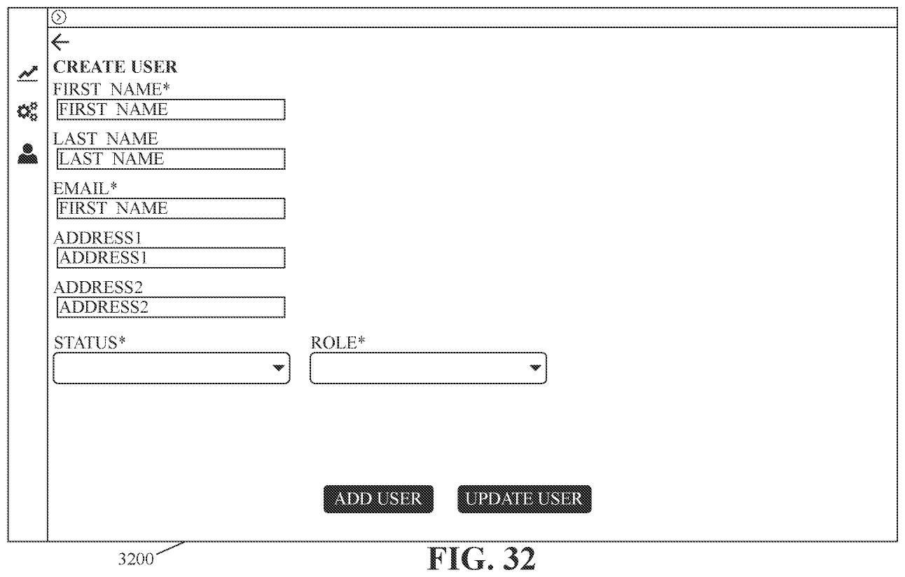

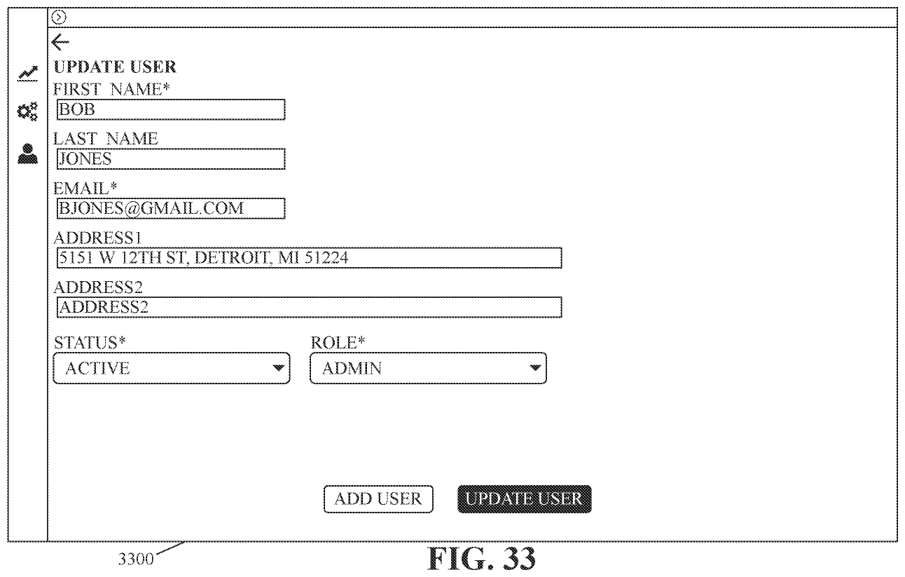

The Add User selector may be selected to add a new user, and any of the Update selectors may be selected to edit an existing user. When the user navigates to interface 3100, the users which have already been entered into the system will be displayed as shown in FIG. 31. If the Add User selector is selected then an Add User interface such as interface 3200 of FIG. 32 is displayed. This interface allows for the entry of a user's first name, last name, email address, physical or mailing address, status (inactive or active) and role. The admin may have already provided possible statuses and roles using another interface, not shown, but which will be easily understood by the practitioner of ordinary skill in the art, so that the Status and Role lists are populated with options to select from. After the required (starred) entries are input, the Add User selector can be selected to update a database/data store of system 100 with the user's information. Referring back to interface 3100, if the Update selector is selected for any user, an Update User interface such as FIG. 33 is displayed. This interface allows for the edit of any of the user's information, status, role, etc. After changes are made, the Update User selector may be selected to save the changes to a database/data store of system 100.

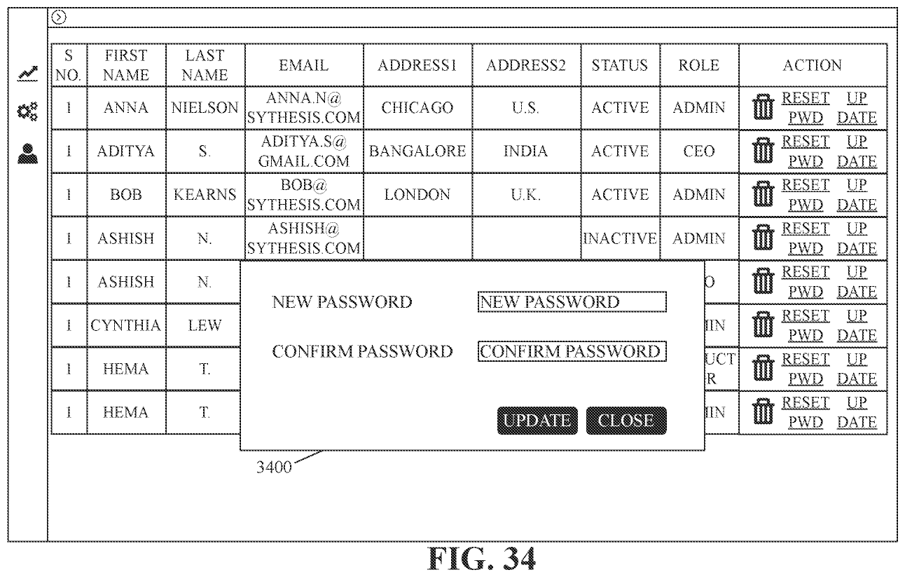

If the user viewing interface 3100 selects the Update Password selector an interface such as interface 3400 of FIG. 34 may pop up, which may allow the user to input a new password, confirm the new password, and select Update to store the change or Close to revert to the prior password.

Interfaces 3000, 3200 and 3300 may be called “user access interfaces” and are configured to receive user input to adjust a user's ability to view the various interfaces of the system, edit the one or more rules/queries set up (such as on interfaces 2200, 2600, etc.), and control other access of the user to elements of the system.

Although the elements of FIG. 2 show various discrete databases or data stores, in implementations their separation could be virtual, with some or all of the data stores existing on common machines/servers or the like.

Although system 100 and related methods are described herein as being used for revenue assurance, system 100 and similar systems and methods could be used in implementations for business insights or improvements other than revenue assurance.

Any of the interfaces discussed herein may be displayed/facilitated at least in part by using information provided by one or more servers of system 100.

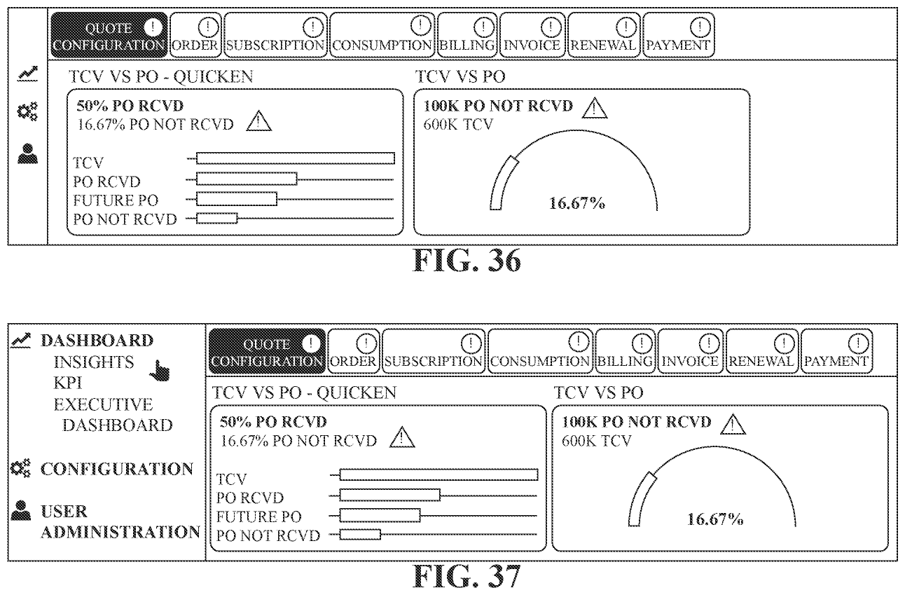

Various additional and/or alternative user interfaces, which may be implemented using the systems disclosed herein and which may be utilized to implement revenue assurance methods, will now be described. The examples and use cases given below are only representative examples, and in implementations the user interfaces could reflect different details, different customers, and so forth. Referring to FIG. 36, an executive dashboard interface is shown which includes a number of selectable menu items shown along a top banner, including Quote Configuration, Order, Subscription, Consumption, Billing, Invoice, Renewal, and Payment.

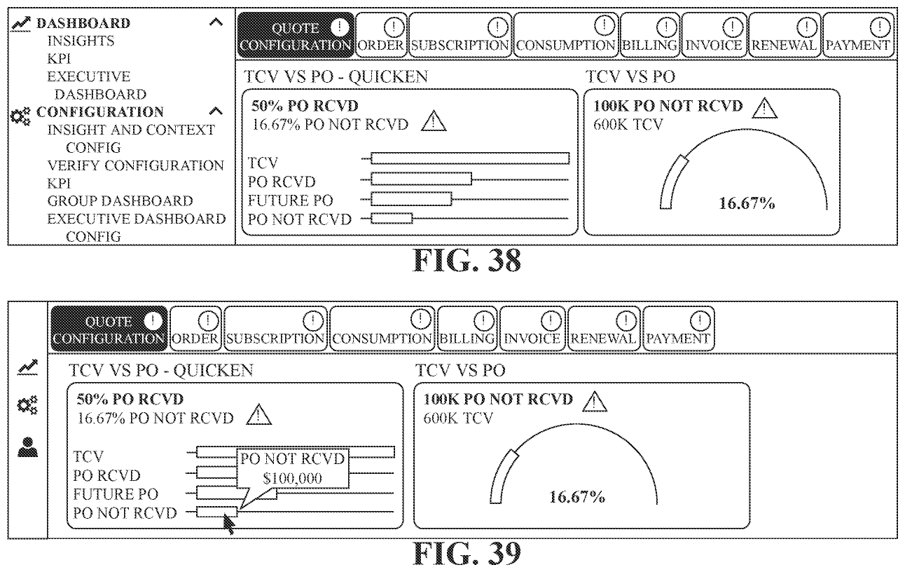

FIGS. 37-38 show that on the left hand side of the executive dashboard interface is a menu which shows a number of selectable items (a Dashboard menu item with sub-items of Insights, KPI, and Executive Dashboard, a Configuration menu item, and a User Administration menu item). The left hand menu maximizes (as shown in FIGS. 37-38) when a user hovers over it with a cursor and minimizes (as shown in FIGS. 36, 39) when the cursor is placed to the right of the menu. The “Configuration” menu item when hovered over shows sub-menu items of Insight and Context Config, Verify Configuration, KPI, Group Dashboard, and Executive Dashboard Config.

The menu items along the top of FIGS. 36-39 represent various stages of the revenue assurance process including revenue assurance related to Quote Configurations, Orders, Subscriptions, Consumption, Billing, Invoicing, Renewals, and Payment. Each of these menu items may be selected to see an overview of previously set up graph groups and rule outcomes related to revenue assurance. The exclamation marks (within circles) corresponding with the top menu items indicate those areas where leakage is detected based on the system configurations (i.e., they indicate some value exceeding a threshold). It can be seen that in this example each menu item along the top reflects revenue leakage. The menu items along the top, in this implementation, are “business areas,” previously discussed.

It is also seen in FIGS. 36-39 that there are graph groups having graphs and showing details based on the rules or settings that the user has set up. For instance there is a “TCV VS PO—QUICKEN” graph group (showing bar graphs) on the left and there is a “TCV VS PO” graph group (having a single graph) on the right. Each graph group includes one or more insights (some of which may also be “context” or may include context, as that term has been discussed and described above), and these are graphed using one of a variety of graph formats. There are exclamation points (within triangles) which are shown based on rule configurations that the user has set up. When the user is setting up a rule (which may involve simple click and/or click-and-drag operations) the user can determine/input a specific threshold, and if an insight value exceeds this threshold the exclamation point (within a triangle) may be displayed on a related graph group.

The “TCV VS PO” items shown in FIGS. 36-39 represent “total contract value versus purchase orders received.” The left TCV VS PO item is a simulated contract for QUICKEN. The user can hover over any of the insights (as seen in FIG. 39) to show actual values, in this representative example the TCV is $600,000, the PO RCVD is $300,000, the FUTURE PO is $200,000, and the PO NOT RCVD is $100,000. The top of the graph group shows that 16.67% of purchase orders are not received (this is the $100,000 divided by the $600,000 total contract value) and this exceeds a threshold that the user has configured (this is why the exclamation point within a triangle is shown next to it). The top of the graph group also shows “50% PO RCVD” indicating the percentage of purchase orders received. The user has set this graph group up to show this and may have set up a threshold for the PO RCVD—for instance if it falls below 30%, as an example, an exclamation point within a triangle may be displayed next to it (the user could of course set any value as a threshold).

As described previously, every rule can be run on a specific schedule. While any given rule is running (or after any rule has run) the related graph groups shown on the executive dashboard of FIGS. 36-39 may show outcomes of the rule (the same goes for other executive dashboard interfaces). For example any PO that was supposed to be received (but was not received) before a scheduled run date of a rule will be included in the “PO NOT RCVD” calculation/tally and will be reflected in any related graphs.

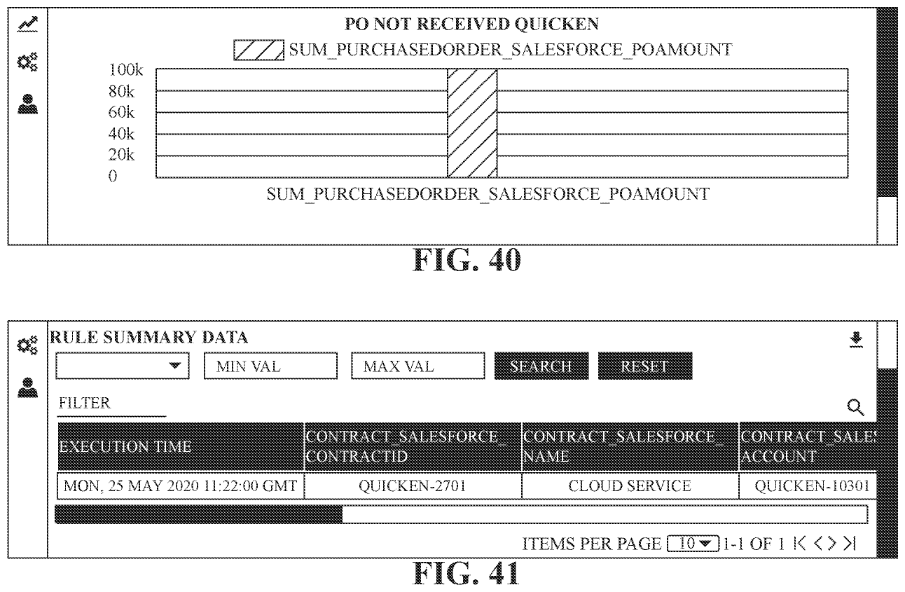

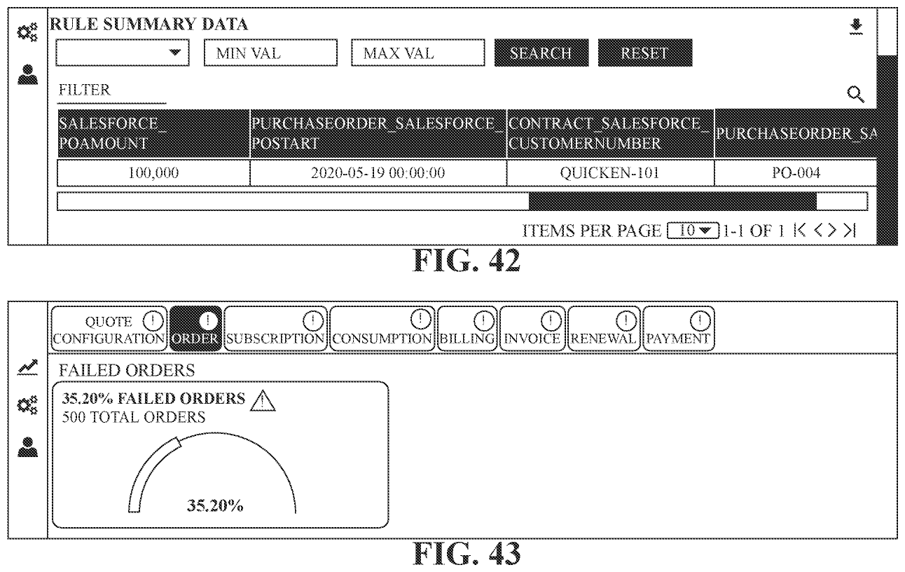

The user may click on or otherwise select any of the insights of a graph group to see a details interface (similar to interface 2000 and related interfaces described above). For example when the user clicks on the PO NOT RCVD insight the interface shown in FIGS. 40-42 is shown. FIGS. 40-42 are different portions of the same interface, in FIG. 40 the user is scrolled to the top of the interface. In FIG. 41 the user has scrolled to the bottom of the interface, and in FIG. 42 the user has scrolled to the right of the table shown at the bottom of the interface. The interface of FIGS. 40-42 shows rule summary data for the “PO Not Received QUICKEN” rule (or sub-rule) that the user has set up on a rule interface. The data related to the rule is downloadable using the download selector (seen at the top right of FIG. 41), for example this may download the data as an EXCEL spreadsheet, though in other implementations it could be available in other formats, such as a comma separate value (CSV) format.

The graph group shown on the right side of FIGS. 36-39 (TCV VS PO graph group) is related to the graph group on the left (TCV VS PO—QUICKEN), and/or related to the same rule(s) set up using a rule interface. The right graph group is showing some of the same information as the left graph group, i.e., that $100,000 in purchase orders have not been received, and that this exceeds a preset threshold, that the total contract value (TCV) is $600,000, and that the amount not received is 16.67% of the total contract value. The right graph group shows a different graph type used, similar to a speedometer in appearance (and showing only one graph). Accordingly, the left graph group and right graph group are based on the same underlying data and rule(s), but represented in different manners. Any graph group may, accordingly, include information related to other graph groups, and the user may set up as many graph groups as desired to be shown in the executive dashboard of FIGS. 36-39 (and the user may scroll down if needed to see all graph groups). The ability to set up graph groups in a flexible way allows the revenue assurance (RA) analyst to get a quick glimpse of potential issues that need to be addressed. As implied above, some graph groups only include a single graph. Nevertheless, the term “graph group” as used herein is meant to include versions that only include a single graph.

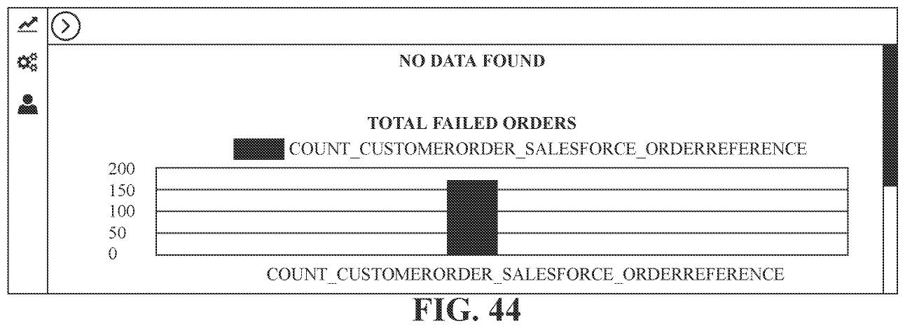

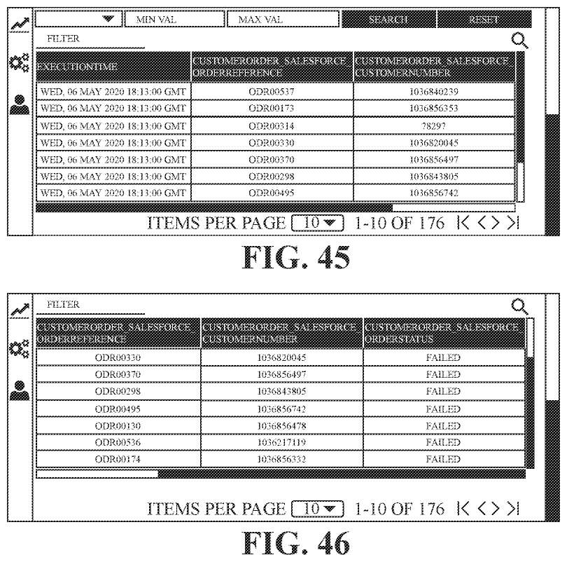

If the user selects the “Order” business area along the top menu the executive dashboard interface of FIG. 43 is shown. On this interface the user has set up a graph group related to failed orders. Failed orders naturally lead to customer dissatisfaction and otherwise negatively affect business operations. Upon clicking on the FAILED ORDERS insight on this graph group (in other words, clicking on the FAILED ORDERS graph) the details interface of FIGS. 44-46 is shown. FIGS. 44-46 show different portions of a single interface, with FIG. 44 showing the interface when the scroll bar is at the top of the interface, FIG. 45 showing the interface when the user has scrolled to the bottom of the page, and FIG. 46 showing the interface when the user has scrolled to the right of the table at the bottom of the interface. This details interface (as with other details interfaces described herein) has similar features and functions as described above for other details interfaces or similar interfaces. The details interface allows the user to delve into the details of the insights of the graph group. This allows the user to see which orders have failed, for which customer and which account, any other order status information, and so forth.

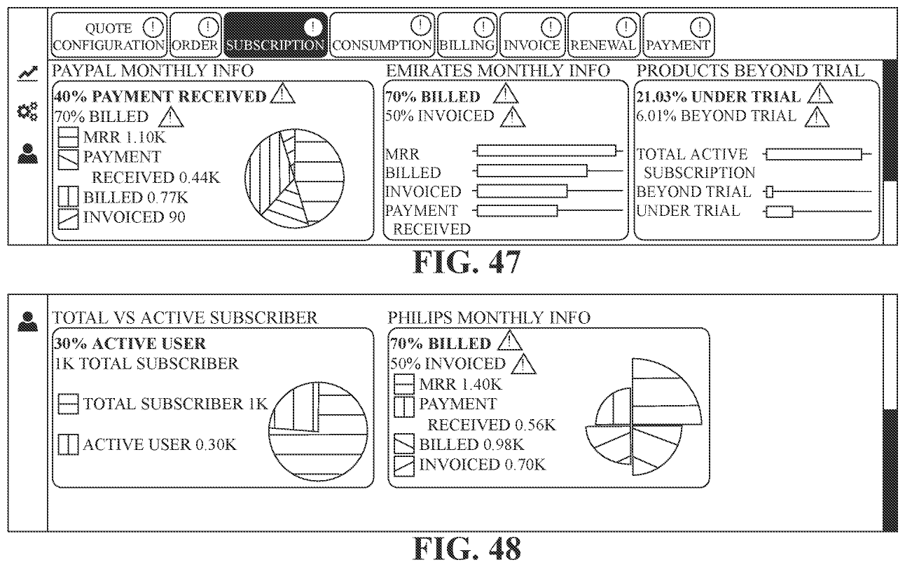

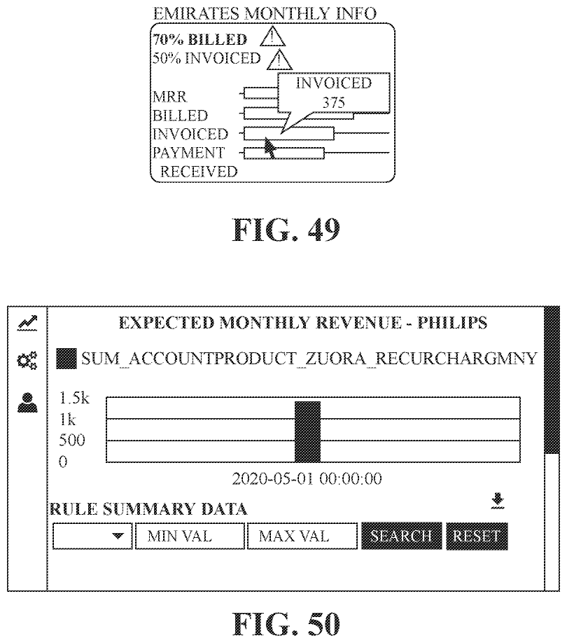

If the user selects the “Subscription” business area along the top menu the subscription executive dashboard interface of FIGS. 47-49 is shown. FIGS. 47-49 show different portions of a single interface, with FIG. 47 showing the interface when the user has scrolled to the top of the interface, FIG. 48 showing the interface when the user has scrolled to the bottom of the interface, and FIG. 49 showing a close-up view of the “EMIRATES MONTHLY INFO” graph group. The subscription interface can give a 360-degree view of details related to subscription customers (shown using various graph groups that the user has set up using underlying rules). Simulated in FIGS. 47-49 are a PAYPAL MONTHLY INFO graph group, an EMIRATES MONTHLY INFO graph group, a PRODUCTS BEYOND TRIAL graph group, a TOTAL VS ACTIVE SUBSCRIBER graph group, and a PHILIPS MONTHLY INFO graph group. In the EMIRATES MONTHLY INFO graph group, as an example, the outcomes of the monthly recurring revenue (MRR), billed, invoiced, and payment received insights/rules are shown, and the user may hover over any of these to see the amount (as shown in FIG. 49). In this example threshold limits are exceeded for every graph group except the TOTAL VS ACTIVE SUBSCRIBER graph group, as reflected by the exclamation points (within triangles). More dimensions/details could be added to the subscription interface, or details removed to make the interface simpler, at any time as desired by the user. The user in this case has set up some graph groups related to specific customers (for example EMIRATES and PHILIPS), showing that the subscription interface may be custom tailored to show specific information for specific customers (for example the user may desire this for the largest customers). From the subscription interface the user is able to quickly see risk areas that may affect (or that are affecting) revenue. For example for the EMIRATES MONTHLY INFO graph group the user can quickly see that the billed amount is less than the monthly recurring revenue, that the invoiced amount is less than billed, and that the payment received is less than invoiced.

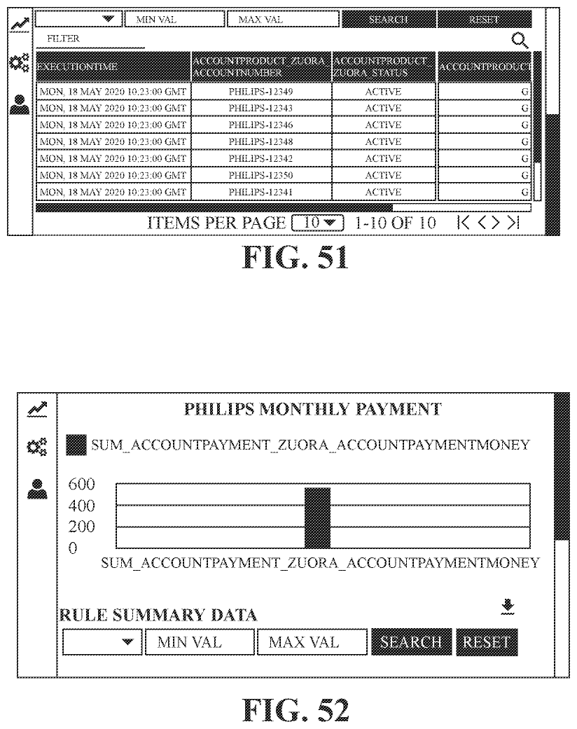

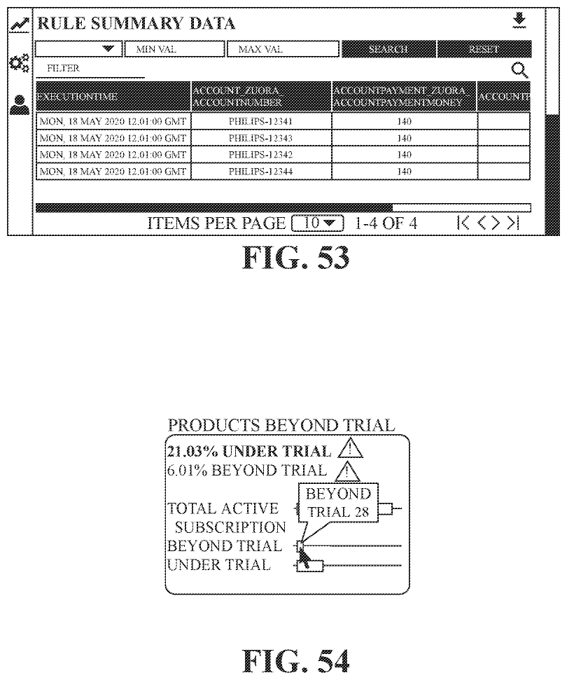

The user may click on or otherwise select any of the insights of a graph group to bring up a details interface. For example FIGS. 50-51 show a details interface that is shown when the user clicks on the “MRR 1.40K” section of the polar graph on the “PHILIPS MONTHLY INFO” graph group (effectively selecting the MRR insight). FIGS. 50-51 show different portions of the same interface accessed using scroll bars, as described above for other details interfaces. FIGS. 52-53 show a details interface that is shown when the user clicks on the “PAYMENT RECEIVED 0.56K” section of the polar graph on the “PHILIPS MONTHLY INFO” graph group (effectively selecting the PAYMENT RECEIVED insight). FIGS. 52-53 show different portions of the same interface accessed using scroll bars, as described above for other details interfaces.

FIG. 54 shows a close-up view of the PRODUCTS BEYOND TRIAL graph group. For instance if a product is used beyond a trial period (but without payment) there is straight revenue leakage. This graph group accordingly shows the number of total active subscriptions, how many are beyond trial (past a trial period) and how many are under trial (within a trial period). A threshold of 6% was set up for the “Beyond Trial” insight of this graph group. Since 6.01% are beyond trial, the exclamation point is shown next to “6.01% Beyond Trial” to show that the threshold is exceeded. Any of the insights of the graph group may be hovered over to show the actual number, as seen in FIG. 54, which shows that there are 28 accounts beyond trial.

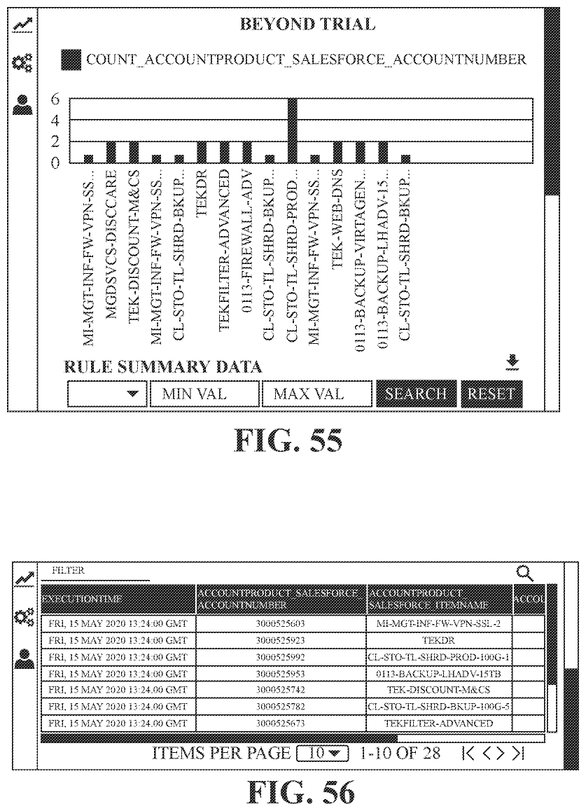

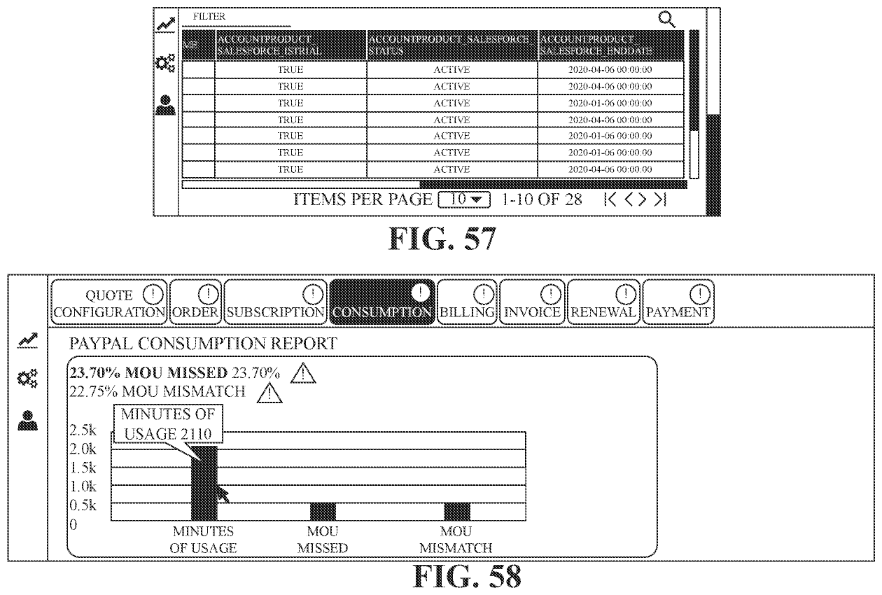

FIGS. 55-57 show a details interface that is shown when the user clicks on the “BEYOND TRIAL” insight of the “PRODUCTS BEYOND TRIAL” graph group. FIGS. 55-57 show different portions of the same interface accessed using scroll bars, as described above for other details interfaces. The details interface of FIGS. 55-57 allows the user to delve further, such as seeing which products are on trial, for which accounts, when each trial was supposed to end, and so forth. This allows the RA analyst to deal with revenue leakage related to trials.

The TOTAL VS ACTIVE SUBSCRIBER graph group may allow the user to see revenue leakage related to costs associated with maintaining dormant customers.

If the user selects the “Consumption” business area along the top menu the consumption executive dashboard interface of FIG. 58 is shown. This is seen to have a PAYPAL CONSUMPTION REPORT graph group. As described or implied earlier, the system can directly poll data from a source platform where consumption is occurring. Graph groups can accordingly show consumption from a specific platform to show usage that is happening. The user may again hover over any of the insights to see actual values, as seen in FIG. 58 which shows 2110 minutes of usage. Minutes of use (MOU) missed and mismatch are also graphed in the graph group. More graph elements/dimensions could be added using one or more rules interfaces.

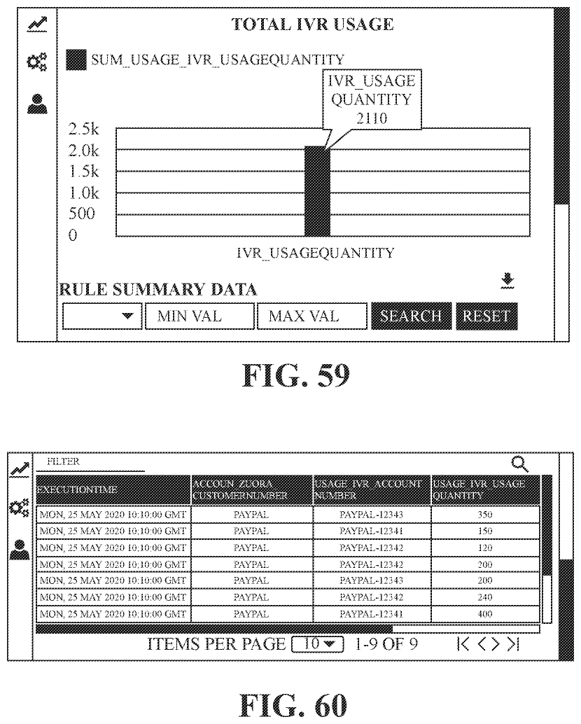

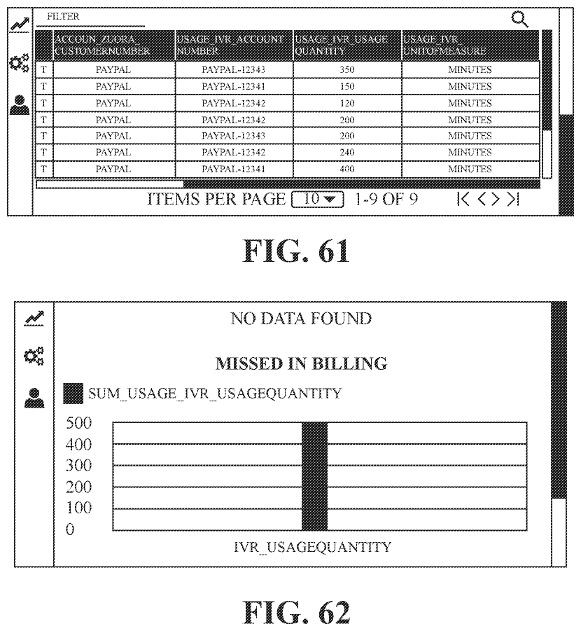

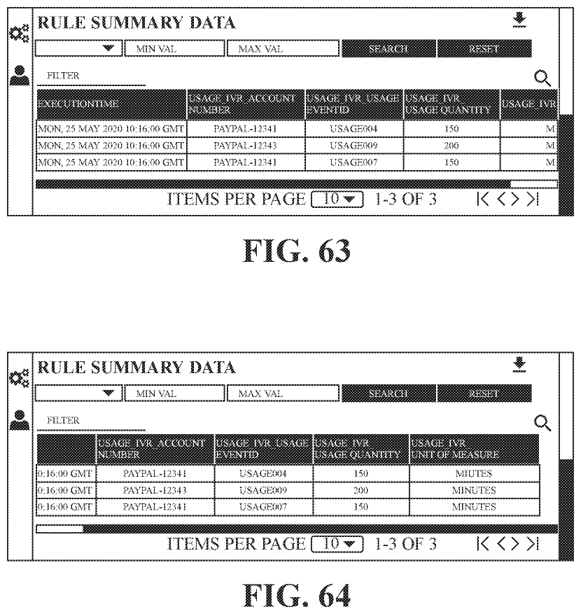

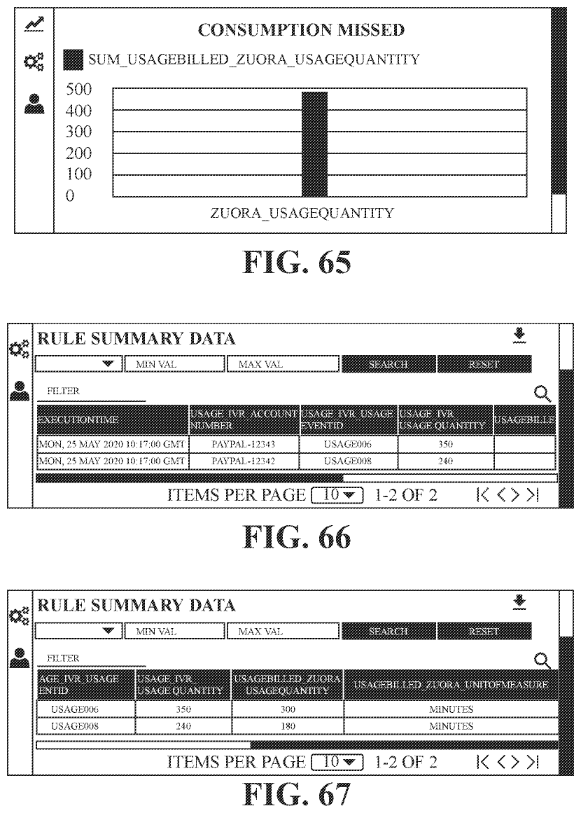

FIGS. 59-61 show a details interface that is shown when the user clicks on the “MINUTES OF USAGE” insight of the “PAYPAL CONSUMPTION REPORT” graph group. FIGS. 59-61 show different portions of the same interface accessed using scroll bars, as described above for other details interfaces. FIGS. 62-64 show a details interface that is shown when the user clicks on the “MOU MISSED” insight of the “PAYPAL CONSUMPTION REPORT” graph group. FIGS. 62-64 show different portions of the same interface accessed using scroll bars, as described above for other details interfaces. This shows MOU missed (which reflects minutes not recorded in billing, so is a straight reconciliation). The MOU MISMATCH insight reflects items that were recorded in billing but that have a mismatch between the IVR (interactive voice response) usage amount and the usage billed. FIGS. 65-67 show a details interface that is shown when the user clicks on the “MOU MISMATCH” insight of the “PAYPAL CONSUMPTION REPORT” graph group. FIGS. 65-67 show different portions of the same interface accessed using scroll bars, as described above for other details interfaces.

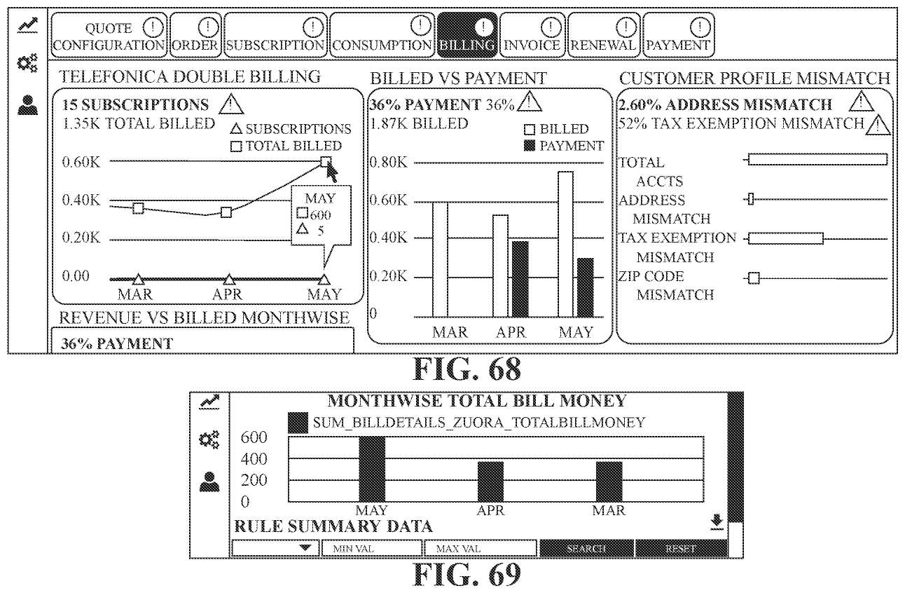

If the user selects the “Billing” business area along the top menu the billing executive dashboard interface of FIG. 68 is shown. This is seen to have a TELEFONICA DOUBLE BILLING graph group, a BILLED VS PAYMENT graph group, a CUSTOMER PROFILE MISMATCH graph group, and a REVENUE VS BILLED MONTHWISE graph group. The TELEFONICA DOUBLE BILLING graph for example shows that the number of subscriptions from March to May remained the same, but that the billing amount increased significantly from April to May, reflecting that some accounts may have been double billed. This is relevant to revenue assurance in that, if accounts have been double billed, there will be refunds that will be needed.

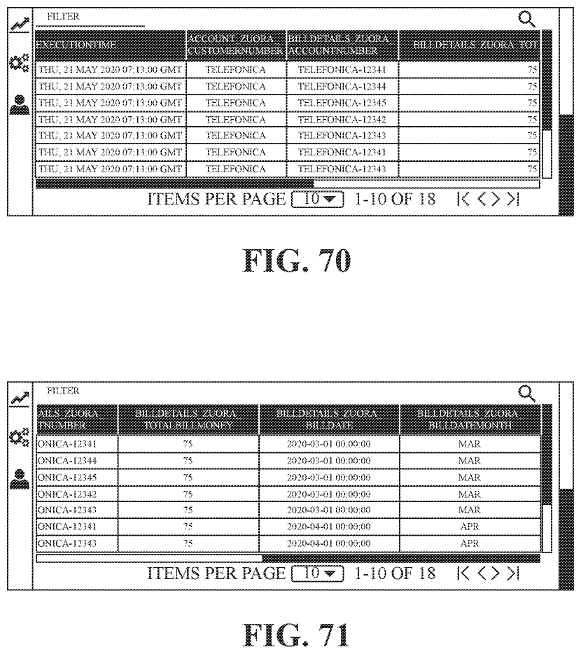

FIGS. 69-72 show a details interface that is shown when the user clicks on the “TOTAL BILLED” insight (top graphed line) of the “TELEFONICA DOUBLE BILLING” graph group. FIGS. 69-72 show different portions of the same interface accessed using scroll bars, as described above for other details interfaces. Referring to FIGS. 71-72, any of the columns of the table may be selected to organize the table by that column. In FIG. 72 the user has selected the rightmost column to organize the table by the bill month (the user clicked twice to organize by latest month at the top and older months below), so that for example all of the bills for May are shown (but the user may scroll up or down as needed to see other months). In implementations any column may be selected once to organize by that column and selected again to organize in the reverse order by that column (for example selecting the rightmost column could first organize the table from January to December and selecting it again could organize the table in reverse order from December to January- or by any subset of months if not all months have data). In other implementations the user could select the rightmost column to show a month at a time, for example clicking on it once may only show March bills, then clicking again may only show April bills, and so forth. The graph and tables of FIGS. 69-72 allow the user to see which accounts have been billed twice in any given month to address double billing issues.

A close-up view of the BILLED VS PAYMENT graph group is shown in FIG. 73, and the user may hover over any insight to see the actual values, as seen in FIG. 73 which shows that in April $525 was billed and payment was $375. The amount of payment (36% of that billed) exceeds a threshold set by the user (by being below a set threshold percentage), as reflected by the exclamation point (within the triangle).

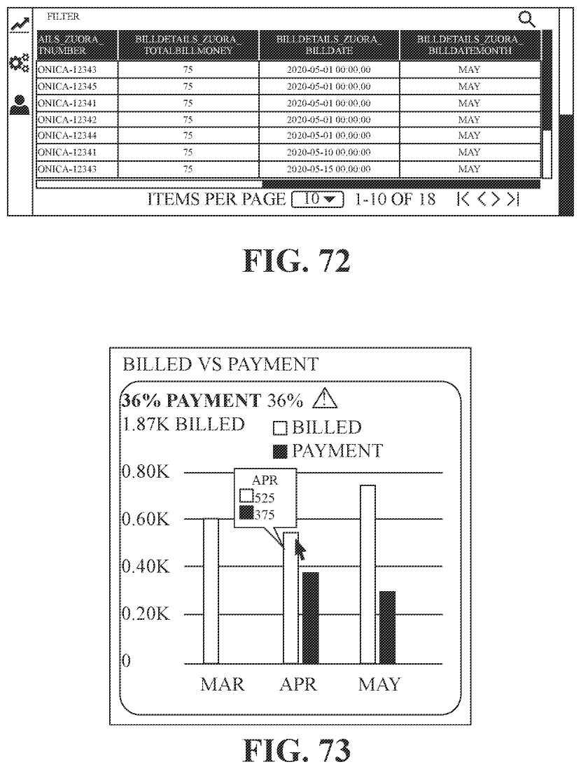

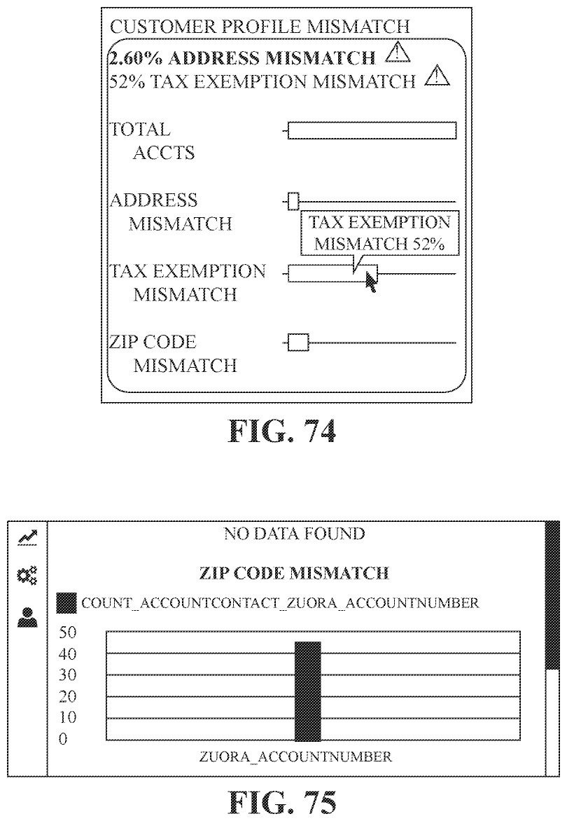

A close-up view of the CUSTOMER PROFILE MISMATCH graph group is shown in FIG. 74. Any of the insights may be hovered over to see the value, for example the Tax Exemption Mismatch value is 52%, as seen in FIG. 74. Address mismatches are related to revenue assurance because if an address is incorrect an invoice may not be delivered to a customer. A zip code mismatch may result in a credit card not being able to be charged. A tax exemption mismatch may result in revenue accounting issues based on inappropriately classifying some items as tax exempt.

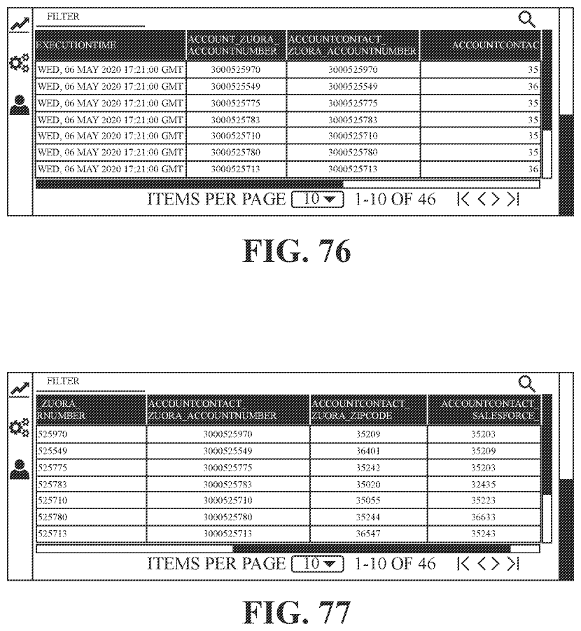

FIGS. 75-77 show a details interface that is shown when the user clicks on the “Zip Code Mismatch” insight of the “CUSTOMER PROFILE MISMATCH” graph group. FIGS. 75-77 show different portions of the same interface accessed using scroll bars, as described above for other details interfaces. From the interface of FIGS. 75-77 the user may be able to see which accounts have zip code mismatches so that the issue may be resolved and the correct zip code used across the board for each account/customer.

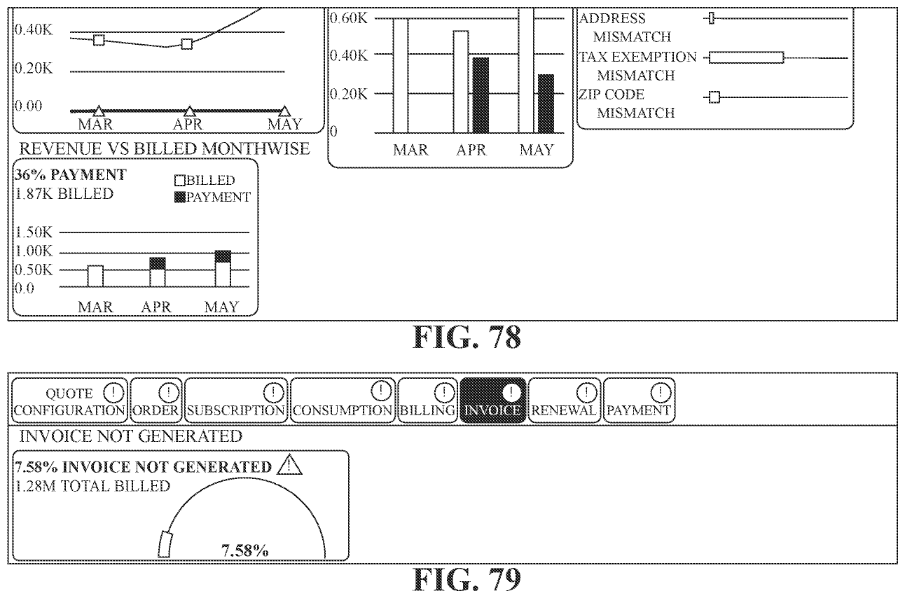

The REVENUE VS BILLED MONTHWISE graph group (shown in FIG. 78, which is the same interface of FIG. 68 but scrolled down) shows another dimension/aspect of billed versus paid amounts.

If the user selects the “Invoice” business area along the top menu the invoice executive dashboard interface of FIG. 79 is shown. This is seen to have an INVOICE NOT GENERATED graph group. This gives the RA analyst a quick view to see, in this example, that 7.58% of invoices are not generated and that 1.28M is the total amount billed. It can be seen that the percentage of invoices not generated exceeds a threshold amount set by the user.

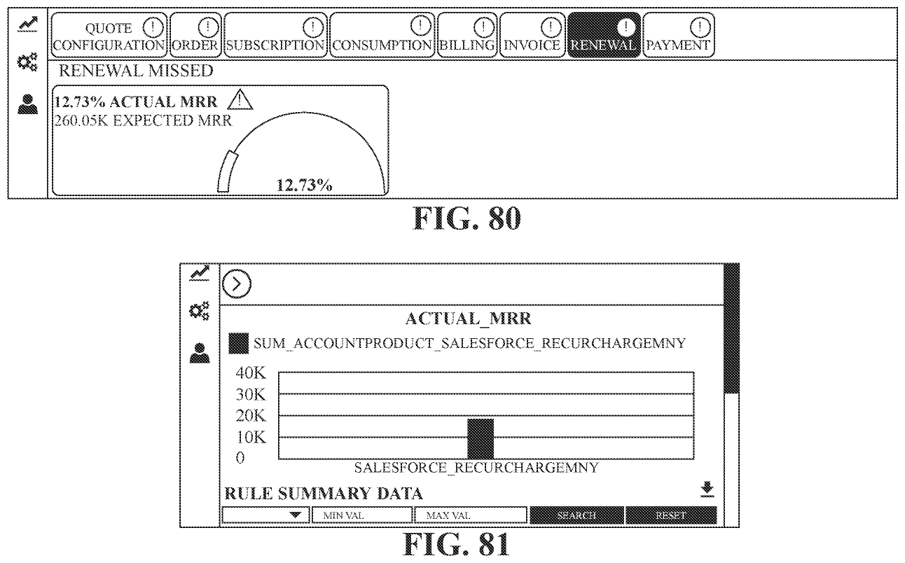

If the user selects the “Renewal” business area along the top menu the renewal executive dashboard interface of FIG. 80 is shown. This is seen to have a RENEWAL MISSED graph group. This allows the RA analyst to quickly see monthly recurring revenue (MRR) details. Automatic renewals that do not take place or that are cancelled contribute to the customer churn rate and reflect a loss of potential revenue. This graph group shows actual and expected MRR and it is seen that the actual MRR value exceeds some threshold (which in this case means the actual value is below the threshold).

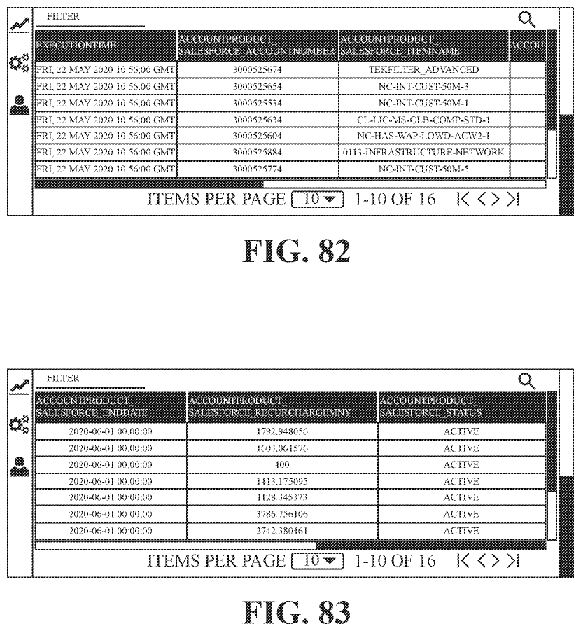

FIGS. 81-83 show a details interface that is shown when the user clicks on the ACTUAL MRR insight of FIG. 80. FIGS. 81-83 show different portions of the same interface accessed using scroll bars, as described above for other details interfaces. This will allow the user to see subscribers who were supposed to renew (or those subscribers that were expected to renew) but who have not renewed so that measures may be taken to try to facilitate renewals for those customers and, therefore, reduce revenue loss.

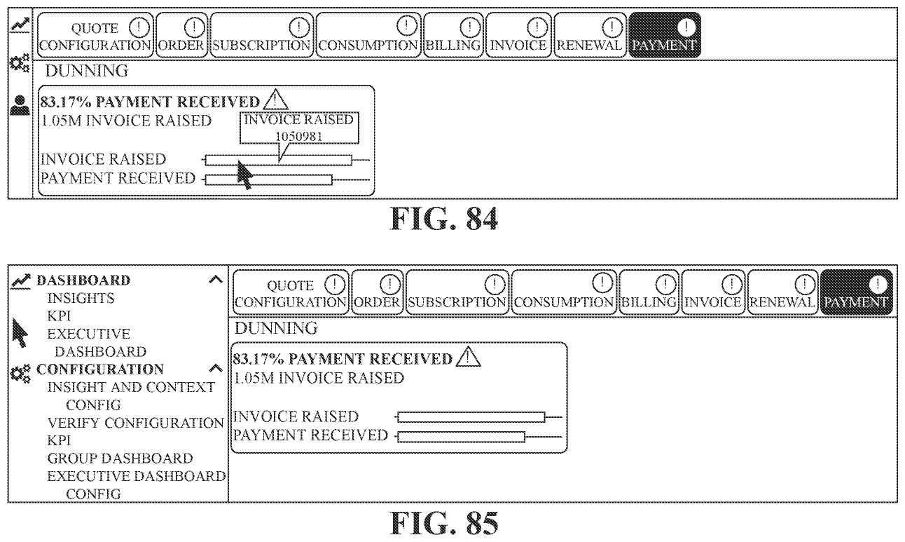

If the user selects the “Payment” business area along the top menu the payment executive dashboard interface of FIG. 84 is shown. This is seen to have a DUNNING graph group. This shows the DUNNING cycle including Invoice Raised and Payment Received. Any insight may be hovered over to show the actual value, for example FIG. 84 shows that the Invoice Raised amount is $1,050,981. This graph group could be used (or modified) to identify if customers with active accounts crossed a credit limit without payment being received, and other details could be shown as desired.

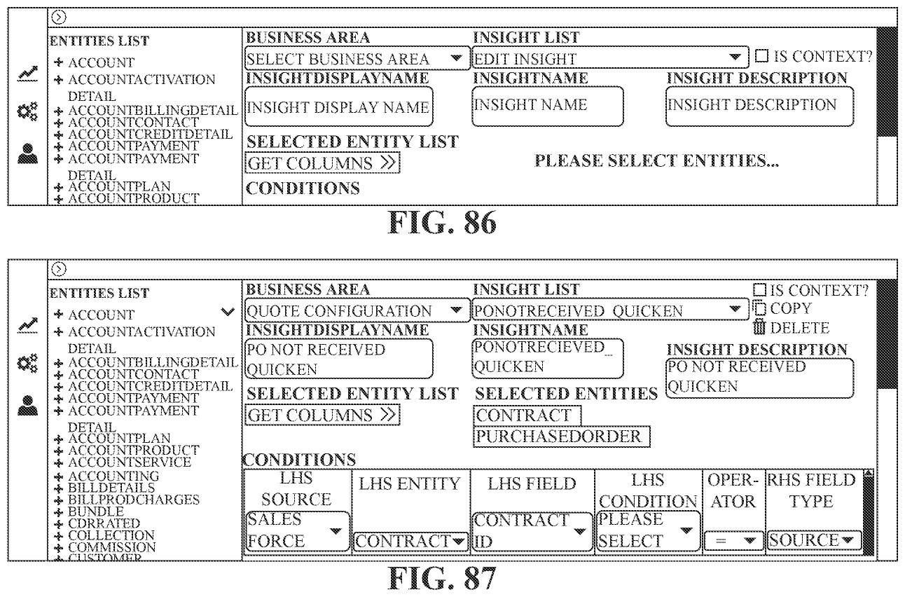

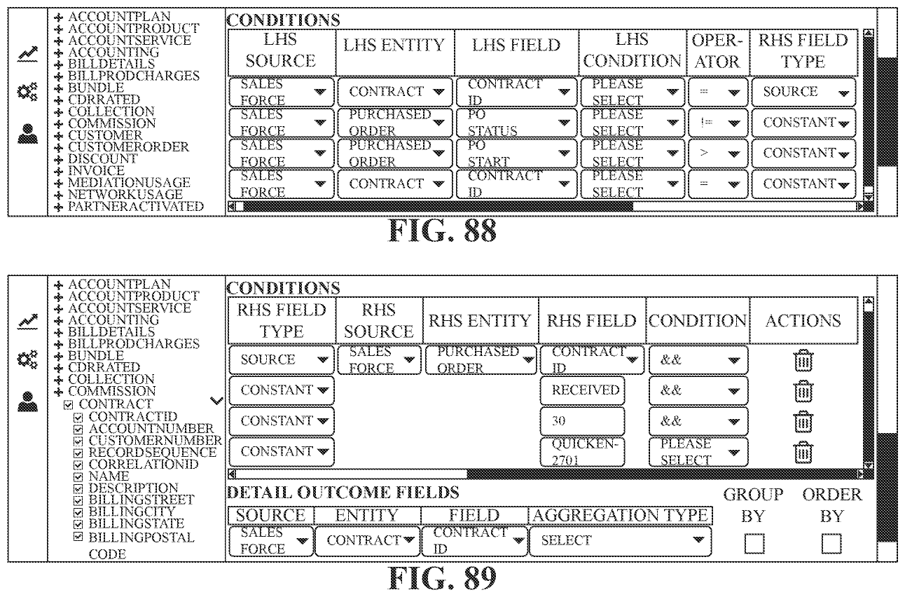

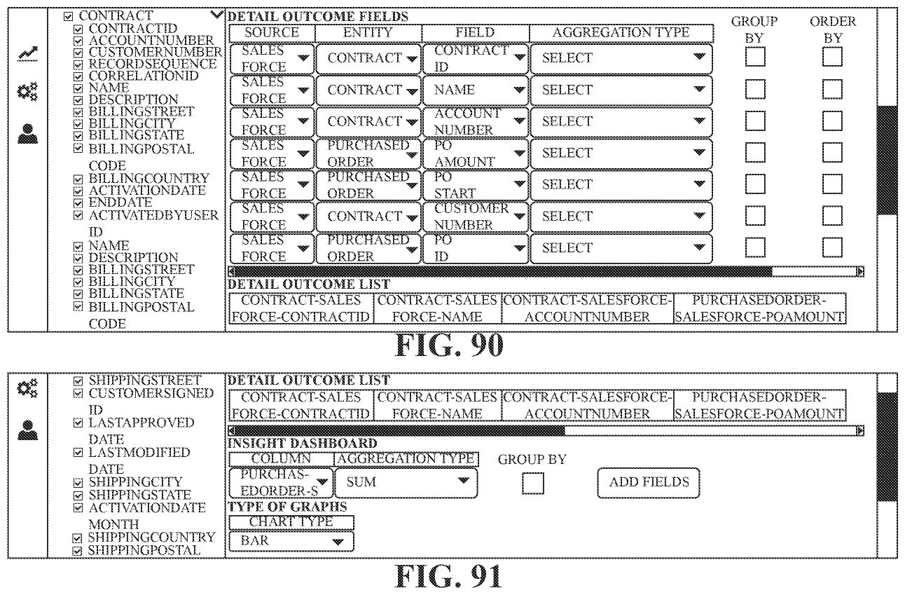

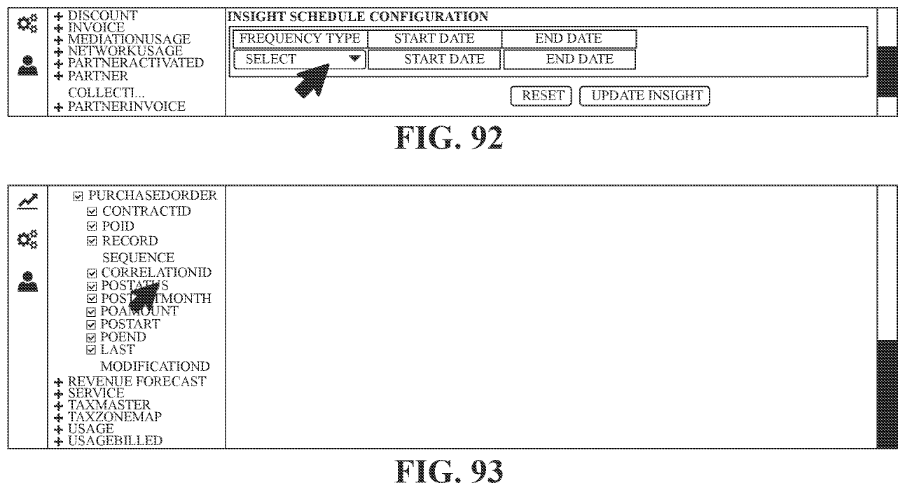

FIG. 85 shows that the user may hover over the left menu of the executive dashboard interface to expand the left menu (this left menu may be present on all executive dashboard interfaces though it may not be shown in all drawings of the executive dashboard interface for ease in viewing other elements). The user may select the Insight and Context Config (rule configurator) to bring up a first rule interface such as that shown in FIG. 86. In FIG. 86 the user has not selected a business area or insight (from an insight list), but in FIG. 87 the user has selected the Quote Configuration business area and PONotReceived_QUICKEN insight. FIGS. 88-93 show the same interface as that of FIG. 87, but scrolled further down (or across) the interface in each case. The PONotReceived_QUICKEN insight here is the rule that is set up to show the details and information related to the “PO NOT RCVD” graph/information of the “TCV VS PO—QUICKEN” insight (from FIGS. 36-42). After the purchase order information is collected/gathered by the system (i.e., there is a contract and a corresponding purchase order for that contract) the data may be used as input to provide a rule outcome.

On the left hand side of the interface of FIGS. 87-93 is shown an entities list that includes selectable entities and entity fields. A user may select the plus icon next to any entity to expand it and show its individual fields. The user may select one or more fields of a given entity (selecting a field may automatically select an entity, but within an entity the user may determine which fields to select/deselect). Each entity of the entities list may have different fields. Entities are tables from different resources. Each entity may have multiple entity fields. To build a query a user will need to select one or more of the entity fields. FIG. 93, for example, shows the PurchasedOrder fields that are selected (in this case they are all selected, but in other implementations some could be deselected). FIGS. 89-91 show some of the fields that are selected for the Contract entity. The functionality of the entities and fields shown in the left hand side of the interface of FIGS. 87-93 is the same that was described previously with respect to FIG. 22.

The various fields and functions of the first rule interface shown in FIGS. 87-93 is similar or the same as that described previously with respect to FIGS. 22-24E. The “Conditions” section allows the user to select items or provide input for fields, select conditions (left hand side, right hand side), etc., to create filtration or otherwise provide a function outputting rule values/outcomes. This allows the user to create filtration for the data or multiple data sources for reconciliation purposes and otherwise for revenue assurance. The “Detail Outcome Fields” section allows the user to identify what the user will want to see as a detail outcome when the user clicks on an individual insight of a graph group (on the details interface). The user can do “Group By” and “Order By” functions on any of these.

The “Insight Dashboard” allows the user to select an aggregation type and the type of graph that will be used on the “details interface” for this rule/insight. The aggregation type/function selected here is applied to the Detail Outcome Fields that have been selected. The scheduler (Insight Schedule Configuration) operates similarly to what is described above for FIGS. 24A-E. The system may include adapters or the like to pull data at identified frequencies and load the data into the system. As soon as the data is available the relevant rules can be run to identify revenue leakage. Accordingly, the scheduler can be used to schedule to run the rule after data loading. For example if some data is loaded each morning at 6 AM, a rule relying on that data could be set to run sometime after 6 AM each day so that it is running after the new data has already been loaded.

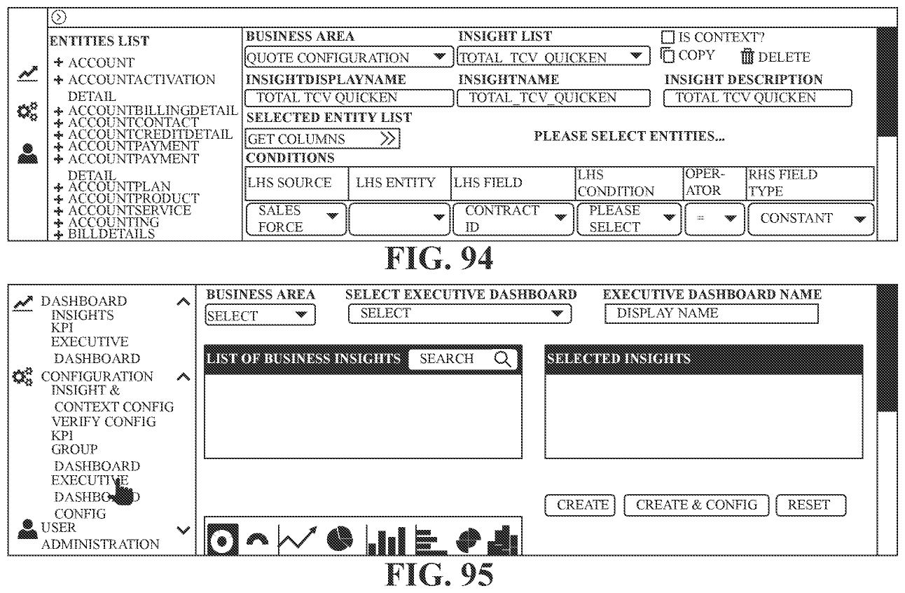

FIG. 94 shows another rule/insight (set up using the first rule interface). The business area is again Quote Configuration and the rule/insight is Total_TCV_QUICKEN. This is a rule/insight that may be used to obtain the total contract value amounts used for the graph groups and details interface of FIGS. 36-42. If the user hovers over the left menu to expand the left menu, and then selects the Executive Dashboard Config menu item (as seen in FIG. 95), this brings the user to a group dashboard interface such as the interfaces of FIGS. 95-100. These interfaces are similar to interface 2900 of FIG. 29 previously described (in some implementations the left menu and other menus may not be expandable but may always be expanded, such as when the user has a large screen to show the interfaces—but in other implementations they expand and contract as needed to fit a screen size or browser window or the like). The group dashboard interface is customizable using a selection mechanism for insights (some of which may be contexts). In some implementations this could be a drag and drop mechanism, though other mechanisms could be used such as single or double clicking to make selections of contexts and insights, or checking a box (not shown) to select them, etc.

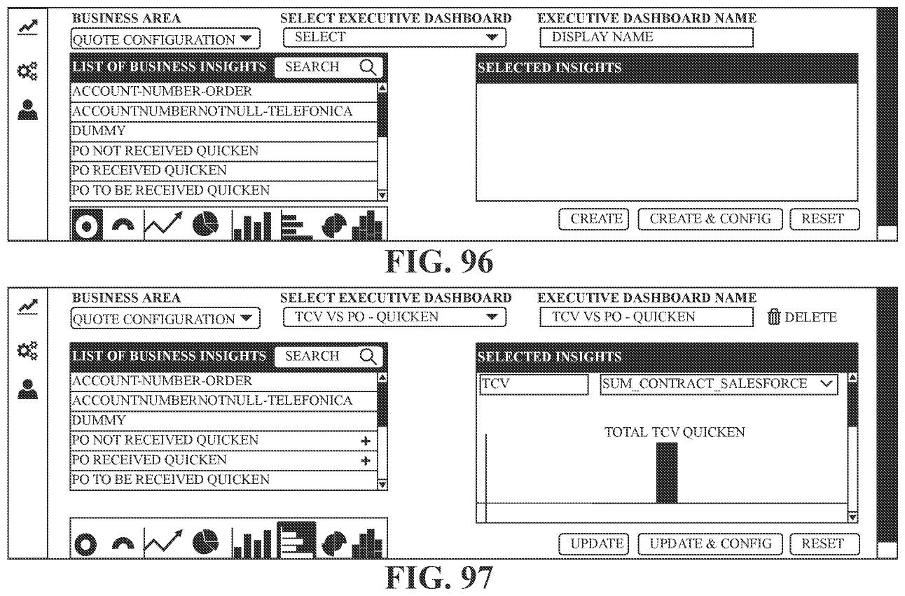

On the interfaces of FIGS. 95-100 the user can select the insights that will be shown, and in what type of graph format, and using what thresholds (if any) for any given graph group. In FIG. 95 the user has not yet selected a business area. In FIG. 96 the user has selected the Quote Configuration business area (this corresponds with the Quote Configuration executive dashboard interface of FIGS. 36-39). The user would, accordingly, using the FIG. 95 interface and related interfaces, set up what will be shown for the “TCV VS PO—QUICKEN” and “TCV VS PO” graph groups (and any other desired graph groups). In FIG. 97 for example the user has selected the “TCV VS PO—QUICKEN” graph group from the “Select Executive Dashboard” list to make edits. This list is essentially a list of graph groups previously set up, and the user could alternatively set up a new graph group here. The user can give the graph group a custom name (in the Executive Dashboard Name field) to display on the executive dashboard interface—in this case the graph group name and the display name are the same.

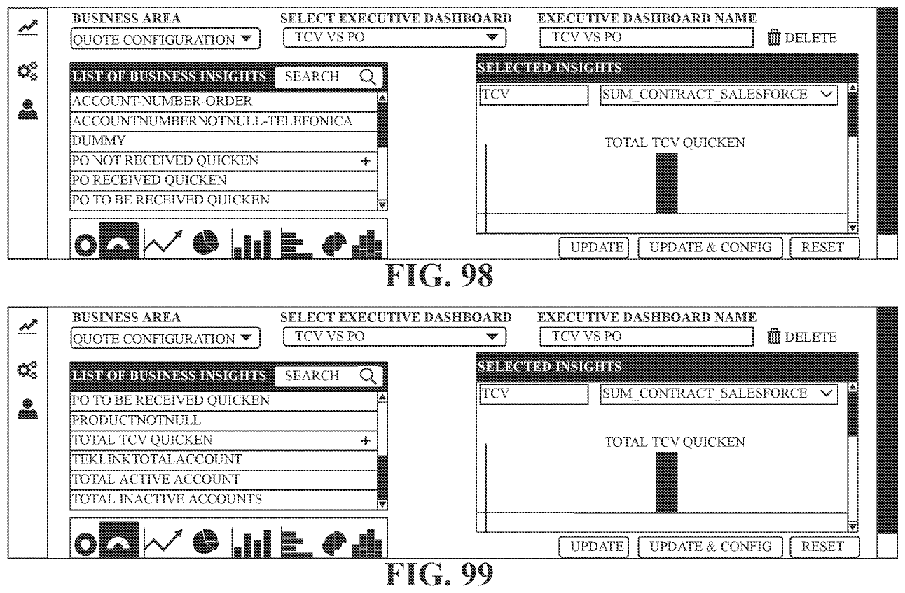

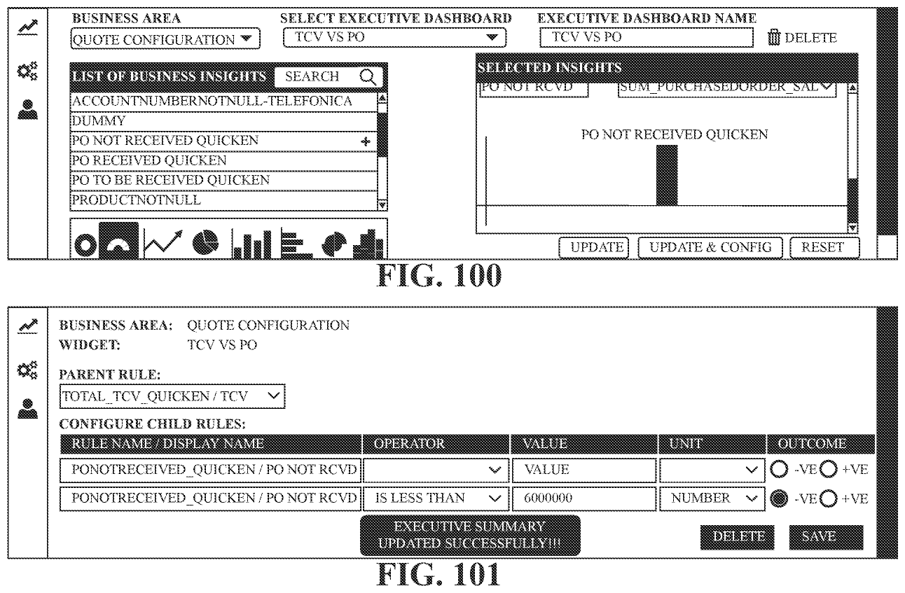

FIGS. 98-100 show the group dashboard interface as the user is configuring a “TCV vs PO” graph group. FIG. 98 shows that the user has selected the PO Not Received QUICKEN insight/rule, and FIG. 99 shows that the user has selected the Total TCV QUICKEN insight rule (each selection indicated by a plus sign). On FIG. 99 it is seen that after the user has selected the Total TCV QUICKEN insight it shows up on the right under “Selected Insights” as a bar graph item. Similarly, FIG. 100 shows that when the user scrolls down in the “Selected Insights” section the PO Not Received QUICKEN insight/rule is also shown as a bar graph item. The graph type (for what type of graph will be shown in the graph group on the executive dashboard interfaces) may be changed using the bottom left selectors (pie chart, line graph, vertical or horizontal bar graphs, polar graph, donut graph, half-donut graph, etc.), but on the Selected Insights section they may always show as bar graphs, in implementations, since they are shown individually and not as a group in this section. The user could select any other insights/rules to add to this graph group, and could select the UPDATE selector to simply update the graph group, or the UPDATE & CONFIG selector to update the graph group and to set up thresholds.

As an example, if the user were configuring the interfaces of FIGS. 95-102 to create or update the “TCV VS PO—QUICKEN” graph group shown on the Quote Configuration executive dashboard interface of FIG. 36, then on the interfaces of FIGS. 95-100 the user could, on the left side, click on the TCV, the PO RCVD, the FUTURE PO and the PO NOT RCVD insights (the selected items will have a plus icon in implementations to indicate that they are selected). The user can also select the graph type here, for example for the “TCV VS PO—QUICKEN” graph group the user had previously selected the horizontal bar graph type (third from the right, shown selected by its black background in FIG. 97) and thus the “TCV VS PO—QUICKEN” graph group of FIGS. 36-39 shows as a horizontal bar graph (though the use could change the graph type at any time—for example in FIG. 98 the user has selected a half donut graph). Once the user selects the items to be shown on the graph group, and the graph type, the related executive dashboard interface will be updated with the new graph group settings. The graph type and the items on the graph group can, accordingly, be changed at any time as desired by the user. In this example the user is accordingly creating a few rules/insights: a Total_TCV_QUICKEN (TCV) rule/insight (set up as in FIG. 94), a PO Received (PO RCVD) rule/insight (not shown being set up), a Future PO rule/insight (not shown being set up), and a PONotReceived_Quicken (PO Not RCVD) rule/insight (set up as in FIGS. 87-93). These rules are then used to create the graph groups that are shown on the Quote Configuration executive dashboard interfaces of FIGS. 36-39.

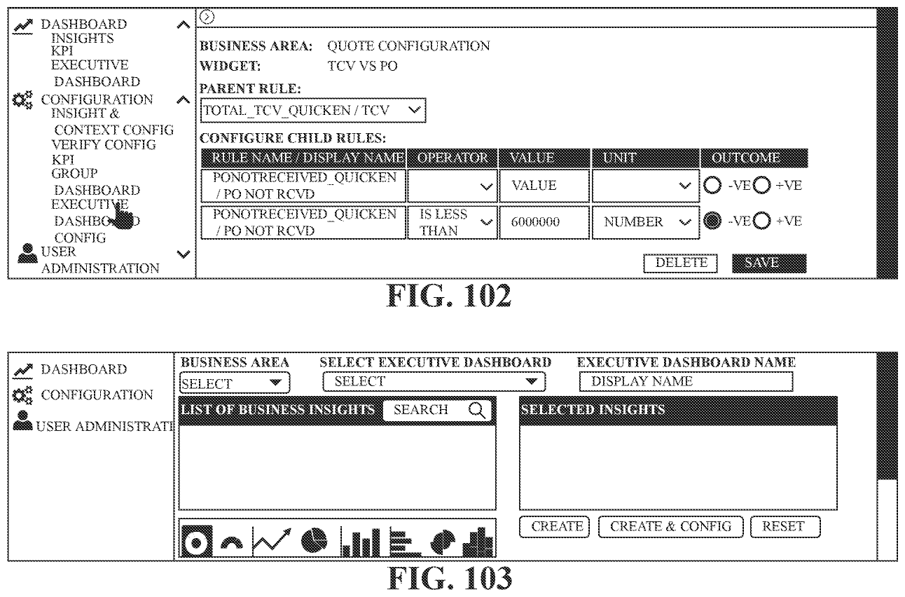

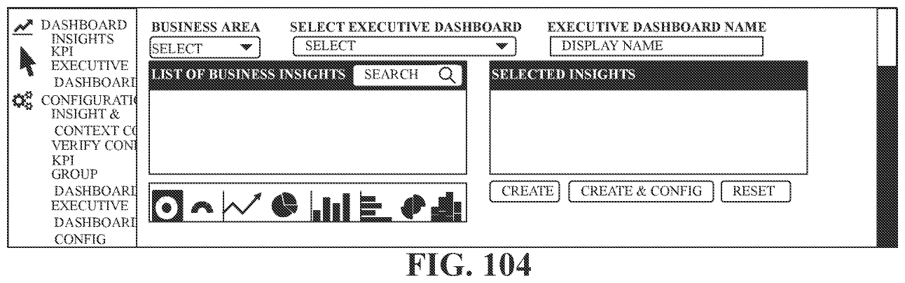

As indicated above, the user can select the UPDATE selector of FIGS. 97-100 to update (publishing the new information to the relevant executive dashboard interface), but the user can also select UPDATE & CONFIG to bring up a threshold configuration interface such as that shown in FIG. 101-102. The user can here set threshold limits for any of the rules/insights of a graph group (also called a widget). For example on this interface the user would set up the “PO RCVD” and “PO NOT RCVD” threshold values for the “TCV VS PO—QUICKEN” graph group of FIG. 36. These are set up as child rules, for example the threshold for PO RCVD would be set up as a child rule to the PO RCVD rule/insight, and the PO NOT RCVD threshold would be set up as a child rule to the PO NOT RCVD rule/insight. Once the thresholds are set up they are displayed on the related graph groups. Each threshold can be set up as a percentage or a number, and can be exceeded/triggered based on any of a number of mathematical operators (less than, less than or equal to, equal to, greater than or equal to, greater than, etc.). A range could be used, for example the threshold may be triggered if the insight/rule value is less than a first value or greater than a second value. The user can select the color they wish to show for when the threshold is crossed (or not crossed) in any direction—for instance red implying negative (−ve) if it is below a certain value and green implying positive (+ve) if it is above a certain value. On the interfaces of FIGS. 101-102 the radio buttons in the OUTCOME column may accordingly have such colors-red for the negative (−ve) radio buttons and green for the positive (+ve) radio buttons to indicate that values beyond the threshold will be shown in red or green, respectively. For example, FIG. 104 shows the left menu item as it is being expanded towards the view shown in FIG. 95 (or as it is being collapsed towards the view where the left menu only shows the icons, such as in FIG. 96).

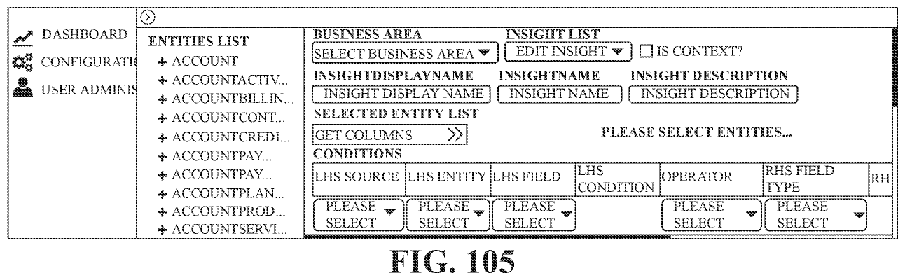

FIGS. 103-106 show interfaces that are somewhat duplicative of other interfaces. FIG. 103 shows an example implementation of an interface similar to that of FIG. 95 but with the sub-items (below the Dashboard, Configuration, and User Administration selectable items) not shown until a user hovers over the left menu to expand the list downwards (in other implementations the list also or alternatively expands and collapses sideways such as is shown between FIGS. 95 and 96 when a user hovers over the left menu or leaves it, respectively). FIG. 105 shows an interface somewhat similar to the interfaces of FIGS. 86-87 but with none of the selections yet made, so that the Business Area, Insight List, Insight Display Name, and other fields/selectors all are empty or have the default values before a user has entered values or has made selections (such as using a dropdown menu). FIG. 105 also shows an alternative view of the left two menus (leftmost menu and Entities List) whereby each is partially collapsed and the leftmost menu shows some of the wording but not the sub-elements below the Dashboard, Configuration and User Administration elements. Indeed, in some implementations the user may be able to manually collapse and expand menus and other windows or portions of an interface/window and leave it at any desired position, including a partially-collapsed position.

The user can also create a KPI for any rule (discussed above), and do other configurations such as user management integrated with a token system, user access control (UAC) based on a secure layer, and so forth.

It is pointed out that some of the interface images from FIG. 36 onward have been cropped to show other interface elements more easily. Accordingly, any of the interfaces from FIG. 36 onward may include border or edge or menu or similar elements shown in other interfaces from FIG. 36 onward.

In implementations the systems and/or methods disclosed herein may be configured such that data or one or more datasets for executing one or more rules are dynamically/automatically selected to be the latest data or datasets received from various sources or systems. In implementations it is also possible to select specific data or a specific data set based on a selected date range.

In implementations a cache-which could be a third party cache such as REDIS or AZURE CACHE for REDIS or an in-house cache solution—may be used to increase the perceived speed of rule executions or other data queries/updates from a big data source (for example APACHE HIVE). The retrieved data may be stored in key-value pairs. The entire tree structure may be stored as the value. Updates to individual nodes may be done in the cache. When the updates are completed, the cache may update the physical database (for example APACHE HIVE) in one go.

In implementations the systems disclosed herein may include pluggable architecture such that other systems (which may be in-house or third party systems, such as a billing system, a contract system, etc.) can be “plugged in” to the system to carry out specific tasks. For example in such implementations rating and/or billing may not be done by the systems disclosed herein (i.e., they may not be done by the revenue assurance system) but another in-house or third party system may do them through API calls and/or file feeds, the results of which may be used to carry out reconciliation.

In implementations any of the dropdown lists or other selectors or dynamic search fields (fields that dynamically show a list of options as a user types) may dynamically show the latest selected items at the top of the list so that the user may more quickly/easily select them again if the user so desires.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of revenue assurance systems and methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited in the claim, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element-if the claim does not explicitly recite a “second” of that element, the claim does not require a “second” of that element.

What is claimed is:

1. A revenue assurance method, comprising:
using one or more user interfaces displayed on one or more displays of one or more computing devices communicatively coupled with one or more databases:
receiving a user selection of a business area stored in the one or more databases;
receiving, at a first data source field, a user selection of a first data source, the first data source used to populate the one or more databases with business revenue-related source data relevant to the selected business area;
receiving, at a first input field, a user selection of one or more first data associated with the first data source through the one or more databases;
receiving, at an operator field, a user selection of one of an equal-to operator, a not-equal-to operator, a greater-than operator, a greater-than-or-equal-to operator, a less-than operator, and a less-than-or-equal-to operator;
receiving, at a second input field, one of a user input of a constant and a user selection of one or more second data, the one or more second data associated through the one or more databases with one of the first data source and a second data source used to populate the one or more databases with business revenue-related source data relevant to the selected business area;
executing a first database query to retrieve data from the one or more databases, wherein the first database query is defined at least in part by the first data source field, the first input field, the operator field, and the second input field;
displaying, on the one or more user interfaces, a graph representatively illustrating the data retrieved by the first database query, wherein the graph displays business revenue-related information relevant to the selected business area.

2. The method of claim 1, further comprising displaying, on the one or more user interfaces, one or more key performance indicator (KPI) input fields and, in response to receiving input using the KPI input fields, executing a second database query to retrieve data from the one or more databases and displaying, on the one or more user interfaces, one of an output of the second database query and a calculation based on the output of the second database query, wherein the output comprises business revenue-related information relevant to the selected business area.

3. The method of claim 2, wherein the second database query is defined at least in part by the data retrieved by the first database query.

4. The method of claim 2, further comprising displaying a KPI threshold input field on the on the one or more user interfaces, receiving a user-input threshold at the KPI threshold input field, and displaying, on the one or more user interfaces, the user-input threshold, one of the data retrieved by the second database query and a value calculated using the data retrieved by the second database query, and an indication of whether the data retrieved by the second database query is outside the user-input threshold.

5. A revenue assurance system, comprising:
one or more servers communicatively coupled with one or more databases, the one or more servers providing information to display, on one or more user interfaces displayed on one or more displays of one or more computing devices:
a business area selection field configured to receive a user selection of one of a plurality of previously-determined business areas stored in the one or more databases;
a first data source field configured to receive a user selection of a first data source, the first data source used to populate the one or more databases with business revenue-related source data relevant to the selected business area;
a first input field configured to receive a user selection of one or more first data associated with the first data source through the one or more databases;
an operator field configured to receive a user selection of one of an equal-to operator, a not-equal-to operator, a greater-than operator, a greater-than-or-equal-to operator, a less-than operator, and a less-than-or-equal-to operator; and
a second input field configured to receive one of a user input of a constant and a user selection of one or more second data, the one or more second data associated through the one or more databases with one of the first data source and a second data source used to populate the one or more databases with business revenue-related source data relevant to the selected business area;
one or more input fields configured to, in response to receiving one or more user inputs, automatically initiate generation of a database query and automatically initiate execution of the database query to retrieve data from the one or more databases, wherein the database query is defined at least in part by the first data source field, the first input field, the operator field, and the second input field; and
a graph representatively illustrating the data retrieved from the one or more databases by the database query, wherein the graph displays business revenue-related information relevant to the selected business area.

6. The system of claim 5, the one or more servers further providing information to display, on the one or more user interfaces, a table displaying one of the data retrieved by the database query and one or more calculations based on the data retrieved by the database query.

7. The system of claim 5, the one or more servers further providing information to display, on the one or more user interfaces, one or more frequency input fields configured to, in response to receiving one or more user inputs, automatically initiate execution of the database query on a repeating schedule.

8. The system of claim 5, the one or more servers further providing information to display, on the one or more user interfaces, a threshold field configured to receive an input threshold value.

9. The system of claim 8, the one or more servers further providing information to display, on the one or more user interfaces, a notification input field configured to allow selection of one or more users for automatic notifications when the threshold value is exceeded by one of a value retrieved from the one or more databases and a calculation based on one or more values retrieved from the one or more databases.

10. The system of claim 8, the one or more servers further providing information to display, on the one or more user interfaces, a summary showing the threshold value and one of a value retrieved from the one or more databases and a calculation based on one or more values retrieved from the one or more databases.

11. A revenue assurance system, comprising:
one or more servers communicatively coupled with one or more data stores, the one or more servers providing information to display, on one or more displays of one or more computing devices:
one or more first rule interfaces, the one or more first rule interfaces comprising:
a first data source field configured to receive a user selection of a first data source, the first data source used to populate the one or more data stores with business revenue-related source data;
a first input field configured to receive a user selection of one or more first data associated with the first data source through the one or more data stores;
an operator field configured to receive a user selection of a mathematical symbol;
a second input field configured to receive one of a user input of a constant and a user selection of one or more second data, the one or more second data associated through the one or more data stores with one of the first data source and a second data source used to populate the one or more data stores with business revenue-related source data;
one or more input fields configured to, in response to receiving one or more user inputs, automatically initiate generation of one or more data store queries and automatically initiate execution of the one or more data store queries to retrieve data from the one or more data stores, wherein the one or more data store queries are defined at least in part by the first data source field, the first input field, the operator field, and the second input field, and wherein the one or more data store queries comprise one or more first rules; and
one or more first rule outcome interfaces, the one or more first rule outcome interfaces comprising:
one or more first rule outcome graphs representatively illustrating the data retrieved by the one or more data store queries, wherein the one or more first rule outcome graphs display business revenue-related information.

12. The system of claim 11, wherein the one or more first rule interfaces further comprise a business area selection field configured to receive a user selection of one of a plurality of previously-determined business areas stored in the one or more data stores, wherein the business revenue-related source data from the first data source is relevant to the selected business area, and wherein the one or more first rule outcome graphs display business revenue-related information relevant to the selected business area.

13. The system of claim 12, the one or more servers further providing information to display, on the one or more displays of the one or more computing devices, a group dashboard interface configured to allow, for each previously-determined business area, user selection of a subset of the first rule outcome graphs, the subset defining a graph group.

14. The system of claim 13, the one or more servers further providing information to display, on the one or more displays of the one or more computing devices, one or more summary interfaces displaying two or more of the previously-determined business areas and further displaying, for each displayed business area, the user-defined graph group for that business area.

15. The system of claim 11, wherein the mathematical symbol comprises one of an equal-to operator, a not-equal-to operator, a greater-than operator, a greater-than-or-equal-to operator, a less-than operator, and a less-than-or-equal-to operator.

16. The system of claim 11, the one or more servers further providing information to display, on the one or more displays of the one or more computing devices, one or more second rule interfaces, the one or more second rule interfaces configured to allow user creation of a second rule in part by allowing a user to select an output of one of the one or more first rules to be a component of the second rule.

17. The system of claim 16, wherein the one or more second rule interfaces comprise one or more input fields configured to allow user selection of a numerator and user selection of a denominator, the numerator and the denominator at least partly defining the second rule.

18. The system of claim 16, wherein the one or more second rule interfaces comprise one or more selectors configured to allow user identification of an outcome of the second rule as one of a number, a ratio, and a percentage.

19. The system of claim 16, the one or more servers further providing information to display, on the one or more displays of the one or more computing devices, one or more second rule outcome interfaces, the one or more second rule outcome interfaces displaying a graph of an output of the second rule plotted against time.

20. The system of claim 11, the one or more servers further providing information to display, on the one or more displays of the one or more computing devices, one or more user access interfaces configured to receive user input to adjust a user's ability to edit the one or more first rules.
